(19) United States
(12) Patent Application Publication
(10) Pub. No.: US 2026/0012550 A1
(43) Pub. Date: Jan. 8, 2026

(54) INFORMATION PROCESSING APPARATUS, SYSTEM, NON-TRANSITORY RECORDING MEDIUM, AND METHOD

(71) Applicant: Susumu Fujioka, KANAGAWA (JP)

(72) Inventor: Susumu Fujioka, KANAGAWA (JP)

(73) Assignee: Ricoh Company, Ltd., Tokyo (JP)

(21) Appl. No.: 19/252,532

(22) Filed: Jun. 27, 2025

(30) Foreign Application Priority Data
Jul. 3, 2024 (JP) 2024-107423
Mar. 4, 2025 (JP) 2025-033699

(51) Int. Cl. H04N 1/21; H04N 1/00

(52) U.S. Cl. CPC H04N 1/2166; H04N 1/00244; H04N 1/00331; H04N 1/00336; H04N 2201/0094

(57) ABSTRACT

An information processing apparatus includes circuitry to determine, based on contents of data received from a terminal apparatus, a storage location candidate of the data among a plurality of storage locations, cause the terminal apparatus to display, on a display, information indicating the storage location candidate and feature information obtained by analyzing stored data having been stored in the storage location candidate, and cause the data to be stored in the storage location candidate, in response to an operation performed on the terminal apparatus for instructing to store the data in the storage location candidate.

### CROSS-REFERENCE TO RELATED APPLICATIONS

This patent application is based on and claims priority pursuant to 35 U.S.C. § 119 (a) to Japanese Patent Application Nos. 2024-107423, filed on Jul. 3, 2024 and 2025-033699, filed on Mar. 4, 2025, in the Japan Patent Office, the entire disclosure of which is hereby incorporated by reference herein.

### BACKGROUND

### Technical Field

The present disclosure relates to an information processing apparatus, a system, a non-transitory recording medium, and a method.

### Related Art

Some techniques for classifying an image read by a scanner based on a predetermined rule and storing the image in a folder have been proposed.

For example, a technique for analyzing a document and presenting a storage location candidate for storing the document is disclosed. According to the technique, a document analysis apparatus receives image data obtained by scanning a document having multiple pages and dividing the document into pages, and sequentially analyzes the received image data for each page. When a candidate of a storage location of the image data is determined, the document analysis apparatus returns information about the determined storage location candidate.

However, by only presenting the storage location candidate, it has been difficult to determine whether the storage location candidate is appropriate as a storage location of the document.

### SUMMARY

The present disclosure described herein provides an information processing apparatus including circuitry to determine, based on contents of data received from a terminal apparatus, a storage location candidate of the data among a plurality of storage locations, cause the terminal apparatus to display, on a display, information indicating the storage location candidate and feature information obtained by analyzing stored data having been stored in the storage location candidate, and cause the data to be stored in the storage location candidate, in response to an operation performed on the terminal apparatus for instructing to store the data in the storage location candidate.

In another aspect, a system includes a terminal apparatus and an information processing apparatus. The terminal apparatus includes circuitry to acquire data, determine, based on contents of the data, a storage location candidate of the data among a plurality of storage locations, and transmit a result of a determination of the storage location candidate to the information processing apparatus. The information processing apparatus includes other circuitry to transmit information indicating the storage location candidate and feature information obtained by analyzing stored data having been stored in the storage location candidate to the terminal apparatus and store the data in the storage location candidate in response to an operation performed on the terminal apparatus for instructing to store the data in the storage location candidate.

In another aspect, a non-transitory recording medium stores a plurality of program codes which, when executed by one or more processors, causes the one or more processors to perform a method including determining, based on contents of data received from a terminal apparatus, a storage location candidate of the data among a plurality of storage locations, causing the terminal apparatus to display, on a display, information indicating the storage location candidate and feature information obtained by analyzing stored data having been stored in the storage location candidate, and causing the data to be stored in the storage location candidate, in response to an operation performed on the terminal apparatus for instructing to store the data in the storage location candidate.

In another aspect, a method includes determining, based on contents of data received from a terminal apparatus, a storage location candidate of the data among a plurality of storage locations, causing the terminal apparatus to display, on a display, information indicating the storage location candidate and feature information obtained by analyzing stored data having been stored in the storage location candidate, and causing the data to be stored in the storage location candidate, in response to an operation performed on the terminal apparatus for instructing to store the data in the storage location candidate.

In another aspect, a system for providing a service on a cloud includes circuitry to determine, based on contents of data to be stored in the service, a storage location candidate of the data among a plurality of storage locations, cause a terminal apparatus to which the service is provided to display, on a display, information indicating the storage location candidate and feature information obtained by analyzing stored data having been stored in the storage location candidate, and cause the data to be stored in the storage location candidate, in response to an operation performed on the terminal apparatus for instructing to store the data in the storage location candidate.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic diagram illustrating an overall hardware configuration of a system according to a first embodiment;

FIGS. 2A and 2B are diagrams each illustrating a hardware configuration of an apparatus included in a system according to the first embodiment;

FIG. 3 is a block diagram illustrating a functional configuration of a system according to the first embodiment;

FIG. 4 is a diagram illustrating how scan data is analyzed according to the first embodiment;

FIG. 5 is a flowchart of a process executed by a server apparatus according to the first embodiment;

FIGS. 6A and 6B are diagrams each illustrating a screen displayed in the first embodiment;

FIGS. 7A and 7B are diagrams each illustrating another screen displayed in the first embodiment;

FIGS. 8A and 8B are diagrams each illustrating still another screen displayed in the first embodiment;

FIG. 9 is a flowchart of a first example of a process for generating a thumbnail image according to the first embodiment;

FIG. 10 is a conceptual diagram illustrating the first example of the process for generating a thumbnail image according to the first embodiment;

FIG. 11 is a flowchart of a second example of a process for generating a thumbnail image according to the first embodiment;

FIG. 12 is a conceptual diagram illustrating the second example of the process for generating a thumbnail image according to the first embodiment;

FIG. 13 is a block diagram illustrating a functional configuration of a system according to a second embodiment;

FIG. 14 is a flowchart of a process executed by a multifunction peripheral (MFP) according to the second embodiment;

FIG. 15 is a block diagram illustrating a functional configuration of a system according to a third embodiment;

FIG. 16 is a diagram illustrating how scan data is analyzed according to the third embodiment;

FIG. 17 is a schematic diagram illustrating an overall hardware configuration of a system according to a fourth embodiment;

FIG. 18 is a block diagram illustrating a hardware configuration of a personal computer terminal according to the fourth embodiment;

FIG. 19 is a block diagram illustrating a functional configuration of a system according to the fourth embodiment;

FIG. 20 is a flowchart of a process executed by a server apparatus according to the fourth embodiment;

FIGS. 21A to 21B are diagrams each illustrating a screen displayed in the fourth embodiment;

FIGS. 22A to 22B are diagrams each illustrating another screen displayed in the fourth embodiment;

FIG. 23 is a schematic diagram illustrating an overall hardware configuration of a system according to a fifth embodiment;

FIG. 24 is a block diagram illustrating a functional configuration of a system according to the fifth embodiment;

FIGS. 25A and 25B are diagrams each illustrating a screen displayed in the fifth embodiment;

FIG. 26 is a schematic diagram illustrating an overall hardware configuration of a system according to a sixth embodiment;

FIG. 27 is a block diagram illustrating a functional configuration of a system according to the sixth embodiment;

FIG. 28 is a flowchart of a process for generating stored data information according to the sixth embodiment;

FIG. 29 is a conceptual diagram illustrating the process for generating stored data information according to the sixth embodiment;

FIGS. 30A and 30B are diagrams each illustrating a screen displayed in the sixth embodiment;

FIG. 31 is a schematic diagram illustrating an overall hardware configuration of a system according to a seventh embodiment;

FIG. 32 is a block diagram illustrating a functional configuration of a system according to the seventh embodiment;

FIG. 33 is a flowchart of a process executed by a server apparatus according to the seventh embodiment;

FIGS. 34A and 34B are diagrams each illustrating a screen displayed in the seventh embodiment;

FIG. 35A is a schematic diagram illustrating an overall hardware configuration of a system according to an eighth embodiment;

FIG. 35B is a diagram illustrating a hierarchical relationship of a collaboration tool according to the eighth embodiment;

FIG. 36 is a block diagram illustrating a functional configuration of a system according to the eighth embodiment;

FIGS. 37A and 37B are diagrams each illustrating a screen displayed in the eighth embodiment;

FIG. 38 is a flowchart of a process executed by a server apparatus according to the eighth embodiment;

FIGS. 39A and 39B are diagrams each illustrating a screen displayed in a modification of the eighth embodiment;

FIG. 40 is a block diagram illustrating a functional configuration of a system according to a ninth embodiment;

FIG. 41 is a flowchart of a process executed by a server apparatus and a personal computer terminal according to the ninth embodiment; and

FIG. 42 is a diagram illustrating a screen displayed in the ninth embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

The present disclosure is described with reference to first to ninth embodiments, but the present disclosure is not limited thereto. In the drawings referred to below, identical or similar reference signs are used for the common or corresponding elements, and redundant descriptions are omitted as appropriate.

In the embodiments described below, a storage location for storing data is not particularly limited. For example, a physical storage area such as a hard disk drive or a solid-state drive may be used as the storage location, or a virtual storage area referred to as a folder or a directory may be used as the storage location.

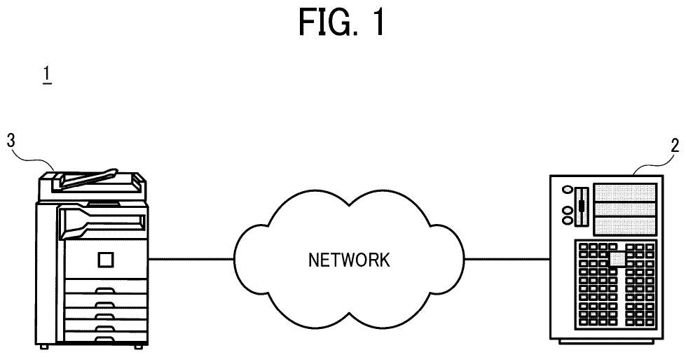

FIG. 1 is a schematic diagram illustrating an overall hardware configuration of a system 1 according to the first embodiment. In FIG. 1, an environment in which a server apparatus 2 and a multifunction peripheral (MFP) 3 are connected via a network such as the Internet or a local area network (LAN) is illustrated. The number of MFPs 3 included in the system 1 is not limited to that illustrated in FIG. 1 and has no limitations. The method for connecting each apparatus to the network may be either wired or wireless.

The server apparatus 2 is an information processing apparatus that provides services according to the embodiments. The server apparatus 2 provides, for example, a storage function for storing data scanned by the MFP 3. The data to be stored in the server apparatus 2 does not have to be data scanned by the MFP 3. For example, document data created by word processing software operating on a personal computer may be used as the data to be stored.

The MFP 3 is an apparatus configured as a terminal apparatus such as an image forming apparatus, and executes print processing for forming an image on a sheet and scan processing for reading a document. The MFP 3 according to the embodiments transmits data obtained by reading the document to the server apparatus 2 and requests the server apparatus 2 to store the data. In the following embodiments, the MFP 3 having a scanning function is described as an example of a terminal apparatus that obtains data to be stored, but the terminal apparatus is not particularly limited thereto. For example, the terminal apparatus may be a terminal apparatus having a photographing function to obtain an image, such as a camera.

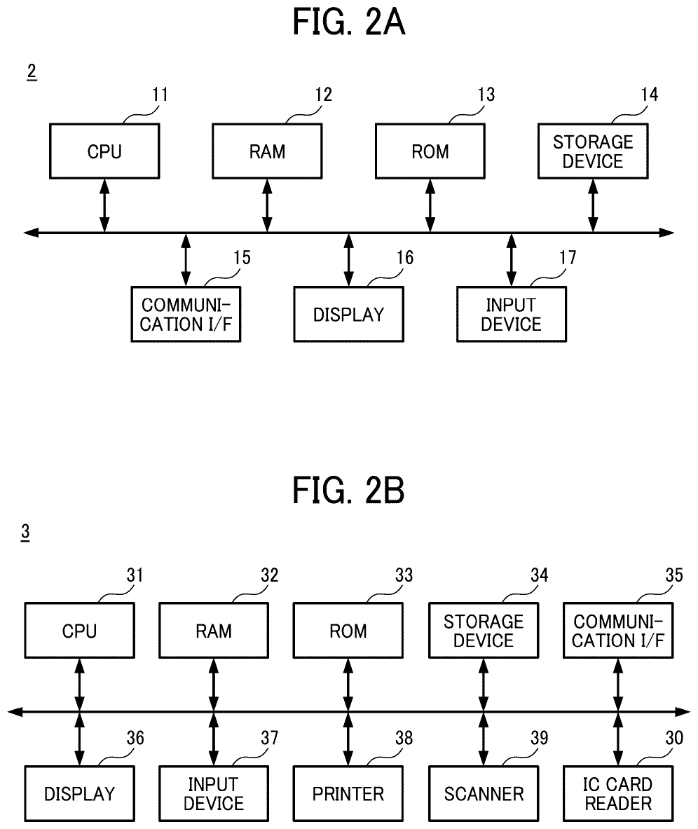

The hardware configuration of each apparatus is described below. FIGS. 2A and 2B are diagrams each illustrating a hardware configuration of the apparatus included in the system 1 of the first embodiment. In FIG. 2A, a hardware configuration of the server apparatus 2 is illustrated. In FIG. 2B, a hardware configuration of the MFP 3 is illustrated.

The hardware configuration of the server apparatus 2 is described below. As illustrated in FIG. 2A, the server apparatus 2 includes a central processing unit (CPU) 11, a random-access memory (RAM) 12, a read-only memory (ROM) 13, a storage device 14, a communication interface (I/F) 15, a display 16, and an input device 17. The hardware components are connected to one another via a bus.

The CPU 11 executes programs for controlling the operation of the server apparatus 2 and performs predetermined processing. The RAM 12 is a volatile storage device that provides a work area for a program executed by the CPU 11 and is used for storing and loading programs and data. The ROM 13 is a nonvolatile storage device that stores data such as programs and firmware executed by the CPU 11.

The storage device 14 is a readable and writable nonvolatile storage device that stores an operating system (OS) and various software to cause the server apparatus 2 to function, setting information, and various data such as data obtained by the MFP 3 executes scanning. Examples of the storage device 14 include a hard disk drive (HDD) and a solid-state drive (SSD).

The communication I/F 15, which may be implemented by an interface circuit, connects the server apparatus 2 to the network, and enables communication with other apparatuses via the network. The communication via the network may be either wired communication or wireless communication. Various data is transmitted and received via the network using a predetermined communication protocol such as a transmission control protocol/internet protocol (TCP/IP).

The display 16 is a device that displays, for example, various data or a state of an apparatus to a user, and examples thereof include a liquid crystal display (LCD). The input device 17 is a device that allows the user to operate the server apparatus 2, and examples thereof include a keyboard and a mouse. The display 16 and the input device 17 may be separate devices or an integral device such as a touch screen display having both functions. The server apparatus 2 does not necessarily include the display 16 and the input device 17.

The hardware configuration of the MFP 3 is described below. As illustrated in FIG. 2B, the MFP 3 includes a CPU 31, a RAM 32, a ROM 33, a storage device 34, a communication I/F 35, a display 36, an input device 37, a printer 38, a scanner 39, and an integrated circuit (IC) card reader 30. The hardware components are connected to one another via a bus. The CPU 31, the RAM 32, the ROM 33, the storage device 34, the communication I/F 35, the display 36, and the input device 37 included in the MFP 3 are similar to those included in the server apparatus 2 described with reference to FIG. 2A, and detailed descriptions thereof are omitted.

The printer 38 is a device that forms an image on a sheet using, for example, a laser printing method or an inkjet printing system. The scanner 39 is a device that reads an image on a printed matter and converts the image into data. The MFP 3 makes a copy of a printed matter, for example, by the scanner 39 and the printer 38 operating in cooperation with each other. The MFP 3 also transmits, for example, image data obtained by the scanner 39 scanning an image to the server apparatus 2 via the communication I/F 35. The image data may be referred to as scan data in the following description.

The IC card reader 30 is a device that reads information of an IC card owned by the user who uses the MFP 3. The IC card reader 30, for example, constantly generates a magnetic field, and when the IC card is brought close to the IC card reader 30, the IC card reader 30 reads information for identifying the user whose information stored in the IC card. In this way, the user is identified whether the user has the authority to use the MFP 3. In other words, the authentication of the user is performed.

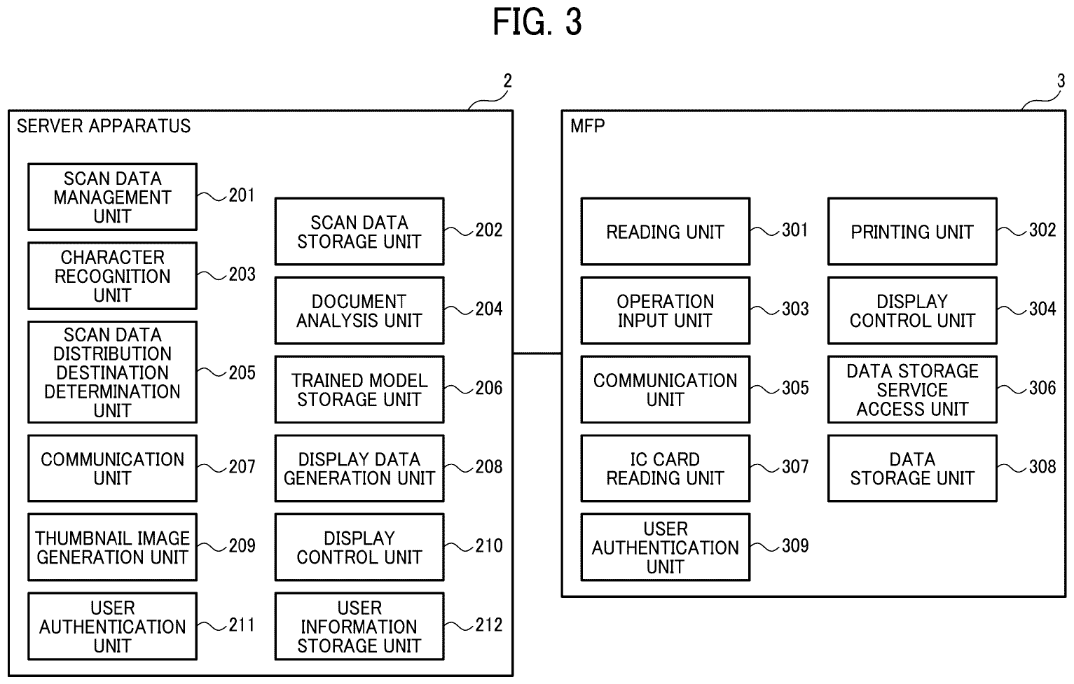

The hardware configuration of each apparatus of the first embodiment has been described above. The functional units implemented by the hardware components according to the first embodiment are described below with reference to FIG. 3. FIG. 3 is a block diagram illustrating a functional configuration of the system 1 according to the first embodiment.

The server apparatus 2 includes, as functional units, a scan data management unit 201, a scan data storage unit 202, a character recognition unit 203, a document analysis unit 204, a scan data distribution destination determination unit 205, a trained model storage unit 206, a communication unit 207, a display data generation unit 208, a thumbnail image generation unit 209, a display control unit 210, a user authentication unit 211, and a user information storage unit 212. The MFP 3 includes, as functional units, a reading unit 301, a printing unit 302, an operation input unit 303, a display control unit 304, a communication unit 305, a data storage service access unit 306, an IC card reading unit 307, a data storage unit 308, and a user authentication unit 309. The functional units are described in detail below.

The functional units of the server apparatus 2 are described below. The scan data management unit 201 manages the scan data received from the MFP 3, and serves as a management function in the present embodiment. The scan data management unit 201 according to the present embodiment, for example, writes the scan data in a predetermined folder or reads out the scan data from a specified folder.

The scan data storage unit 202 controls the operation of the storage device 14 to store the scan data. The scan data storage unit 202 serves as a storage function in the present embodiment. The scan data storage unit 202 of the present embodiment stores the scan data, for example, in a predetermined storage area of an HDD in response to a request from the scan data management unit 201. The scan data storage unit 202 also stores the scan data in folders.

The character recognition unit 203 recognizes characters in the document associated with the scan data, and serves as a recognition function in the present embodiment. The character recognition unit 203 obtains characters from the scan data and converts the obtained characters into text data using optical character recognition (OCR) processing.

The document analysis unit 204 analyzes sentences in the document associated with the scan data, and serves as an analysis function in the present embodiment. The document analysis unit 204 generates vector data as a sentence vector including context information from the text data output by the character recognition unit 203. The vector data is generated, for example, by applying a natural language processing model such as Bidirectional Encoder Representations from Transformers (BERT) to the text data. The document analysis unit 204 of the present embodiment uses a parameter stored in the trained model storage unit 206 to perform a machine learning program using the vector data as an input to a classifier. Thus, the document analysis unit 204 classifies the contents of the document associated with the scan data. In this way, a folder for storing the scan data is determined.

The scan data distribution destination determination unit 205 determines to which folder in the scan data storage unit 202 the scan data should be distributed. The scan data distribution destination determination unit 205 serves as a determination function in the present embodiment. In the present embodiment, the scan data distribution destination determination unit 205 determines a folder for storing the scan data based on the contents of the document classified by the document analysis unit 204, and distributes the scan data to the folder in the scan data storage unit 202.

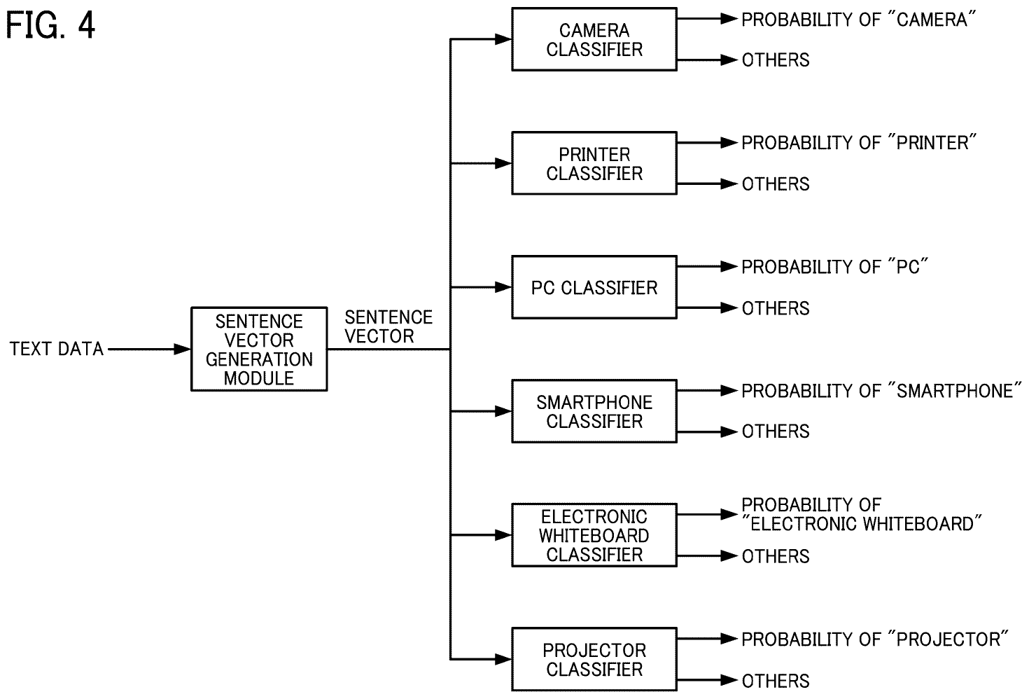

The trained model storage unit 206 controls the operation of the storage device 14 to store a trained model used for classifying the text data. The trained model storage unit 206 serves as a storage function in the present embodiment. The trained model is a program for classifying a document in cooperation with the document analysis unit 204, and is stored in the storage device 14. The trained model in the present embodiment is obtained by performing machine learning on feature data that is obtained from a large number of documents and used for classifying documents. For example, by performing machine learning on documents describing cameras, a trained program that has learned the feature data of the camera is generated. In this way, the trained model and the document analysis unit 204 forms a classifier into which the documents describing the cameras are classified. In the present disclosure, the machine learning is a technique that enables a computer to acquire human-like learning ability. The machine learning refers to a technology in which a computer autonomously generates an algorithm to be used for determination such as data identification from training data loaded in advance and applies the generated algorithm to new data to make a prediction. Any suitable learning method may be applied to the machine learning. For example, any one of supervised learning, unsupervised learning, semi-supervised learning, reinforcement learning, and deep learning may be applied to the machine learning. Classification of the scan data based on the text data is described below with reference to FIG. 4. FIG. 4 is a diagram illustrating how the scan data is analyzed according to the first embodiment. In FIG. 4, how the scan data is classified and stored in one of a folder related to a camera, a folder related to a printer, a folder related to a personal computer (PC), a folder related to a smartphone, a folder related to an electronic whiteboard, and a folder related to a projector is illustrated. When the document associated with the scan data contains the contents related to the camera, the scan data is stored in a “camera” folder. When the document associated with the scan data contains the contents related to the printer, the scan data is stored in a “printer” folder.

The text data output from the character recognition unit 203 is input to a sentence vector generation module of the document analysis unit 204. The document vector generation module applies natural language processing to the text data to output a sentence vector. The sentence vector is input to a camera classifier, a printer classifier, a PC classifier, a smartphone classifier, an electronic whiteboard classifier, and a projector classifier.

Each classifier serves as a support vector machine that compares feature data obtained from a document corresponding to each classification with the sentence vector to calculate the probability that the document corresponds to each classification. For example, the camera classifier compares feature data obtained from a document describing a camera with the sentence vector, and calculates the probability that a sentence associated with the sentence vector describes the camera and the probability that the sentence describes something other than the camera. In the present disclosure, the probability indicates the degree of probability of falling into a certain classification and is expressed as a value ranging from zero to one.

Each classifier to which the sentence vector is input outputs the probability that the sentence vector falls into each classification. For example, when a certain sentence vector is input to each classifier, it is assumed that the camera classifier outputs that the camera probability is 0.7 and the other probability is 0.3, the printer classifier outputs that the printer probability is 0.6 and the other probability is 0.4, the PC classifier outputs that the PC probability is 0.5 and the other probability is 0.5, the smartphone classifier outputs that the smartphone probability is 0.4 and the other probability is 0.6, the electronic whiteboard classifier outputs that the electronic whiteboard probability is 0.3 and the other probability is 0.7, and the projector classifier outputs that the projector probability is 0.2 and the other probability is 0.8. In this case, the text data from which the sentence vector is generated is highly likely to be the text data describing the “camera” that is the classification having the highest probability. Accordingly, the scan data distribution destination determination unit 205 determines to distribute the scan data to a folder related to the “camera.”

With reference to FIG. 4, a case in which the determination of a storage location candidate is made based on the data to be stored and the classifier is described. However, the determination of a storage location candidate does not necessarily have to be made based on the output result of the classifier. Accordingly, for example, the determination may be made based on the degree of coincidence or the degree of association by comparing the data to be stored with the data stored in each folder. The data to be compared with includes, for example, the title of the data, the submission destination of the data, the contents of the data, the creator of the data, and the date of creation or submission of the data. Examples of the contents of the data include text information, a figure including image data, and information for identifying the contents of the data such as a project name or a project number. The scan data distribution destination determination unit 205 determines, as a result of comparison of the data to be stored with the data, a folder containing a large amount of data having a high degree of coincidence or association to be a storage location candidate.

Returning to FIG. 3, the description continues. The communication unit 207 controls the operation of the communication I/F 15 to communicate with other apparatuses via the network. The communication unit 207 serves as a communication function in the present embodiment. The communication unit 207 of the present embodiment, for example, receives the scan data from the MFP 3 and transmits display data and a thumbnail image to the MFP 3.

The display data generation unit 208 generates data of an image to be displayed on the display 36 of the MFP 3. The display data generation unit 208 serves as a generation function in the present embodiment. The display data generation unit 208 according to the present embodiment generates, for example, display data of an image indicating a storage location candidate of the scan data. The display data generation unit 208 generates display data of an image that allows a folder serving as a candidate of a storage location is easily recognized. In the image, for example, storage locations are regarded as drawers of a cabinet and a drawer corresponding to the candidate of the storage location is opened. The candidate of a storage location may be referred to as a storage location candidate in the following description. The display data generated by the display data generation unit 208 is transmitted to the MFP 3 via the communication unit 207.

The thumbnail image generation unit 209 generates, as feature information, a thumbnail image of a document stored in a folder for storing the scan data. The feature information is obtained by analyzing stored data having been stored in the storage location candidate, and is information that allows a determination of whether the storage location candidate is appropriate. Specifically, the feature information is information obtained by analyzing the stored data having been stored in the storage location candidate. Examples of the information include information indicating the relationship between the data to be stored and the stored data and information indicating the tendency of the stored data having been stored in the storage location candidate. The information obtained by analyzing the stored data having been stored in the storage location candidate and indicating the relationship between the data to be stored and the stored data is, for example, a thumbnail image of a page identified to be highly relevant to the data to be stored of the stored data highly relevant to the data to be stored. The information obtained by analyzing the stored data having been stored in the storage location candidate and indicating the tendency of the stored data having been stored in the storage location candidate is, for example, a thumbnail image including a text and an image identified to have high frequencies of appearance among the texts and images obtained from the stored data having been stored in the storage location candidate. In addition, the information obtained by analyzing the stored data having been stored in the storage location candidate and indicating the tendency of the stored data having been stored in the storage location candidate is, for example, breakdown information indicating the classification of the stored data having been stored in the storage location candidate. The feature information is not limited to the aforementioned types of information. For example, a text identified to have a high frequency of appearance is highly likely to feature the stored data and can be a factor for determining whether the storage location candidate is appropriate. Accordingly, when texts identified to have high frequencies of appearance are found as a result of analyzing the stored data, these texts may be used as keywords and a list of the keywords may be used as the feature information.

The thumbnail image generation unit 209 serves as a generation function in the present embodiment. The thumbnail image generation unit 209 of the present embodiment generates, for example, a thumbnail image indicating the relationship between the data to be stored and the stored data and a thumbnail image indicating the tendency of the stored data having been stored in the storage location candidate. For example, when a specific page (e.g., an initial page) of the stored data is identified to be a page indicating the feature information as a result of analysis, the thumbnail image generation unit 209 generates a thumbnail image that is an image obtained by reducing the image of the initial page. In addition, the thumbnail image generation unit 209 generates multiple thumbnail images for a single folder. For example, when the scan data most recently stored (i.e., the scan data lastly stored) is identified to indicate the feature information as a result of the analysis, the thumbnail image generation unit 209 generates a thumbnail image from this scan data. As described above, since the thumbnail image generated by the thumbnail image generation unit 209 is generated based on the stored data in the folder, the thumbnail image is associated with the stored data. The thumbnail image generated by the thumbnail image generation unit 209 is transmitted to the MFP 3 via the communication unit 207 together with the display data generated by the display data generation unit 208. The process of generation of a thumbnail image performed by the thumbnail image generation unit 209 will be described later.

The thumbnail image serving as the feature information obtained by analyzing the stored data having been stored in the storage location candidate may include, for example, a page, an image, and a text indicating the feature of the folder serving as the storage location candidate, which are identified to indicate the feature information as a result of the analysis. For example, when a “smartphone” folder is determined to be a storage location candidate, and when it is determined that the frequency of appearance of a smartphone image is high as a result of analysis of the stored data in the “smartphone” folder, the thumbnail image generation unit 209 generates a thumbnail image that is an image obtained by reducing a page including the smartphone image from the data stored in the “smartphone” folder. Alternatively, for example, when a page, such as a title page or a page including a title image, related to a folder serving as the storage location candidate is identified to indicate the tendency of the stored data in the storage location candidate in the data already stored in the folder serving as the storage location candidate as a result of analyzing the stored data, the thumbnail image generation unit 209 may generate a thumbnail image that is an image obtained by reducing the image of the page related to the folder serving as the storage location candidate.

When the determination of the storage location candidate is made based on the degree of coincidence by comparing the data to be stored with the stored data in each folder, the thumbnail image generation unit 209 may analyze and evaluate the degree of coincidence or association between the data to be stored and the stored data. Then, the thumbnail image generation unit 209 may generate a thumbnail image of a page having a high degree of coincidence or association as a page identified to be highly relevant to the data to be stored.

The display control unit 210 controls a terminal apparatus such as the MFP 3 to display various information transmitted to the terminal apparatus via the communication unit 207. The display control unit 210 serves as a control function in the present embodiment. The display control unit 210 of the present embodiment controls, for example, the MFP 3 to display a thumbnail image generated by the thumbnail image generation unit 209 or an image based on display data generated by the display data generation unit 208.

The user authentication unit 211 authenticates the user who uses the data storage service. The user authentication unit 211 serves as an authentication function in the present embodiment. For example, the user authentication unit 211 of the present embodiment collates the information in the identification (ID) card of the user received from the MFP 3 with the user information stored in the user information storage unit 212 to authenticate the user. The authentication of the user may be performed by a method other than using the ID card. For example, the authentication may be performed by the user inputting an ID and a password.

The user information storage unit 212 controls the operation of the storage device 14 to store information on the user who uses the MFP 3. The user information storage unit 212 serves as a storage function in the present embodiment. The user information storage unit 212 of the present embodiment stores, for example, the ID and the password of the user in association with each other.

The functional units of the MFP 3 are described below. The reading unit 301 controls the operation of the scanner 39 to read a document. The reading unit 301 serves as a reading function in the present embodiment. The reading unit 301 of the present embodiment reads an image on the document and outputs electronic data as scan data. The scan data is transmitted to the server apparatus 2 via the communication unit 305.

The printing unit 302 controls the operation of the printer 38 to print an image on a sheet. The printing unit 302 serves as a printing function in the present embodiment. For example, the printing unit 302 of the present embodiment executes print processing based on a print job transmitted from a personal computer terminal.

The operation input unit 303 inputs an operation received via the input device 37. The operation input unit 303 serves as an input function in the present embodiment. For example, the operation input unit 303 of the present embodiment inputs an operation for starting scan processing and an operation for selecting a folder serving as a storage location candidate of the scan data.

The display control unit 304 controls the operation of the display 36 to display a predetermined screen on the display 36. The display control unit 304 serves as a control function in the present embodiment. For example, the display control unit 304 of the present embodiment controls display based on the display data or thumbnail image transmitted from the server apparatus 2.

The communication unit 305 controls the operation of the communication I/F 35 to communicate with other apparatuses via the network. The communication unit 305 serves as a communication function in the present embodiment. For example, the communication unit 305 of the present embodiment transmits the scan data to the server apparatus 2 and receives the display data and the thumbnail image from the server apparatus 2.

The data storage service access unit 306 accesses the data storage service provided by the server apparatus 2. The data storage service access unit 306 serves as an access function in the present embodiment. The data storage service access unit 306 of the present embodiment requests the server apparatus 2 to store the scan data and requests the server apparatus 2 to read out the scan data stored in the server apparatus 2. For example, the data storage service access unit 306 passes a command used for the data storage service to the communication unit 305. The communication unit 305 transmits a data packet to which the command is added.

The IC card reading unit 307 controls the operation of the IC card reader 30 to read the information (data) stored in the IC card. The IC card reading unit 307 serves as a reading function in the present embodiment. The data read out by the IC card reading unit 307 is used by the user authentication unit 309 to authenticate the user. The data read out by the IC card reading unit 307 is transmitted to the server apparatus 2 when the data storage service access unit 306 accesses the data storage service provided by the server apparatus 2.

The data storage unit 308 controls the operation of the storage device 34 to store various data. The data storage unit 308 serves as a storage function in the present embodiment. For example, the data storage unit 308 of the present embodiment stores various setting data for the MFP 3 and image data.

The user authentication unit 309 authenticates the user who uses the MFP 3. The user authentication unit 309 serves as an authentication function in the present embodiment. The user authentication unit 309 of the present embodiment collates the information in the ID card of the user read by the IC card reading unit 307 with the user information stored in the data storage unit 308 to authenticate the user. The authentication of the user may be performed by a method other than using the ID card. For example, the authentication may be performed by the user inputting an ID and a password.

The above-described functional units correspond to functions implemented by the CPU 31 executing programs to function hardware components. All the functional units described in the embodiments may be implemented by software. Alternatively, a part or all of the functional units may be implemented by pieces of hardware each of which provides the equivalent function.

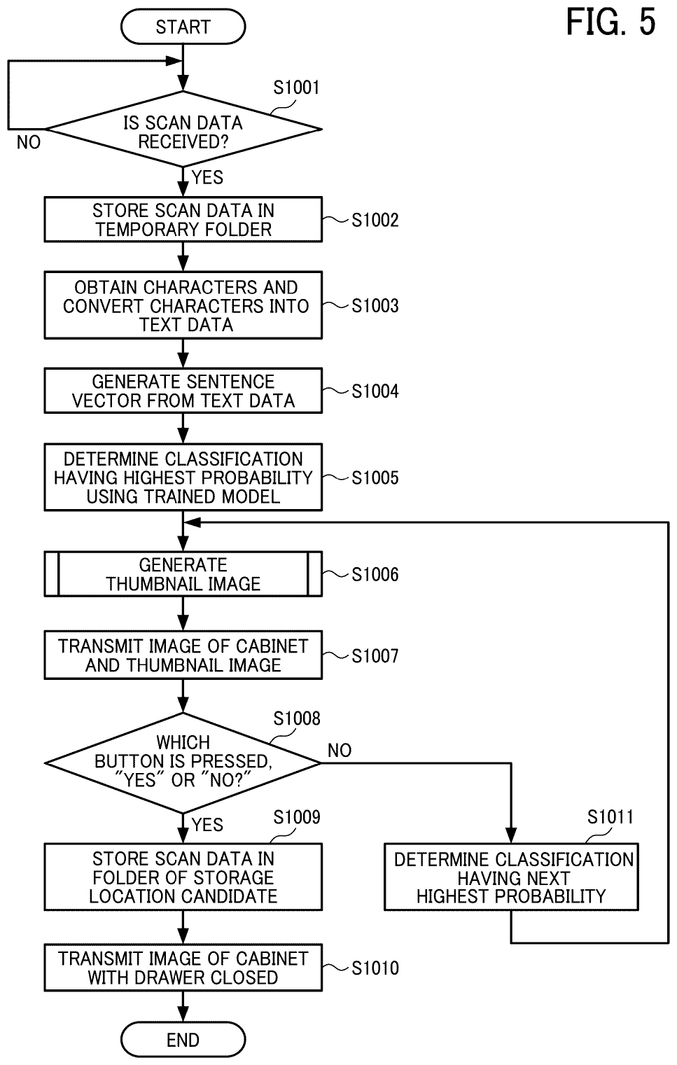

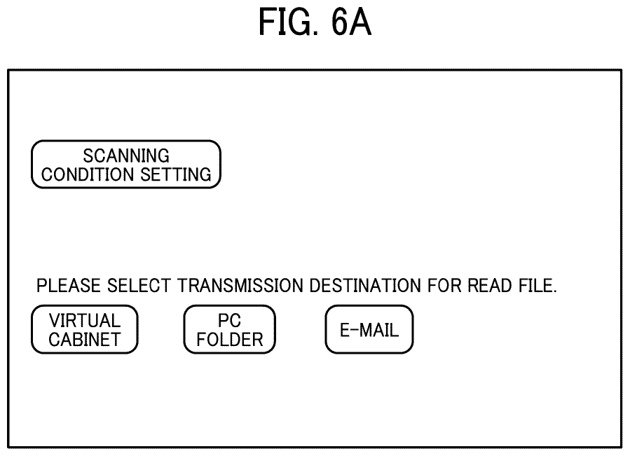

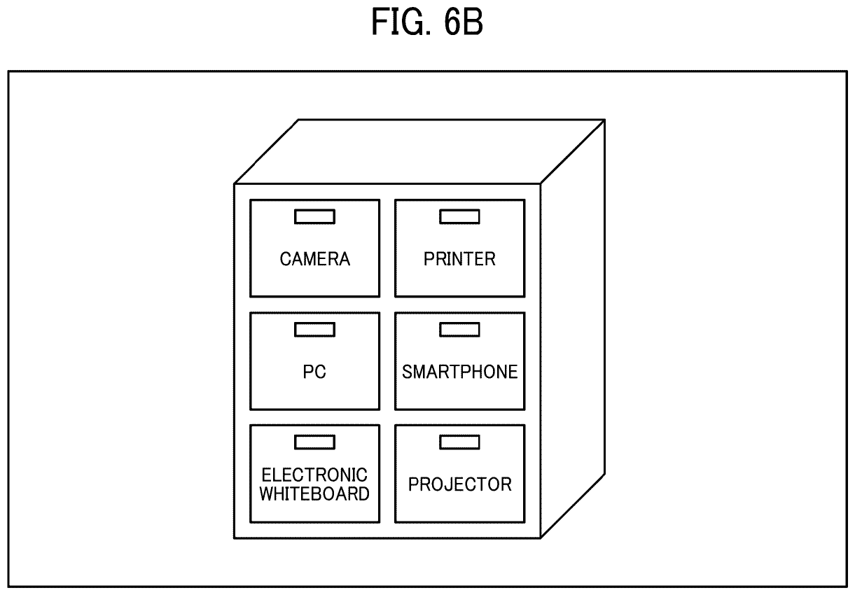

The processes executed by the above-described functional units are described below with reference to FIG. 5. FIG. 5 is a flowchart of the process executed by the server apparatus 2 according to the first embodiment. In the following description of FIG. 5, FIGS. 6 to 8 are referred to as appropriate. In FIGS. 6A to 8B, examples of screens displayed in the first embodiment are illustrated. In the drawings illustrating the display screen of each embodiment described below, the reference numerals and the leading lines accompanying the reference numerals are not included in the display screen.

The server apparatus 2 starts the process.

In step S1001, the process branches depending on whether the scan data is received from the MFP 3. In the case where the scan data is not received (NO in step S1001), the process of step S1001 is repeated to wait for reception of the scan data.

On the other hand, in the case where the scan data is received (YES in step S1001), the process proceeds to step S1002. The MFP 3 displays a screen as illustrated in FIG. 6A to perform scanning. FIG. 6A is a diagram illustrating an example of a screen displayed on the MFP 3, on which a button used for transitioning to a screen for setting a scanning condition and a button used for selecting a transmission destination of a read file are displayed. After setting the scanning condition, the user selects a “virtual cabinet” as the transmission destination and instructs scanning of a document. The virtual cabinet is such that the storage locations for storing the scan data according to the present embodiment are regarded as the drawers of a cabinet.

FIG. 6B is a diagram illustrating a display example of the virtual cabinet. In the virtual cabinet of the present embodiment, images of multiple drawers corresponding to multiple folders are displayed. In other words, as illustrated in FIG. 6B, a folder for storing scan data related to the camera is presented as a “camera” drawer. A folder for storing scan data related to the printer is presented as a “printer” drawer. A folder for storing scan data related to the PC is presented as a “PC” drawer. A folder for storing scan data related to the smartphone is presented as a “smartphone” drawer. A folder for storing scan data related to the electronic whiteboard is presented as an “electronic whiteboard” drawer. A folder for storing scan data related to the projector is presented as a “projector” drawer.

Returning to FIG. 5, the description continues. In step S1002, the received scan data is stored in a temporary folder. In step S1003, the character recognition unit 203 obtains characters included in the scan data and converts the obtained characters into text data. The converted text data is output to the document analysis unit 204.

In step S1004, the document analysis unit 204 generates a sentence vector from the text data. In step S1005, the document analysis unit 204 inputs the sentence vector to each classifier to calculate the probability of falling into each classification using the trained model. In addition, in step S1005, the scan data distribution destination determination unit 205 determines a classification having the highest probability and sets the determined classification as the storage location candidate of the scan data.

In step S1006, the thumbnail image generation unit 209 generates a thumbnail image serving as feature information obtained by analyzing the stored data. The process of step S1006 will be described in detail later.

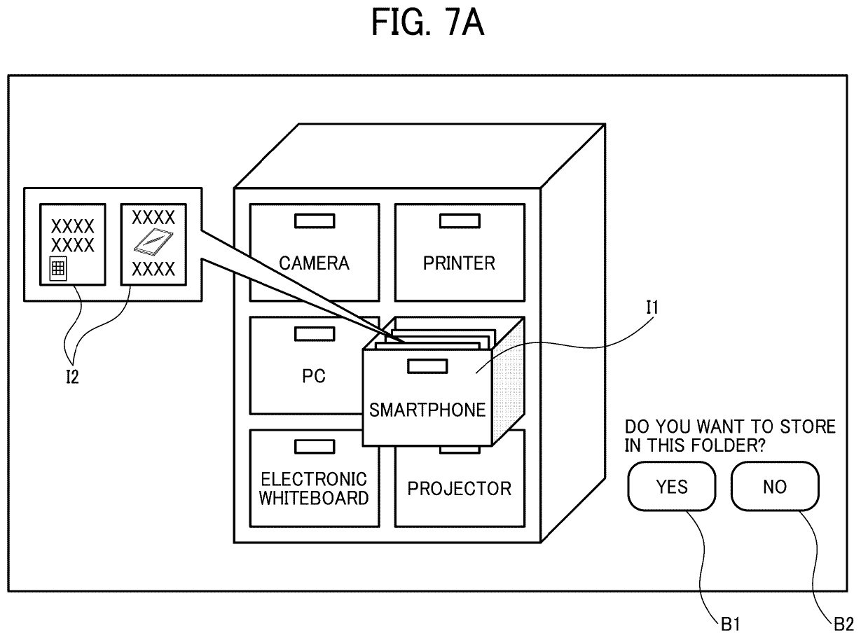

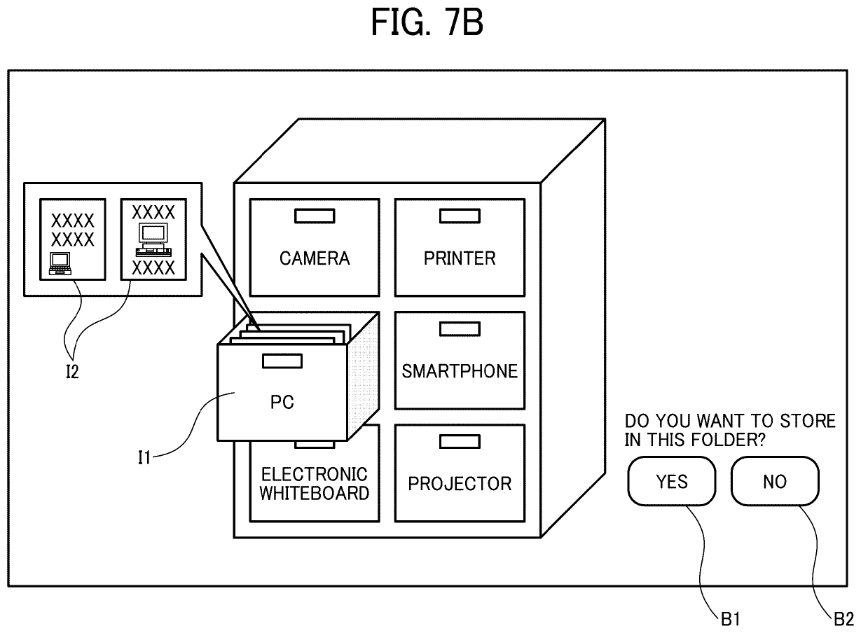

In step S1007, the display control unit 210 transmits, to the MFP 3 via the communication unit 207, an image of the cabinet serving as the information indicating the folder serving as the storage location candidate and the thumbnail image generated in step S1006, and controls the MFP 3 to display the image and the thumbnail image. Information I1 indicating the folder serving as the storage location candidate is, for example, the name of a drawer opened in the cabinet illustrated in FIG. 7A (i.e., the “smartphone” drawer in FIG. 7A). The information I1 is referred to as storage location candidate folder display information I1 in the following description. Feature information I2 obtained by analyzing the stored data in the folder serving as the storage location candidate is, for example, an image displayed in a balloon pointing to the drawer opened in the cabinet illustrated in FIG. 7A. In step S1007, the display data generation unit 208 generates and transmits an image of the cabinet in which the drawer (i.e., the folder serving as the storage location candidate) corresponding to the classification determined in step S1005 is opened. In addition, in step S1007, the thumbnail image generation unit 209 generates and transmits a thumbnail image of other scan data stored in the folder of the classification determined in step S1005.

The image transmitted in step S1007 is displayed on the MFP 3 as illustrated in FIG. 7A. FIG. 7A is a diagram illustrating an example of a screen when the scan data is classified into the smartphone. Accordingly, as illustrated in FIG. 7A, the image of the cabinet in which the “smartphone” drawer determined to be the classification (i.e., the folder serving as the storage location candidate) is opened is displayed on the MFP 3. In the case where other scan data is already stored in the “smartphone” folder, as illustrated in FIG. 7A, one or more thumbnail images (i.e., the feature information I2) obtained by reducing one or more pages related to the “smartphone” folder of the other scan data stored in the “smartphone” folder are also displayed. On the screen illustrated in FIG. 7A, the reason that the folder is determined to be the storage location candidate may be displayed. For example, a numerical value of the probability output by the classifier or the degree of coincidence or association between the data to be stored and the stored data may be displayed.

In this way, by displaying to the user the classification of the storage location for storing the scan data and the examples of the other scan data already stored in the folder, the user can easily recognize whether the determined classification is appropriate as a storage location for storing the scan data. The drawers of the virtual cabinet are given by way of example, and a user interface (UI) image is not limited thereto. Accordingly, as long as the determined classification can be distinguished from other classifications, the UI image does not have to be the image of the cabinet having drawers.

In addition, as illustrated in FIG. 7A, a message “Do you want to store in this folder?” is displayed on the MFP 3. Also, a “Yes” button B1 and a “No” button B2 for allowing the user to make a selection in response to the message are displayed. After viewing the image of the virtual cabinet and the thumbnail images, the user can determine the folder for storing the scan data of the document by pressing the “Yes” button B1 or the “No” button B2.

Returning to FIG. 5, the description continues. After the data of the image to be displayed is transmitted to the MFP 3 in step S1007, the process branches in step S1008 depending on whether the user presses the “Yes” button B1 or the “No” button B2. For example, in the case where the user presses the “Yes” button B1 on the screen of FIG. 7A, the process proceeds to step S1009. In the case where the user presses the “No” button B2, the process proceeds to step S1011.

In the case where the user presses the “Yes” button B1 in step S1008 (YES in step S1008), the scan data management unit 201 causes the scan data storage unit 202 to store the scan data in the folder serving as the storage location candidate in step S1009. For example, when the user presses the “Yes” button B1, that is, when the operation input unit 303 of the MFP 3 receives an operation for storing the scan data in the candidate folder, the communication unit 305 of the MFP 3 transmits a notification to the server apparatus 2 that the operation for storing the scan data in the candidate folder has been received. When the communication unit 207 of the server apparatus 2 receives the notification, the scan data management unit 201 performs a process for storing the scan data in the candidate folder in step S1009.

In step S1010, the display data generation unit 208 generates an image of the cabinet with the drawers closed and transmits the image to the MFP 3. The image transmitted in step S1010 is displayed on the MFP 3, for example, as an image illustrated in FIG. 6B. Then, the server apparatus 2 ends the process.

On the other hand, in the case where the user presses the “No” button B2 in step S1008 (NO in step S1008), the scan data distribution destination determination unit 205 determines a classification that has the next highest probability after the classification of the current storage location candidate in step S1011. Then, the process returns to step S1006 and the above-described processes are repeated. For example, when the user presses the “No” button B2, that is, when the operation input unit 303 of the MFP 3 receives an operation for not storing the scan data in the candidate folder, the communication unit 305 of the MFP 3 transmits a notification to the server apparatus 2 that the operation for not storing the scan data in the candidate folder has been received. When the communication unit 207 of the server apparatus 2 receives the notification, the scan data distribution destination determination unit 205 performs a process for determining a classification having the next highest probability in step S1011.

In this case, in the process of step S1007 repeatedly performed, an image different from the image displayed in the process of step S1007 performed the first time (i.e., the previous time) is displayed. For example, it is assumed that the classification having the highest probability is determined to be the “smartphone” and the classification having the next highest probability is determined to be the “PC.” In this case, when the process of step S1007 is performed the first time, an image of the cabinet with the smartphone drawer opened is displayed as illustrated in FIG. 7A. When the process of step S1007 is performed the second time (i.e., repeatedly), an image of the cabinet with the PC drawer opened and one or more thumbnail images representing the other scan data stored in the “PC” folder are displayed as illustrated in FIG. 7B. Then, by displaying the message “Do you want to store in this folder?” together with the image of the cabinet and the thumbnail images, and the “Yes” button B1 and the “No” button B2 for allowing the user to make a selection in response to the message, the user is prompted to select again whether the scan data should be stored in the “PC” folder.

In this way, when the user performs an operation for selecting “No” in step S1008, by repeating the display of suggesting the classification with the next highest probability as the storage location candidate, the user is allowed to select an appropriate storage location for storing the scan data. In particular, by setting a classification having a high probability based on the sentence vector generated from the text data as a storage location candidate, the workload for the user in selecting a folder is reduced.

With reference to the flowchart illustrated in FIG. 5 and the examples of the screens illustrated in FIGS. 7A and 7B, the case has been described in which a single classification having a high probability is set as a storage location candidate. However, the number of classifications is not limited to one. Accordingly, two or more classifications each having a high probability may be set as the storage location candidate.

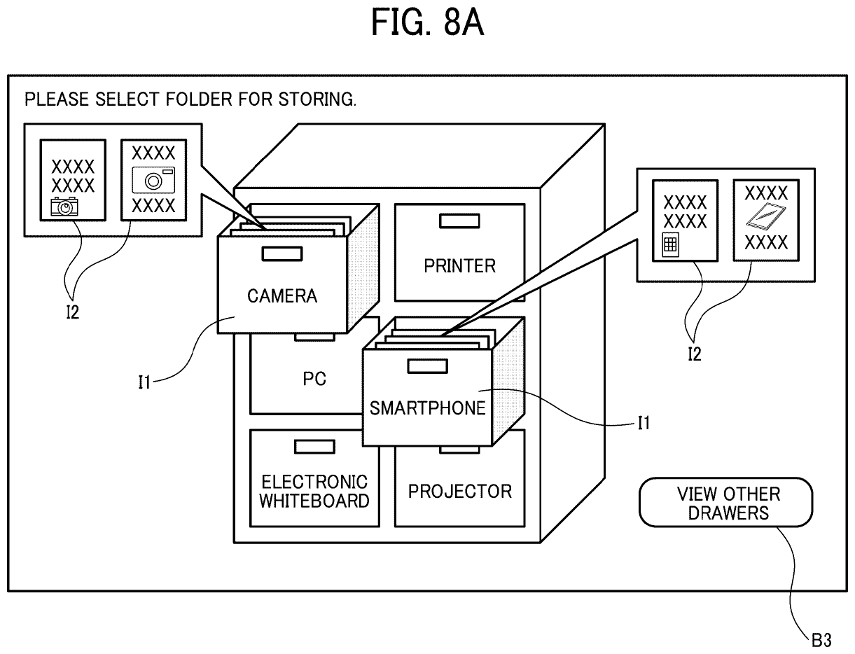

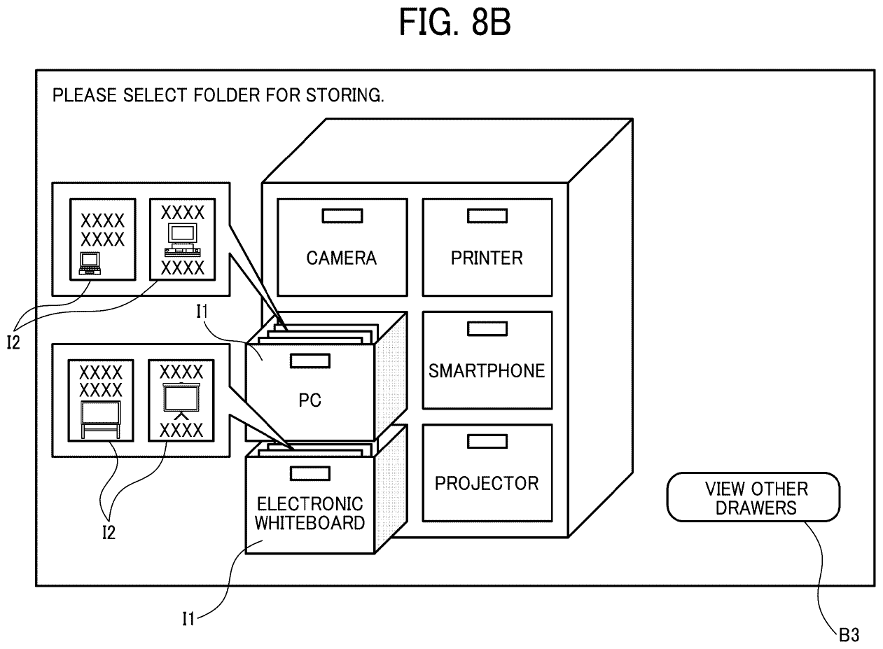

For example, it is assumed that top two classifications having higher probabilities are determined to be the smartphone and the camera. As illustrated in FIG. 8A, the display data generation unit 208 generates data for displaying an image of the cabinet with the smartphone and camera drawers opened, and the thumbnail image generation unit 209 generates one or more thumbnail images of the other scan data stored in the “smartphone” folder and the “camera” folder. The user can view a screen as illustrated in FIG. 8A and is allowed to select either the “smartphone” folder or the “camera” folder as the storage location for storing the scan data. In the case where the user determines that neither folder is appropriate as a storage location for storing the scan data, the user is allowed to select a “view other drawers” button. The “view other drawers” button is referred to as an “other candidates display button B3” in the following description.

For example, when the user performs an operation for selecting the “smartphone” folder as the storage location for storing the scan data, that is, when the operation input unit 303 of the MFP 3 receives an operation for storing the scan data in the “smartphone” folder, the communication unit 305 of the MFP 3 transmits a notification to the server apparatus 2 that the operation for storing the scan data in the “smartphone” folder has been received. When the communication unit 207 of the server apparatus 2 receives the notification, the scan data storage unit 202 performs a process for storing the scan data in the selected candidate folder (i.e., the “smartphone” folder) in step S1009.

When the “view other drawers” button (other candidates display button B3) is pressed, an image of the cabinet in which drawers corresponding to multiple classifications having the next highest probabilities are opened is displayed. For example, it is assumed that the classifications of the “PC” and the “electronic whiteboard” are determined to have next highest probabilities after the probabilities of the classifications of the “smartphone” and the “camera.” In this case, when the “view other drawers” button (other candidates display button B3) is pressed on the screen of FIG. 8A, a screen as illustrated in FIG. 8B is displayed.

On the screen of FIG. 8B, an image of the cabinet with the drawers of the PC and the electronic whiteboard opened and thumbnail images representing the other scan data stored in the “PC” folder and the “electronic whiteboard” folder are displayed. The user views a screen as illustrated in FIG. 8B and determines whether either of the folders is appropriate as a storage location for storing the scan data. Then, the user performs an operation for selecting a folder or pressing the “view other drawers” button (other candidates display button B3).

For example, when the user presses the “view other drawers” button (other candidates display button B3), that is, when the operation input unit 303 of the MFP 3 receives an operation for not storing the scan data in the candidate folder, the communication unit 305 of the MFP 3 transmits a notification to the server apparatus 2 that an operation for not storing the scan data in the candidate folder has been received. When the communication unit 207 of the server apparatus 2 receives the notification, the scan data distribution destination determination unit 205 performs a process for determining a classification having the next highest probability in step S1011.

A first example and a second example of the process for generating a thumbnail image in step S1006 are described below.

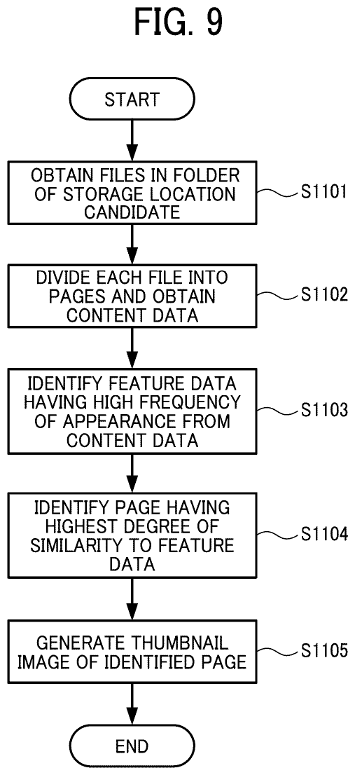

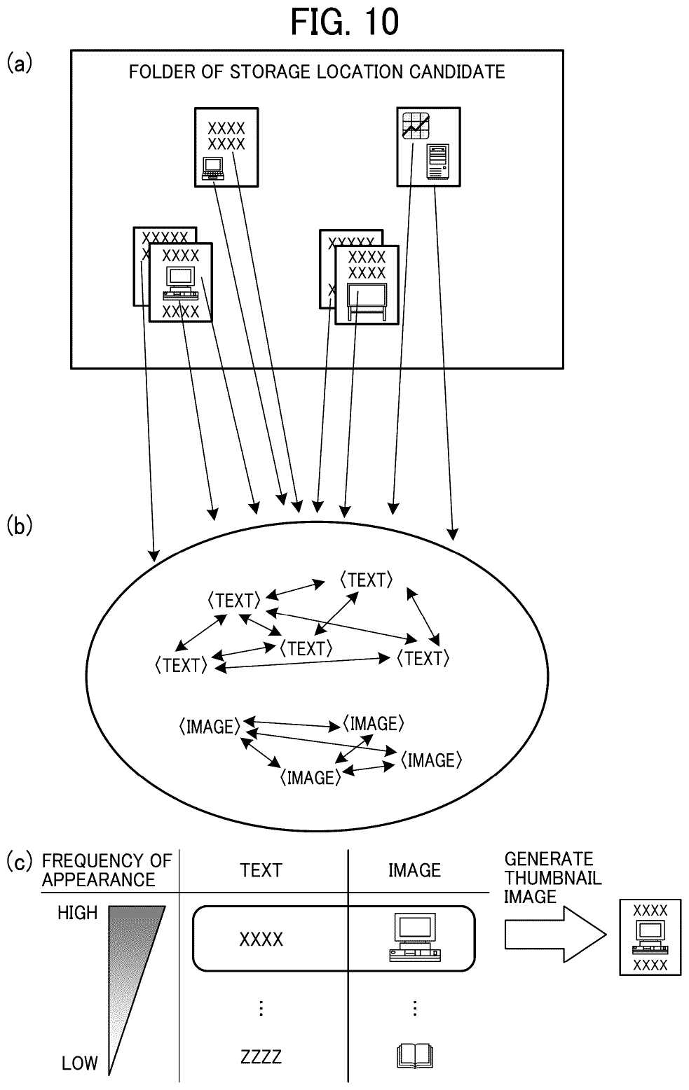

First, the first example of the process for generating a thumbnail image is described below. FIG. 9 is a flowchart of the first example of the process for generating a thumbnail image according to the first embodiment. In the following description of FIG. 9, FIG. 10 is referred to as appropriate. FIG. 10 is a conceptual diagram illustrating the first example of the process for generating a thumbnail image according to the first embodiment.

The thumbnail image generation unit 209 starts the process. In step S1101, the thumbnail image generation unit 209 obtains files (stored data) in the folder serving as the storage location candidate. In part (a) of FIG. 10, a structure of the folder serving as the storage location candidate is illustrated. In the process of step S1101, as illustrated in part (a) of FIG. 10, the stored data in the folder serving as the storage location candidate is obtained.

In step S1102, the thumbnail image generation unit 209 divides each file obtained in step S1101 into pages, and obtains text data and image data in the pages. In the following description, the text data and the image data are collectively referred to as content data unless particularly distinguished from each other. In the process of step S1102, as illustrated in part (b) of FIG. 10, the text data and the image data are obtained.

In step S1103, the thumbnail image generation unit 209 identifies text data and image data that have high frequencies of appearance among the content data. In the following description, the text data and the image data having high frequencies of appearance are collectively referred to as “feature data” unless particularly distinguished from each other.

In step S1104, the thumbnail image generation unit 209 identifies a page of the stored data that has the highest degree of similarity to the feature data. In step S1104, for example, by vectorizing the text data and the image data of each page and calculating the degree of similarity, the page having the highest degree of similarity is identified (see parts (b) and (c) of FIG. 10).

In step S1105, the thumbnail image generation unit 209 generates a thumbnail image of the page identified in step S1105 (see part (c) of FIG. 10). The thumbnail image may be generated, for example, by converting the identified page into an image and reducing the size of the image to a predetermined size.

With reference to part (c) of FIG. 10, the case has been described in which the text data and the image data having the highest frequencies of appearance are present on the same page. However, the text data and the image data having the highest frequencies of appearance do not necessarily have to be present on the same page. When the text data and the image data having the highest frequencies of appearance are not present on the same page, for example, the image data having the highest frequency of appearance and a page that contains a text having a high frequency of appearance among texts may be used for generating a thumbnail image.

After step S1105, the process ends. After the process ends once, the process proceeds to step S1007 in FIG. 5.

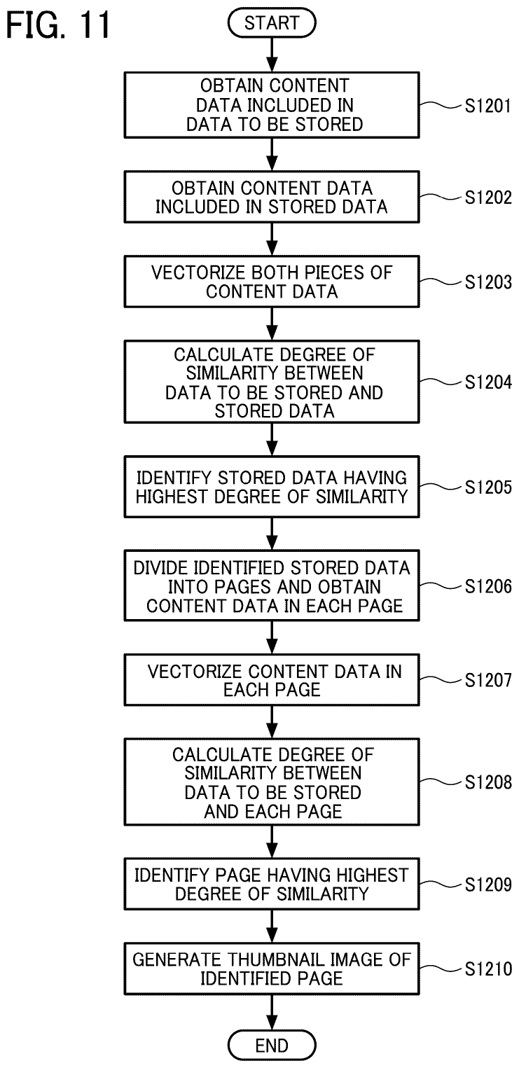

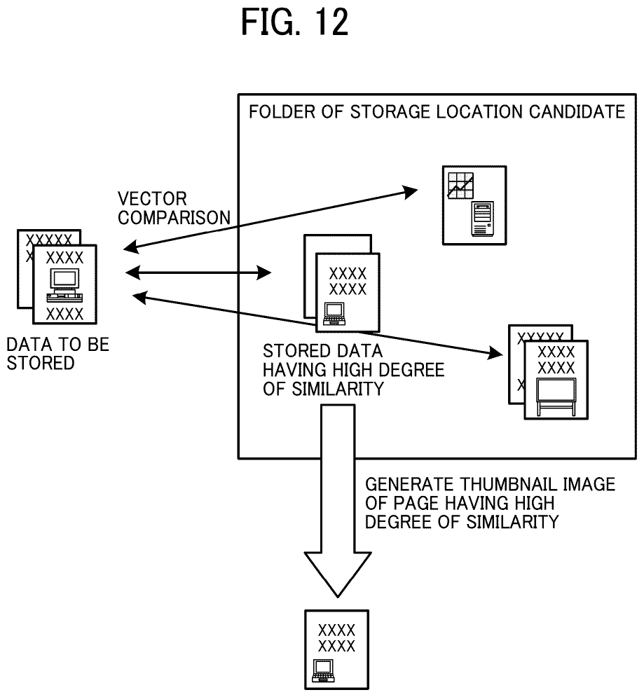

Subsequently, the second example of the process for generating a thumbnail image is described below. FIG. 11 is a flowchart of the second example of the process for generating a thumbnail image according to the first embodiment. In the following description of FIG. 11, FIG. 12 is referred to as appropriate. FIG. 12 is a conceptual diagram illustrating the second example of the process for generating a thumbnail image according to the first embodiment.

The thumbnail image generation unit 209 starts the process. In step S1201, the thumbnail image generation unit 209 obtains content data included in the data to be stored. In step S1202, the thumbnail image generation unit 209 obtains content data included in the stored data in the folder serving as the storage location candidate.

In step S1203, the thumbnail image generation unit 209 vectorizes the obtained content data. Specifically, in step S1203, the thumbnail image generation unit 209 vectorizes the content data included in the data to be stored obtained in step S1201 and the content data included in the stored data obtained in step S1202. In the present disclosure, vectorization is to convert text data or image data included in data into a numerical representation in order to calculate the degree of similarity between pieces of data (between files). The vectorization of text data can be performed, for example, using BERT. The vectorization of image data can be performed using a known image processing algorithm. However, the vectorization of text data or image data is not particularly limited thereto. The vectorization of text data or image data can be performed using any desired method.

In step S1204, the thumbnail image generation unit 209 calculates the degree of similarity between the data to be stored and the stored data. The degree of similarity calculated in step S1204 indicates the degree of similarity between the data to be stored and the stored data. The degree of similarity is calculated, for example, based on the vectors calculated in step S1203. The calculation of the degree of similarity based on the vectors can be performed, for example, by comparing the vector of the text data included in the data to be stored and the vector of the text data included in the stored data, by comparing the vector of the image data included in the data to be stored and the vector of the image data included in the stored data, or by performing a comprehensive comparison in which the aforementioned comparisons are integrated. In FIG. 12, a structure is illustrated in which the vector of the data to be stored and the vector of the stored data in the folder serving as the storage location candidate are compared to calculate the degree of similarity.

In step S1205, the thumbnail image generation unit 209 identifies stored data having the highest degree of similarity based on the degree of similarity calculated in step S1204. In step S1206, the thumbnail image generation unit 209 divides the identified stored data into pages, and obtain content data in each page.

In step S1207, the thumbnail image generation unit 209 vectorizes the content data in each page. The process of the vectorization in step S1207 is substantially the same as the process in step S1203.

In step S1208, the thumbnail image generation unit 209 calculates the degree of similarity between the data to be stored and each page. The process for calculating the degree of similarity in step S1208 is substantially the same as the process in step S1204.

In step S1209, the thumbnail image generation unit 209 identifies a page having the highest degree of similarity. In step S1210, the thumbnail image generation unit 209 generates a thumbnail image of the identified page. The thumbnail image may be generated, for example, by converting the identified page into an image and reducing the size of the image to a predetermined size. With reference to FIG. 12, a case is described in which a page having a high degree of similarity of the stored data identified to have a high degree of similarity is converted into a thumbnail image.

After step S1210, the process ends. After the process ends once, the process proceeds to step S1007 in FIG. 5.

With reference to FIG. 11, the case has been described in which a thumbnail image is generated based on the degree of similarity to the page of the identified stored data. However, a thumbnail image does not necessarily have to be generated based on the degree of similarity to the page of the identified stored data. For example, the degree of similarity may be calculated by comparing texts or images (i.e., individual texts or images within a page), and a thumbnail image including a text or image identified to have a high degree of similarity may be generated.

The thumbnail image generation unit 209 of the present embodiment generates thumbnail images through the processes illustrated in FIGS. 9 and 11, respectively.

The first embodiment has been described above with reference to FIGS. 1 to 12. The second embodiment is described below. In the first embodiment, the server apparatus 2 analyzes the scan data. In the second embodiment, the MFP 3 analyzes the scan data. The schematic hardware configuration of the entire system 1 according to the second embodiment and the hardware configuration of the components included in the system 1 according to the second embodiment are substantially the same as those illustrated in FIGS. 1 and 2, respectively, and detailed descriptions thereof are omitted.

FIG. 13 is a block diagram illustrating a functional configuration of the system 1 according to the second embodiment.

The server apparatus 2 of the second embodiment includes, as functional units, the scan data management unit 201, the scan data storage unit 202, the communication unit 207, the display data generation unit 208, the thumbnail image generation unit 209, the display control unit 210, the user authentication unit 211, and the user information storage unit 212. In other words, the server apparatus 2 according to the second embodiment has a configuration in which the character recognition unit 203, the document analysis unit 204, the scan data distribution destination determination unit 205, and the trained model storage unit 206 are excluded from the configuration of the server apparatus 2 according to the first embodiment (see FIG. 3).

The MFP 3 of the second embodiment includes, as functional units, the reading unit 301, the printing unit 302, the operation input unit 303, the display control unit 304, the communication unit 305, the data storage service access unit 306, the IC card reading unit 307, the data storage unit 308, the user authentication unit 309, a character recognition unit 310, a document analysis unit 311, a scan data distribution destination determination unit 312, and a trained model storage unit 313. In other words, the MFP 3 according to the second embodiment has a configuration in which the character recognition unit 310, the document analysis unit 311, the scan data distribution destination determination unit 312, and the trained model storage unit 313 are added to the configuration of the MFP 3 according to the first embodiment (see FIG. 3).

The functional units according to the second embodiment illustrated in FIG. 13 are substantially the same as those according to the first embodiment illustrated in FIG. 3, and detailed descriptions thereof are omitted. The scan data storage unit 202 according to the second embodiment stores correspondence information between the classification of the scan data and the folder for storing the scan data, and stores the scan data in a folder corresponding to the classification.

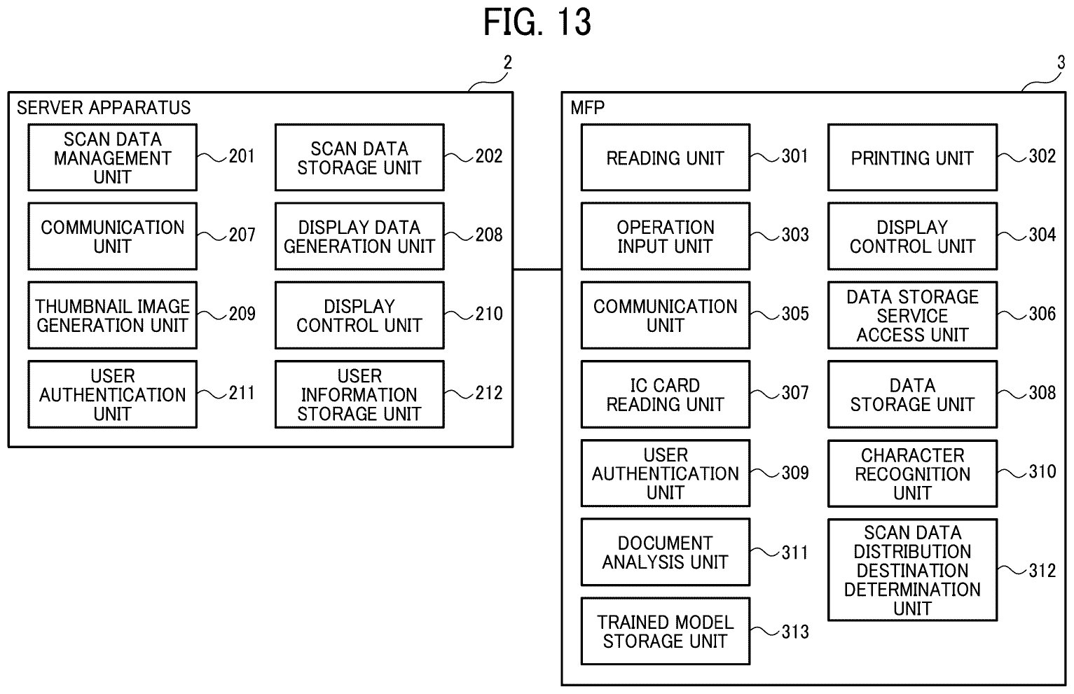

The process according to the second embodiment is described below with reference to FIG. 14. FIG. 14 is a flowchart of the process executed by the MFP 3 according to the second embodiment. In the description with reference to FIG. 14, the descriptions of the processes that are the same or substantially the same as the processes of the flowchart illustrated in FIG. 5 are omitted as appropriate.

The MFP 3 starts the process. In step S2001, the process branches depending on whether scanning has been executed. In step S2001, a screen as illustrated in FIG. 6A is displayed. When the user selects to store the scan data in the virtual cabinet, the process branches depending on whether the scanning has been executed.

In the case where the scanning has not been executed in step S2001 (NO in step S2001), the process of step S2001 is repeated to wait for execution of the scanning. In the case where the scanning has been executed in step S2001 (YES in step S2001), the process proceeds to step S2002.

In step S2002, the scan data is stored in a temporary folder. In step S2003, characters included in the scan data are obtained and converted into text data. In step S2004, a sentence vector is generated from the text data. In step S2005, an appropriate classification is determined using the trained model. The processes in steps S2002 to S2005 are substantially the same as the processes in steps S1002 to S1005 in FIG. 5 according to the first embodiment, but are performed by the MFP 3.

In step S2006, the communication unit 305 of the MFP 3 requests the server apparatus 2 to provide an image of a cabinet and a thumbnail image. In step S2006, the communication unit 305 of the MFP 3 transmits the request for the image of the cabinet and the thumbnail image together with the information on the classification determined to have the highest probability in step S2005. When the server apparatus 2 receives the request for the image of the cabinet and the thumbnail image, the display data generation unit 208 generates an image of a cabinet in which a drawer (a folder serving as the storage location candidate) corresponding to the determined classification is opened, and the thumbnail image generation unit 209 of the server apparatus 2 generates one or more thumbnail images of the other scan data stored in the folder serving as the storage location candidate (see step S1006). The communication unit 207 of the server apparatus 2 transmits the generated image of the cabinet and the thumbnail images to the MFP 3.

In step S2007, the display control unit 304 controls the display 36 to display the image of the cabinet and the thumbnail images received from the server apparatus 2. In step S2007, for example, a screen as illustrated in FIG. 7A is displayed.

In step S2008, the process branches depending on whether the user presses the “Yes” button B1 or the “No” button B2. For example, in the case where the user presses the “Yes” button B1 on the screen of FIG. 7A, the process proceeds to step S2009. In the case where the user presses the “No” button B2, the process proceeds to step S2011.

In the case where the user presses the “Yes” button B1 in step S2008 (YES in step S2008), in step S2009, the communication unit 305 transmits the scan data stored in the temporary folder to the server apparatus 2. In step S2009, the communication unit 305 transmits the information on the classification together with the scan data. Thus, the scan data management unit 201 of the server apparatus 2 can store the scan data in the folder corresponding to the classification. When the server apparatus 2 transmits the image of the cabinet and the thumbnail images to the MFP 3, the server apparatus 2 may also transmit a uniform resource locator (URL) for accessing the folder for storing the scan data. When the MFP 3 receives the URL, the communication unit 305 transmits the scan data to the location indicated by the URL. Thus, the scan data is directly stored in the storage location indicated by the URL, and the process performed by the scan data management unit 201 can be omitted.

In step S2010, the communication unit 305 receives the image of the cabinet with the drawers closed from the server apparatus 2, and the display control unit 304 controls the display 36 to display the image of the cabinet. In step S2010, the display control unit 304 controls the display 36 to display, for example, an image as illustrated in FIG. 6B. Then, the MFP 3 ends the process.

On the other hand, in the case where the user presses the “No” button B2 in step S2008 (NO in step S2008), the scan data distribution destination determination unit 312 determines a classification that has the next highest probability after the classification of the current storage location candidate in step S2011. Then, the process returns to step S2006 and the above-described processes are repeated. The process in step S2011 is substantially the same as the process in step S1011 in FIG. 5 according to the first embodiment.

Through the process of the flowchart illustrated in FIG. 14, the MFP 3 classifies the scan data and stores the scan data in an appropriate folder in the server apparatus 2.

The second embodiment has been described above with reference to FIGS. 13 and 14. The third embodiment is described below. In the first and second embodiments described above, the scan data is classified based on the text data. In the third embodiment, scan data is classified based on images (graphic objects) such as photographs and figures included in a document in addition to the context of a sentence included in the document. The schematic hardware configuration of the entire system 1 according to the third embodiment and the hardware configuration of the components included in the system 1 according to the third embodiment are substantially the same as those illustrated in FIGS. 1 and 2, respectively, and detailed descriptions thereof are omitted.

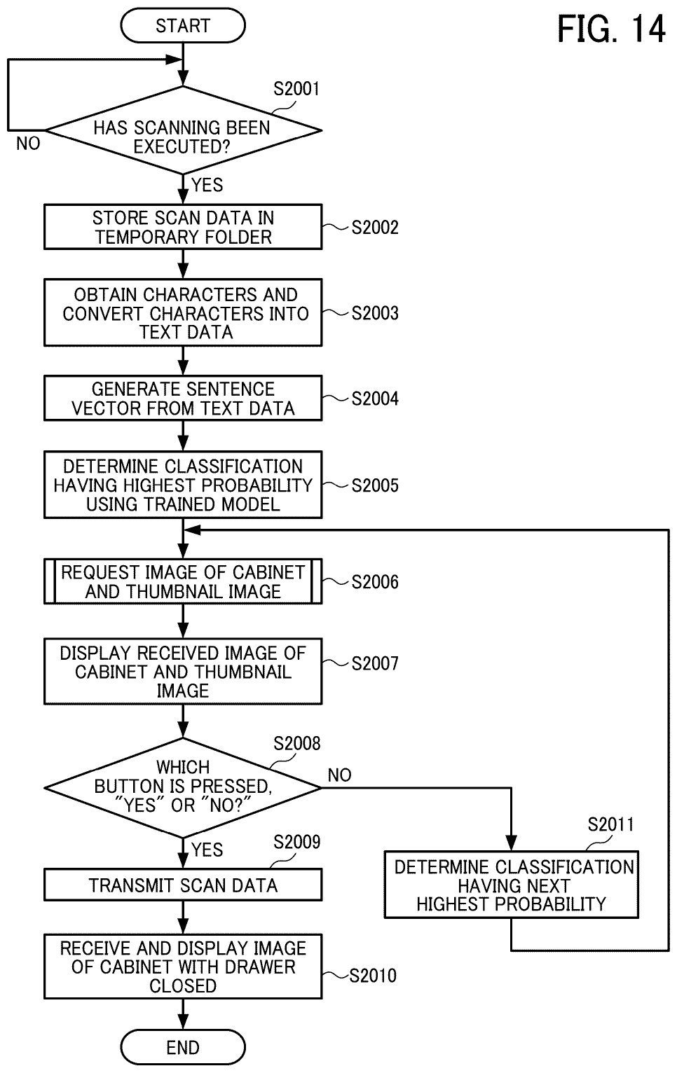

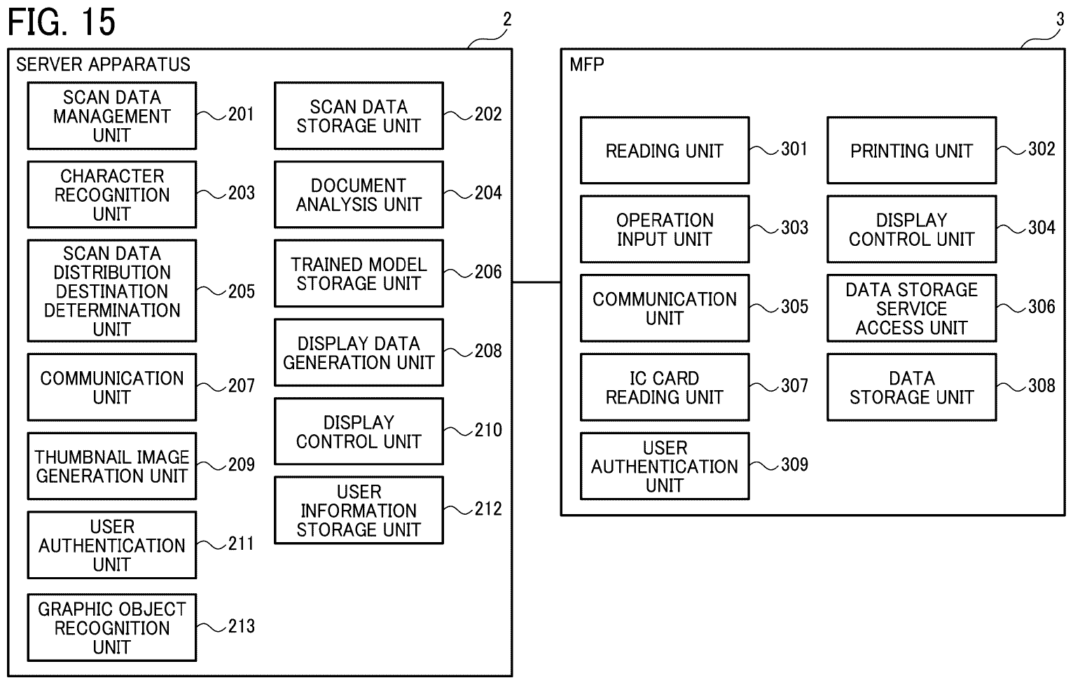

FIG. 15 is a block diagram illustrating a functional configuration of the system 1 according to the third embodiment.

The server apparatus 2 includes, as functional units, the scan data management unit 201, the scan data storage unit 202, the character recognition unit 203, the document analysis unit 204, the scan data distribution destination determination unit 205, the trained model storage unit 206, the communication unit 207, the display data generation unit 208, the thumbnail image generation unit 209, the display control unit 210, the user authentication unit 211, the user information storage unit 212, and a graphic object recognition unit 213. In other words, the server apparatus 2 according to the third embodiment has a configuration in which the graphic object recognition unit 213 is added to the configuration of the server apparatus 2 according to the first embodiment (see FIG. 3). The MFP 3 includes, as functional units, the reading unit 301, the printing unit 302, the operation input unit 303, the display control unit 304, the communication unit 305, the data storage service access unit 306, the IC card reading unit 307, the data storage unit 308, and the user authentication unit 309. In other words, the MFP 3 according to the third embodiment has the same configuration as that of the MFP 3 according to the first embodiment (see FIG. 3). The functional units other than the graphic object recognition unit 213 according to the third embodiment illustrated in FIG. 15 are substantially the same as those according to the first embodiment illustrated in FIG. 3, and detailed descriptions thereof are omitted.

The graphic object recognition unit 213 recognizes a graphic object in a document associated with scan data. The graphic object recognition unit 213 serves as a recognition function in the present embodiment. The graphic object recognition unit 213 of the present embodiment obtains and recognizes a graphic (an object) such as a photograph or a figure included in the scan data. The graphic object recognition unit 213 performs, for example, a process for recognizing a graphic object in the scan data in parallel with the process of step S1003 in FIG. 5. The graphic object recognition unit 213 applies a known image recognition algorithm to the scan data to identify a graphic object. The graphic object recognition unit 213 obtains feature data such as the shape, color, and brightness of an object, converts the feature data into vector data (referred to as an object vector in the following description), and outputs the vector data to the document analysis unit 204.

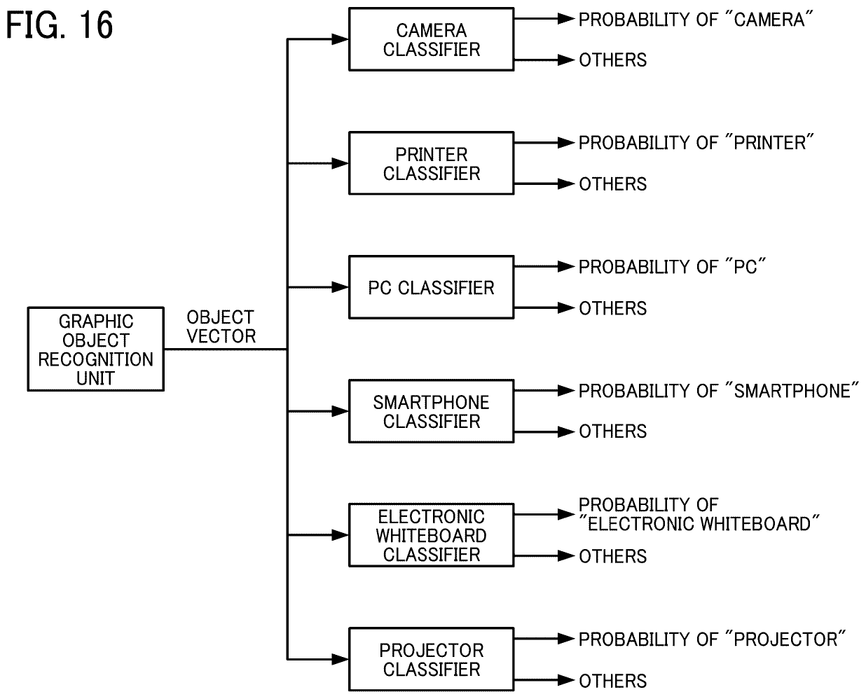

In the third embodiment, the document analysis unit 204 uses the trained model to classify the scan data based on the sentence vector generated from the text data and the object vector output from the graphic object recognition unit 213. Classification of the scan data based on a graphic object according to the third embodiment is described below with reference to FIG. 16. FIG. 16 is a diagram illustrating how the scan data is analyzed according to the third embodiment.

As illustrated in FIG. 16, the object vector output from the graphic object recognition unit 213 is input to each classifier. Each classifier outputs the probability of each classification, similar to each classifier illustrated in FIG. 4. In the third embodiment, the trained model is generated by performing machine learning on an image including an object. Accordingly, when an object vector is input, the classifier classifies an object included in the object vector. For example, when classifying scan data obtained by scanning a document containing a photograph of a PC, the probability of the PC is output as high, and the probabilities of the other classifications are output as low.

The document analysis unit 204 classifies the scan data based on the probability of classification according to the text data (see FIG. 4) and the probability of classification according to the graphic object. For example, the document analysis unit 204 weights the probability of classification according to the text data and the probability of classification according to the graphic object, and determines a classification having a high probability among the classifications, set the determined classification as the storage location candidate of the scan data. The weighting may be, for example, based on the number of characters in the text data or the number of graphic objects.

When different classifications are output based on the probability of classification according to the text data and the probability of classification according to the graphic object, one of the different classifications may be displayed to the user as a candidate folder, and a flag indicating that the classifications of the outputs do not match (referred to as a “mismatch flag” in the following description) may be recorded. For example, a case is described below on the assumption that the “smartphone” is set as the candidate folder based on the probability of classification according to the text data, and the “camera” is set as the candidate folder based on the probability of classification according to the graphic object. In this case, after recording the mismatch flag, a screen indicating the “smartphone” is displayed to the user as the candidate folder. In the case where the user selects not to store the scan data in the “smartphone” folder, another screen indicating the “camera” that is determined to have a high probability based on the graphic object (for which the mismatch flag is recorded) is displayed as the candidate folder, without performing the process for determining a classification having the next highest probability (see step S1011). In this way, a classification having a high probability is determined without performing the process for determining a classification having the next highest probability. Thus, the accuracy of the classification for storing data is increased.

According to the third embodiment, since the scan data is classified based on the text data and the graphic object, the accuracy of classification is increased. In the third embodiment, the case has been described in which the scan data is classified based on the text data and the graphic object. However, the classification does not necessarily have to be performed based on the text data. For example, the scan data may be classified based only on the graphic object.

In the embodiment described above, the case has been described in which the scan data obtained by the MFP 3 executing scanning is classified and stored. However, the data to be stored may be data other than the scan data. In the fourth embodiment, a case is described in which audio data is classified and stored.

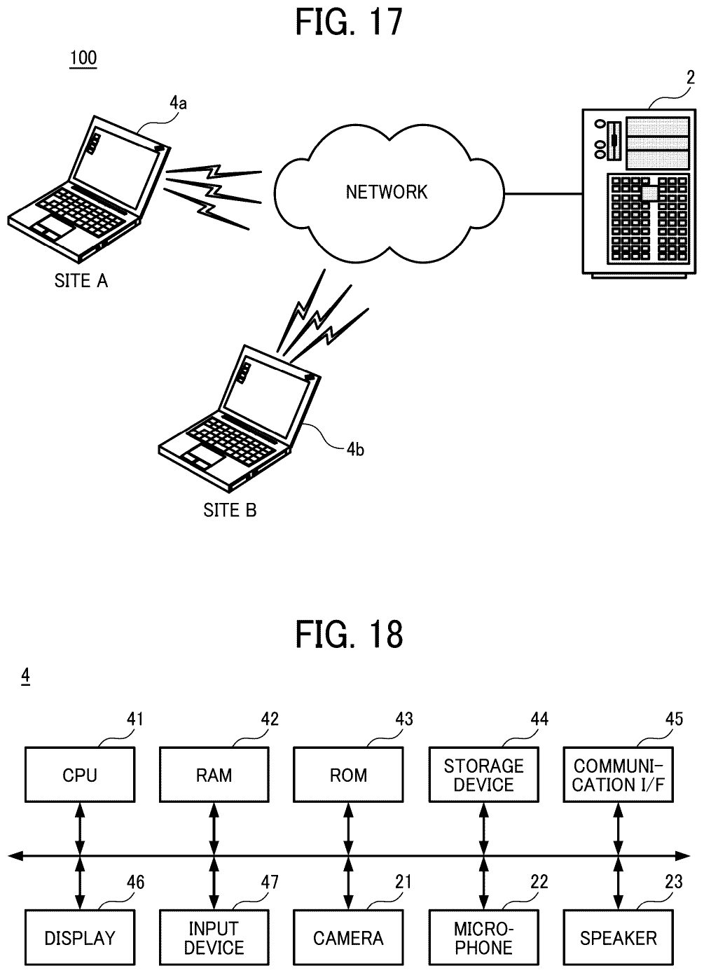

FIG. 17 is a schematic diagram illustrating an overall hardware configuration of the system 1 according to the fourth embodiment. In FIG. 17, an environment in which the server apparatus 2 and multiple communication terminals such as personal computer terminals 4 are connected via a network is illustrated. It is assumed that a personal computer terminal 4a is located at a site A and a personal computer terminal 4b is located at a site B. The fourth embodiment is described below as a case in which audio data obtained when a conference (so-called web conference) is held between the personal computer terminals 4a and 4b through the network is stored in the server apparatus 2. In the following description, any one of the personal computer terminals 4 is referred to as a personal computer terminal 4 unless particularly distinguished from each other.

FIG. 18 is a block diagram illustrating a hardware configuration of the personal computer terminal 4 according to the fourth embodiment. As illustrated in FIG. 18, the personal computer terminal 4 includes a CPU 41, a RAM 42, a ROM 43, a storage device 44, a communication I/F 45, a display 46, an input device 47, a camera 21, a microphone 22, and a speaker 23. The hardware components are connected to one another via a bus. The CPU 41, the RAM 42, the ROM 43, the storage device 44, the communication I/F 45, the display 46, and the input device 47 are substantially the same as those described with reference to FIG. 2A, and detailed descriptions thereof are omitted.

The camera 21 is a device for capturing an image, and captures a still image and a moving image. In the present embodiment, the state of another user can be viewed by transmitting the image capture by the camera 21 at the other site to the personal computer terminal 4 at the site in the web conference.

The microphone 22 is a device for acquiring audio. In the present embodiment, the microphone 22 transmits the acquired audio to the personal computer terminal 4 at the other site. The speaker 23 is a device for outputting audio. In the present embodiment, the speaker 23 outputs the audio received from the other site. By using the microphone 22 and the speaker 23 of each of the personal computer terminals 4, conversation takes place between the users in the web conference.

The hardware configuration of the server apparatus 2 according to the fourth embodiment is substantially the same as that illustrated in FIG. 2A, and a detailed description thereof is omitted.

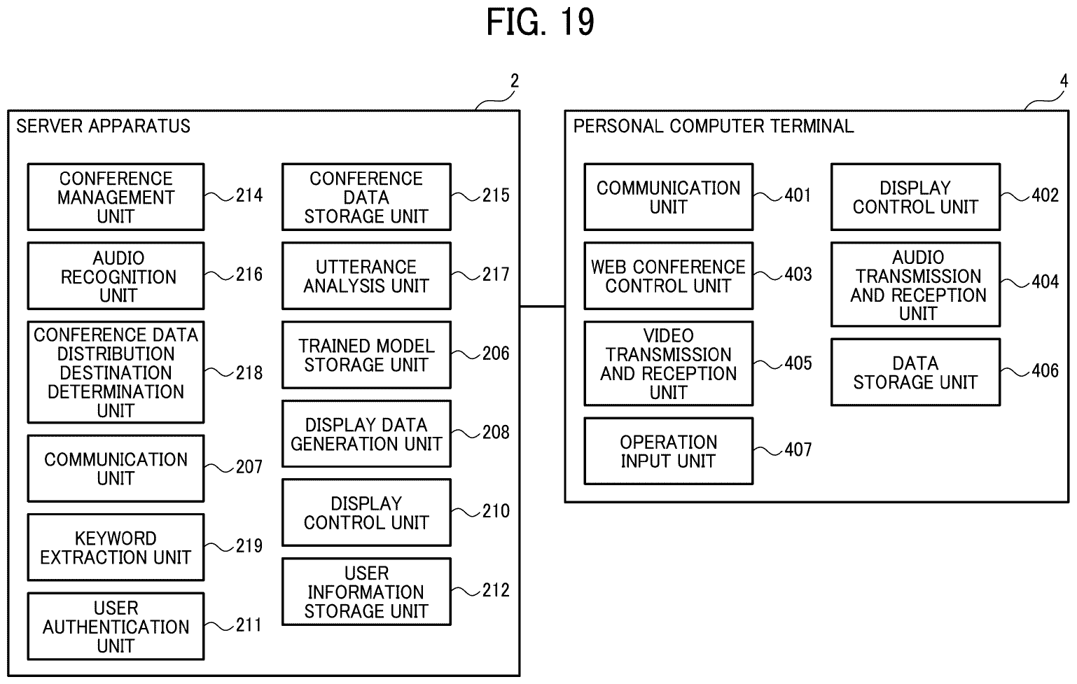

FIG. 19 is a block diagram illustrating a functional configuration of the system 1 according to the fourth embodiment. The server apparatus 2 includes, as functional units, a conference management unit 214, a conference data storage unit 215, an audio recognition unit 216, an utterance analysis unit 217, a conference data distribution destination determination unit 218, the trained model storage unit 206, the communication unit 207, the display data generation unit 208, a keyword extraction unit 219, the display control unit 210, the user authentication unit 211, and the user information storage unit 212. The personal computer terminal 4 includes, as functional units, a communication unit 401, a display control unit 402, a web conference control unit 403, an audio transmission and reception unit 404, a video transmission and reception unit 405, a data storage unit 406, and an operation input unit 407. The functional units are described in detail below.

The functional units of the server apparatus 2 are described below. The communication unit 207, the display data generation unit 208, the display control unit 210, the user authentication unit 211, and the user information storage unit 212 included in the server apparatus 2 are substantially the same as those described in the first embodiment, and detailed descriptions thereof are omitted.

The conference management unit 214 manages a web conference held between the personal computer terminals 4. The conference management unit 214 serves as a management function in the present embodiment. The conference management unit 214 of the present embodiment manages information for identifying the web conference and participants of the conference in association with each other. The conference management unit 214 manages the exchange of video and audio between the sites. For example, the conference management unit 214 transmits an image captured and audio acquired by the personal computer terminal 4a at the site A to the personal computer terminal 4b at the site B. The conference management unit 214 according to the present embodiment, for example, writes various data related to the web conference in a predetermined folder and reads out data from a specified folder.

The conference data storage unit 215 controls the operation of the storage device 44 to store the data related to the web conference (referred to as conference data in the following description). The conference data storage unit 215 serves as a storage function in the present embodiment. The conference data storage unit 215 of the present embodiment stores various conference data such as audio data and video data exchanged between the users in the web conference, conference material data used in the web conference, and text data converted from the audio data. The conference data storage unit 215 of the present embodiment stores the conference data in folders according to the theme and contents of the conference. As the folders for storing the conference data, for example, a folder of a conference related to “medical care,” a folder of a conference related to “education,” a folder of a conference related to “construction,” a folder of a conference related to “transportation,” a folder of a conference related to “agriculture,” and a folder of a conference related to “production” can be set.

The audio recognition unit 216 recognizes audio included in the audio data in the web conference and converts the audio into text data. The audio recognition unit 216 serves as a recognition function in the present embodiment. The audio recognition unit 216 of the present embodiment performs voice recognition processing on the audio data received from the personal computer terminal 4 participating in the web conference to output the text data.

The utterance analysis unit 217 analyzes the text data output from the audio recognition unit 216 to generate a sentence vector including context information. The utterance analysis unit 217 serves as an analysis function in the present embodiment. The vector data is generated, for example, by applying a natural language processing model such as BERT to the text data. The utterance analysis unit 217 of the present embodiment uses a parameter stored in the trained model storage unit 206 to perform a machine learning program using the vector data as an input to a classifier. Thus, the utterance analysis unit 217 classifies the contents of the conference associated with the audio data. In this way, a folder for storing the conference data is determined.

The conference data distribution destination determination unit 218 determines to which folder in the conference data storage unit 215 the conference data should be distributed. The conference data distribution destination determination unit 218 serves as a determination function in the present embodiment. In the present embodiment, the conference data distribution destination determination unit 218 determines a folder for storing the conference data based on the contents of the conference classified by the utterance analysis unit 217, and distributes the conference data to the folder in the conference data storage unit 215.

The keyword extraction unit 219 extracts words having high frequencies of appearance (for example, the top four words) included in the text data as specific keywords. The keyword extraction unit 219 serves as an extraction function in the present embodiment. The keyword extraction unit 219 of the present embodiment extracts keywords for each of multiple pieces of conference data from a single folder. The keyword extraction unit 219 also extracts, for example, a specific keyword from the most recently stored conference data (i.e., the conference data lastly stored). Since the words having high frequencies of appearance are highly likely to be words featuring the conference data, the keyword extraction unit 219 extracts specific keywords as feature information obtained by analyzing the stored data in the folder serving as the storage location candidate, and displays a list of the specific keywords. Thus, the user can easily make a decision to select the storage location for storing the conference data.

The functional units of the personal computer terminal 4 are described below. The communication unit 401, the display control unit 402, the data storage unit 406, and the operation input unit 407 included in the personal computer terminal 4 are substantially the same as those included in the MFP 3 described in the first embodiment, and detailed descriptions thereof are omitted.

The web conference control unit 403 controls a web conference application for the web conference held through the server apparatus 2. The web conference control unit 403 serves as a control function in the present embodiment. The web conference control unit 403 of the present embodiment executes the web conference application to perform, for example, conversation with the other user at the other site, exchange of videos, and sharing of materials.

The audio transmission and reception unit 404 controls the operation of the communication I/F 45 to transmit and receive audio data. The audio transmission and reception unit 404 serves as a transmission and reception function in the present embodiment. The audio transmission and reception unit 404 of the present embodiment transmits the audio data acquired by the microphone 22 to the other site and receives audio data from the other site. The audio data received from the other site is output from the speaker 23.

The video transmission and reception unit 405 controls the operation of the communication I/F 45 to transmit and receive video data. The video transmission and reception unit 405 serves as a transmission and reception function in the present embodiment. The video transmission and reception unit 405 of the present embodiment transmits the video data captured by the camera 21 to the other site and receives video data from the other site. The video data received from the other site is displayed on the display 46.

The above-described functional units correspond to functions implemented by the CPU 41 executing programs to function hardware components. All the functional units described in the embodiments may be implemented by software. Alternatively, a part or all of the functional units may be implemented by pieces of hardware each of which provides the equivalent function.

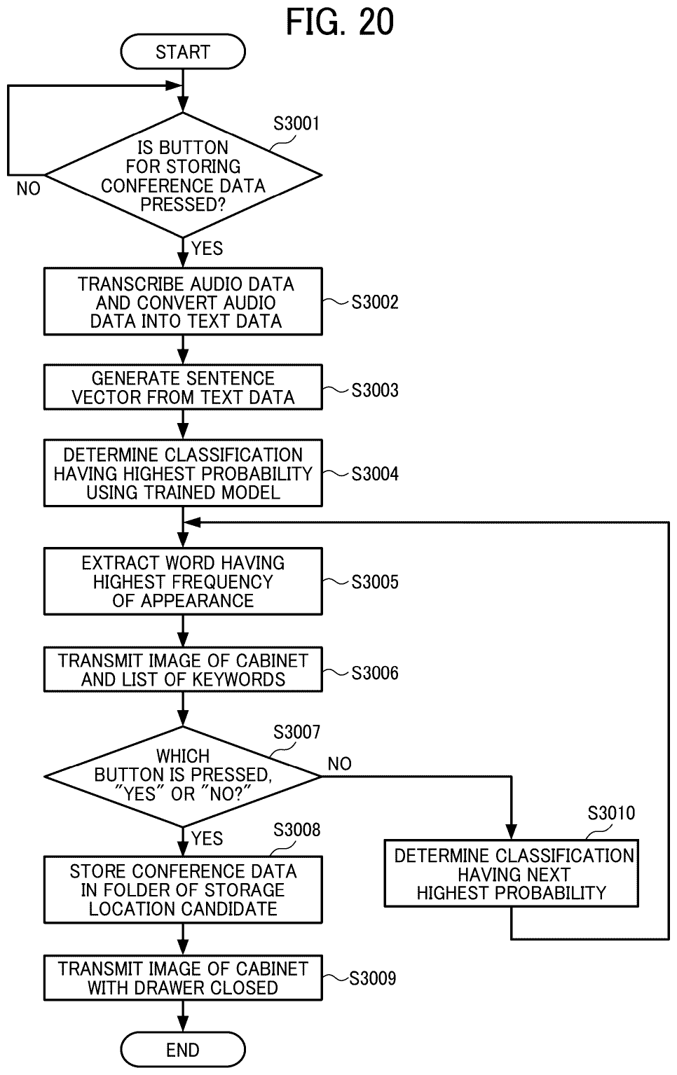

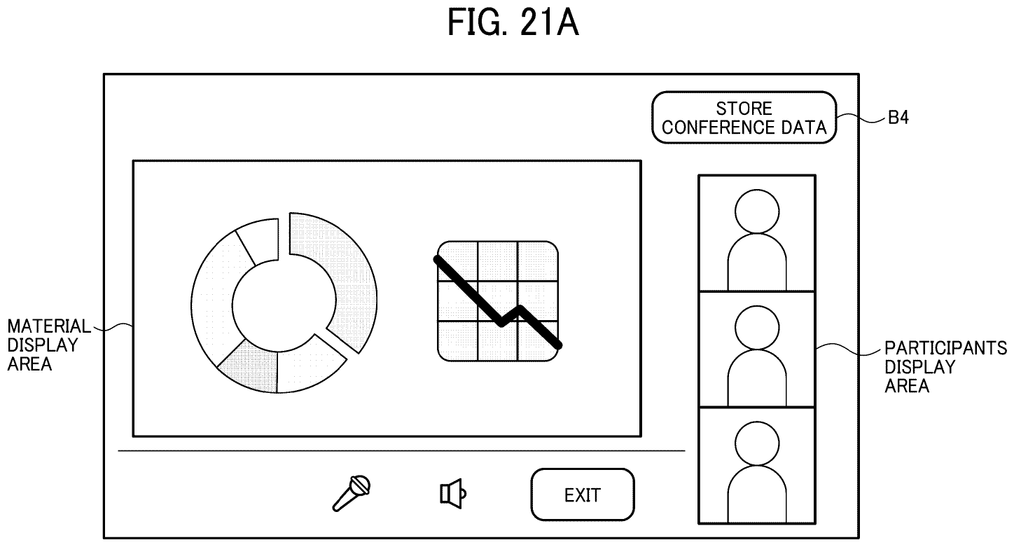

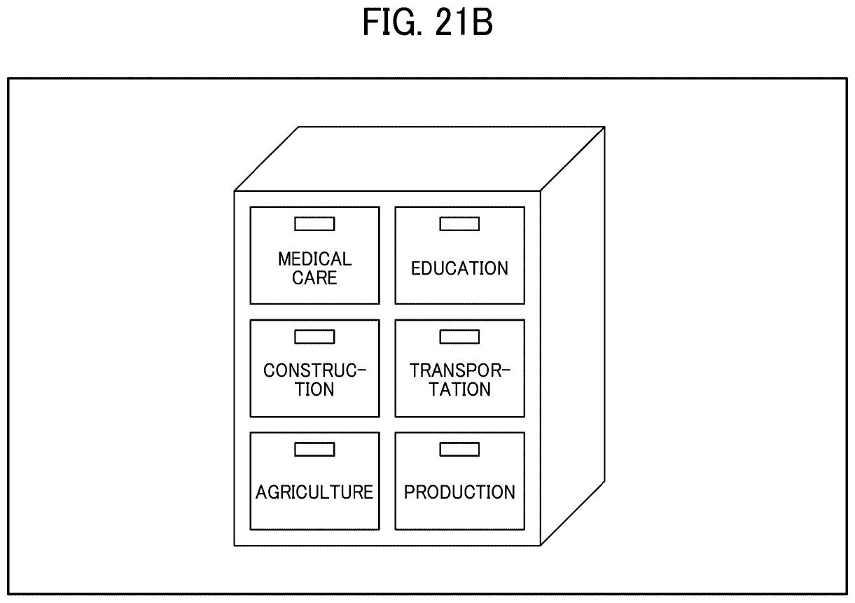

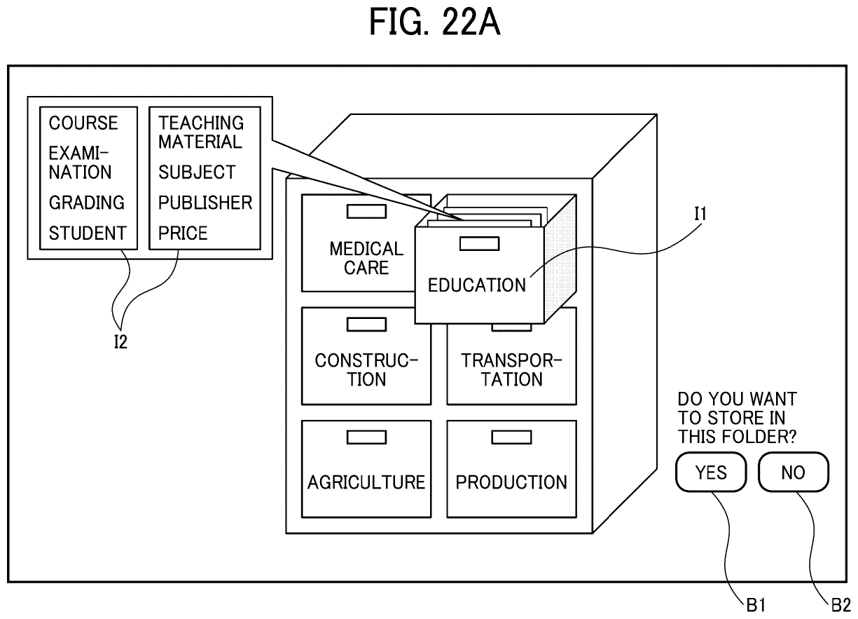

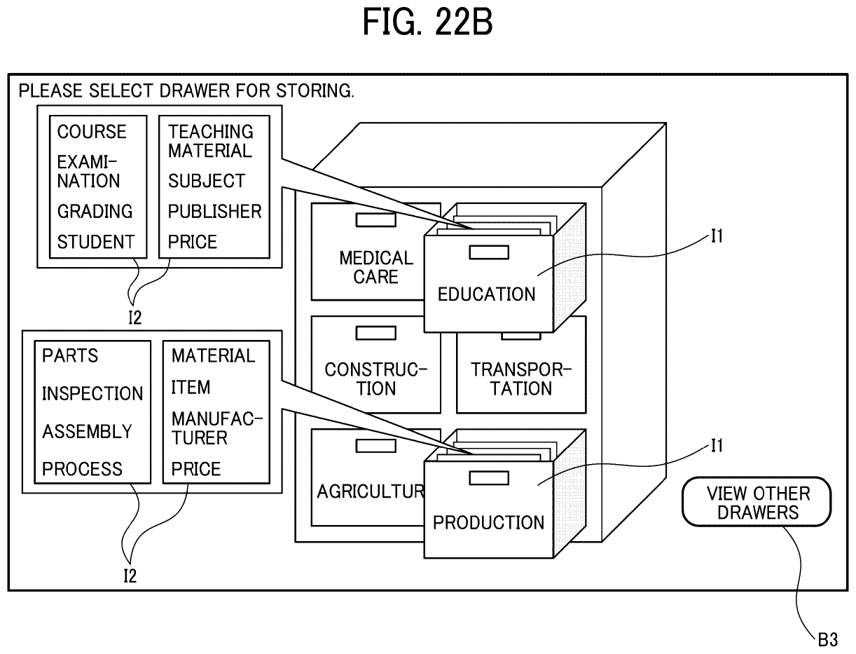

The functional units included in the system 1 of the fourth embodiment has been described above. Subsequently, the processes executed by the functional units are described below with reference to FIG. 20. FIG. 20 is a flowchart of the process executed by the server apparatus 2 according to the fourth embodiment. In the following description of FIG. 20, FIGS. 21A to 22B are referred to as appropriate. FIGS. 21A to 22B are diagrams each illustrating a screen displayed in the fourth embodiment.

The server apparatus 2 starts the process. The server apparatus 2 stores audio data and conference material data received from the personal computer terminal 4 in a temporary folder. In step S3001, the process branches depending on whether a button for storing the conference data of the web conference application is pressed. As the screen of the web conference application in this case, a screen as illustrated in FIG. 21A is displayed. As illustrated in FIG. 21A, the screen of the web conference application includes a participants display area where videos of users participating in the web conference are displayed and a material display area where a material being shared in the web conference is displayed. When a “store conference data” button B4 is pressed on the screen illustrated in FIG. 21A, the server apparatus 2 performs a process for storing the conference data.

In the case where the “store conference data” button B4 is not pressed in step S3001 (NO in step S3001), the process of step S3001 is repeated to wait for the pressing of the “store conference data” button B4. In the case where the “store conference data” button B4 is pressed in step S3001 (YES in step S3001), the process proceeds to step S3002.

In step S3002, the audio recognition unit 216 applies voice recognition processing to the audio data stored in the temporary folder to transcribe the audio data and convert the audio data into text data. In step S3003, the utterance analysis unit 217 analyzes the text data to generate a sentence vector. In step S3004, the utterance analysis unit 217 inputs the sentence vector to each classifier to calculate the probability of falling into each classification using the trained model. In addition, in step S3004, the conference data distribution destination determination unit 218 determines a classification having the highest probability and sets the determined classification as a storage location candidate of the conference data.

In step S3005, the keyword extraction unit 219 extracts, as a specific keyword, a word having a high frequency of appearance included in the text data generated from the stored conference data in the folder serving as the storage location candidate of the conference data. For example, the keyword extraction unit 219 extracts multiple keywords featuring multiple pieces of stored conference data from pieces of text data generated from the multiple pieces of stored conference data.

In step S3006, the server apparatus 2 transmits, to the personal computer terminal 4, an image of a cabinet as information indicating a folder serving as the storage location candidate and a list of specific keywords serving as feature information obtained by analyzing the stored conference data in the folder serving as the storage location candidate. In the fourth embodiment, a cabinet with drawers that are regarded as folders serving as storage locations is displayed. In FIG. 21B, a display example of a virtual cabinet is illustrated. In the virtual cabinet of the present embodiment, images of multiple drawers corresponding to multiple folders are displayed. In other words, as illustrated in FIG. 21B, a folder for storing conference data related to the medical care is presented as a “medical care” drawer. A folder for storing conference data related to the education is presented as a “education” drawer. A folder for storing conference data related to the construction is presented as a “construction” drawer. A folder for storing conference data related to the transportation is presented as a “transportation” drawer. A folder for storing conference data related to the agriculture is presented as an “agriculture” drawer. A folder for storing conference data related to the production is presented as a “production” drawer.

Returning to FIG. 20, the description continues. In step S3006, the display data generation unit 208 generates and transmits an image of the cabinet in which the drawer (i.e., a folder serving as the storage location candidate) corresponding to the classification determined in step S3004 is opened. In step S3006, a list of specific keywords extracted in step S3005 is also transmitted.

The image transmitted in step S3006 is displayed on the personal computer terminal 4 as illustrated in FIG. 22A. In FIG. 22A, a screen when the conference data is classified into the education is illustrated. Accordingly, as illustrated in FIG. 22A, the image (i.e., the storage location candidate folder display information I1) of the cabinet in which the “education” drawer determined to be the classification is opened is displayed on the personal computer terminal 4. In the case where other conference data is already stored in the “education” folder, as illustrated in FIG. 22A, a list of specific keywords extracted from the stored conference data is also displayed. In FIG. 22A, featuring keywords (i.e., the feature information I2) extracted from the other conference data stored in the “education” folder are displayed. By viewing the screen as illustrated in FIG. 22A, the user can recognize that conference data related to a “course,” “examination,” “grading,” and a “student” and conference data related to “teaching material,” a “subject,” a “publisher,” and a “price” are stored in the “education” folder, and can easily determine the storage location for storing the conference data.

In addition, as illustrated in FIG. 22A, a message “Do you want to store in this folder?” is displayed on the personal computer terminal 4. Also, the “Yes” button B1 and the “No” button B2 for allowing the user to make a selection in response to the message are displayed. After viewing the image of the virtual cabinet and the list of keywords, the user can determine the folder for storing the conference data by pressing the “Yes” button B1 or the “No” button B2.

Returning to FIG. 20, the description continues. After the data of the image to be displayed is transmitted to the personal computer terminal 4 in step S3006, the process branches in step S3007 depending on whether the user presses the “Yes” button B1 or the “No” button B2. For example, in the case where the user presses the “Yes” button B1 on the screen of FIG. 22A, the process proceeds to step S3008. In the case where the user presses the “No” button B2, the process proceeds to step S3010.

In the case where the user presses the “Yes” button B1 in step S3007 (YES in step S3007), in step S3008, the conference management unit 214 causes the conference data storage unit 215 to store the conference data stored in the temporary folder in the folder serving as the storage location candidate. For example, when the user presses the “Yes” button B1, that is, when the operation input unit 407 of the personal computer terminal 4 receives an operation for storing the conference data in the candidate folder, the communication unit 401 of the personal computer terminal 4 transmits a notification to the server apparatus 2 that the operation for storing the conference data in the candidate folder has been received. When the communication unit 207 of the server apparatus 2 receives the notification, the conference management unit 214 performs a process for storing the conference data in the candidate folder in step S3008.

In step S3009, the display data generation unit 208 generates an image of the cabinet with the drawers closed and transmits the image of the cabinet to the personal computer terminal 4. The image of the cabinet transmitted in step S3009 is displayed on the personal computer terminal 4, for example, as an image illustrated in FIG. 21B. Then, the server apparatus 2 ends the process.

On the other hand, in the case where the user presses the “No” button B2 in step S3007 (NO in step S3007), the conference data distribution destination determination unit 218 determines a classification that has the next highest probability after the classification of the current storage location candidate in step S3010. Then, the process returns to step S3005 and the above-described processes are repeated. For example, when the user presses the “No” button B2, that is, when the operation input unit 407 of the personal computer terminal 4 receives an operation for not storing the conference data in the candidate folder, the communication unit 401 of the personal computer terminal 4 transmits a notification to the server apparatus 2 that the operation for not storing the conference data in the candidate folder has been received. When the communication unit 207 of the server apparatus 2 receives the notification, the conference data distribution destination determination unit 218 performs a process for determining a classification having the next highest probability in step S3010.

In this way, by repeating the process when the user presses the “No” button B2, the user is allowed to select an appropriate storage location for storing the conference data. In particular, by setting a classification having a high probability as a storage location candidate based on the sentence vector generated from the conference data, the workload for the user in selecting a folder is reduced.

With reference to the flowchart illustrated in FIG. 20 and the examples of the screens illustrated in FIGS. 22A to 22B, the case has been described in which a single classification having a high probability is set as a storage location candidate. However, the number of classifications is not limited to one. Accordingly, two or more classifications each having a high probability may be set as the storage location candidate.

For example, it is assumed that top two classifications having higher probabilities are determined to be the education and the production. As illustrated in FIG. 22B, the display data generation unit 208 generates data for displaying an image of the cabinet with the education and production drawers opened, and the keyword extraction unit 219 extracts specific keywords from the text data stored in the “education” folder and the “production” folder. The user can view an image as illustrated in FIG. 22B and is allowed to select either the “education” folder or the “production” folder as the storage location for storing the conference data. In the case where the user determines that neither folder is appropriate as a storage location, the user is allowed to select the “view other drawers” button (i.e., the other candidates display button B3).

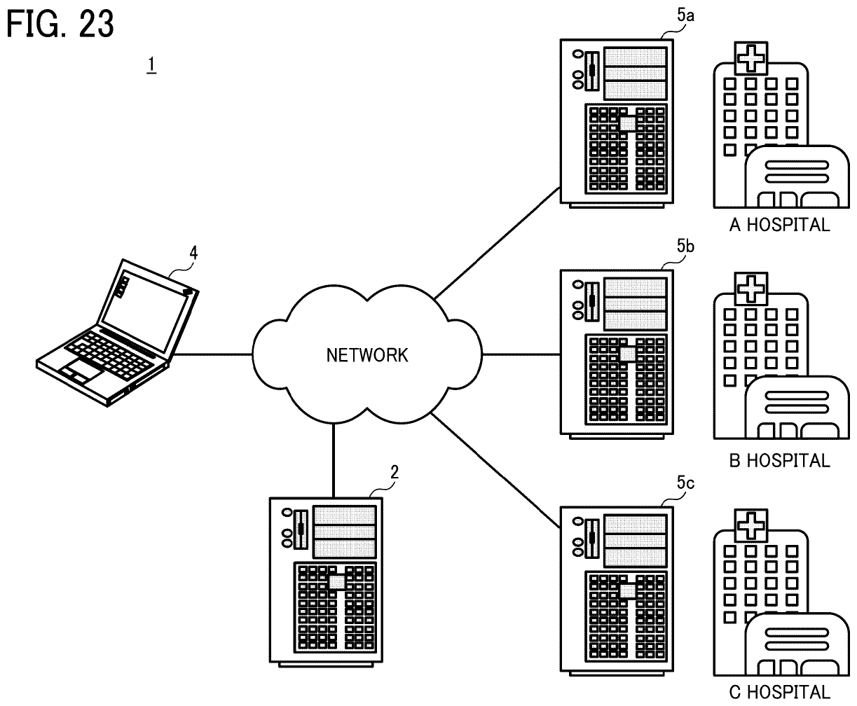

In the first to fourth embodiments described above, a folder is used as the storage location, and data is stored in one of multiple folders. However, the folder is given by way of example as the storage location, and the storage location is not limited thereto. The data may be stored in a storage location other than a folder. For example, the data may be stored in one of multiple physical storage areas. The physical storage areas may be included in a storage medium such as a hard disk drive or a solid-state drive, or may be included in an information processing apparatus such as a server computer for storing data. The fifth embodiment in which data is stored in a physical storage area is described below with reference to FIGS. 23 to 25B. In the fifth embodiment, a case is described in which data is stored in an external server apparatus for storing the data.

FIG. 23 is a schematic diagram illustrating an overall hardware configuration of the system 1 according to the fifth embodiment. In FIG. 23, an environment in which the server apparatus 2, the personal computer terminal 4, and multiple data storage servers 5 are connected via a network such as the Internet or a LAN is illustrated. In the following description, any one of the data storage servers 5 is referred to as a data storage server 5 unless particularly distinguished from one another. The number of data storage servers 5 included in the system 1 is not limited to that illustrated in FIG. 5 and has no limitations. As illustrated in FIG. 23, a data storage server 5a is located in a hospital A, a data storage server 5b is located in a hospital B, and a data storage server 5c is located in a hospital C. In the fifth embodiment below, a case is described in which diagnostic data such as a medical record or an X-ray image acquired by the personal computer terminal 4 is stored in the data storage server 5 located in one of the hospitals.

In the fifth embodiment, since the hardware configurations of the server apparatus 2 and the data storage server 5 are substantially the same as that illustrated in FIG. 2A and the hardware configuration of the personal computer terminal 4 is substantially the same as that illustrated in FIG. 18, detailed descriptions thereof are omitted.

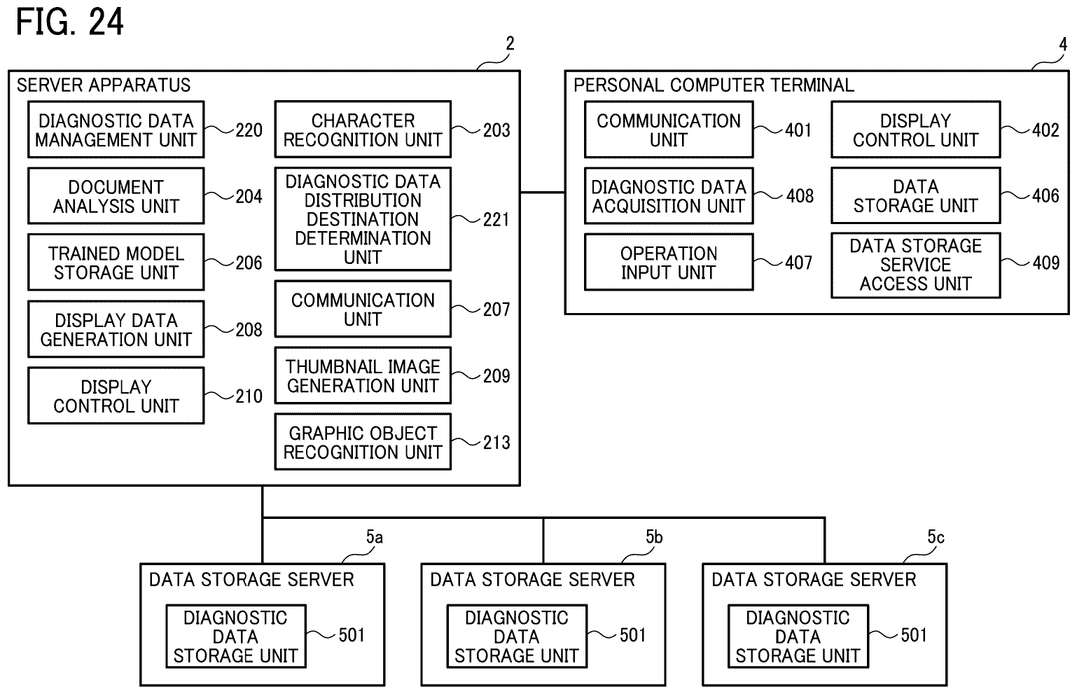

FIG. 24 is a block diagram illustrating a functional configuration of the system 1 according to the fifth embodiment. The server apparatus 2 includes, as functional units, a diagnostic data management unit 220, the character recognition unit 203, the document analysis unit 204, a diagnostic data distribution destination determination unit 221, the trained model storage unit 206, the communication unit 207, the display data generation unit 208, the thumbnail image generation unit 209, the display control unit 210, and the graphic object recognition unit 213. The personal computer terminal 4 includes, as functional units, the communication unit 401, the display control unit 402, a diagnostic data acquisition unit 408, the data storage unit 406, the operation input unit 407, and a data storage service access unit 409. Each of the data storage servers 5 includes a diagnostic data storage unit 501. The functional units are described in detail below.

The functional units of the character recognition unit 203, the document analysis unit 204, the trained model storage unit 206, the communication unit 207, the display data generation unit 208, the thumbnail image generation unit 209, the display control unit 210, the graphic object recognition unit 213, the communication unit 401, the display control unit 402, the data storage unit 406, the operation input unit 407, and the data storage service access unit 409 are substantially the same as those according to the first embodiment illustrated in FIG. 3 and the fourth embodiment illustrated in FIG. 19, and detailed descriptions thereof are omitted. The diagnostic data management unit 220, the diagnostic data distribution destination determination unit 221, and the diagnostic data storage unit 501 are functional units corresponding to the scan data management unit 201, the scan data distribution destination determination unit 205, and the scan data storage unit 202 in FIG. 3, respectively, and detailed descriptions thereof are omitted.

The diagnostic data acquisition unit 408 acquires diagnostic data such as a medical record, an X-ray image, a magnetic resonance imaging (MRI) image, and a computed tomography (CT) image. The diagnostic data acquisition unit 408 serves as an acquisition function in the present embodiment. The diagnostic data acquisition unit 408 of the present embodiment acquires various diagnostic data, for example, using software for creating a medical record or a scanner. The acquired diagnostic data is stored in the data storage unit 406, or stored in the data storage servers 5 of the hospitals using a data storage service via the server apparatus 2.

The processes executed by the functional units of the present embodiment are substantially the same as those of the flowchart of the first embodiment illustrated in FIG. 5, and detailed descriptions thereof are omitted. In the fifth embodiment, a data storage server in a hospital is identified as a storage location candidate of diagnostic data based on analysis of text data in a medical record performed by the document analysis unit 204 or recognition of a graphic object (e.g., a part of a lung, brain, or heart subjected to diagnosis) in an image such as an X-ray image, an MRI image, or a CT image performed by the graphic object recognition unit 213. Further, in the fifth embodiment, an image in which an icon representing a hospital where the data storage server 5 serving as the storage location candidate is located is enlarged larger than icons representing the other hospitals is displayed. Also, a thumbnail image of other diagnostic data stored in the data storage server 5 serving as the storage location candidate in the hospital is displayed to the user such as a doctor who uses the personal computer terminal 4. In this way, by viewing the thumbnail image, the user can determine whether the determined data storage server 5 in the hospital is appropriate as a storage location for storing the diagnostic data.

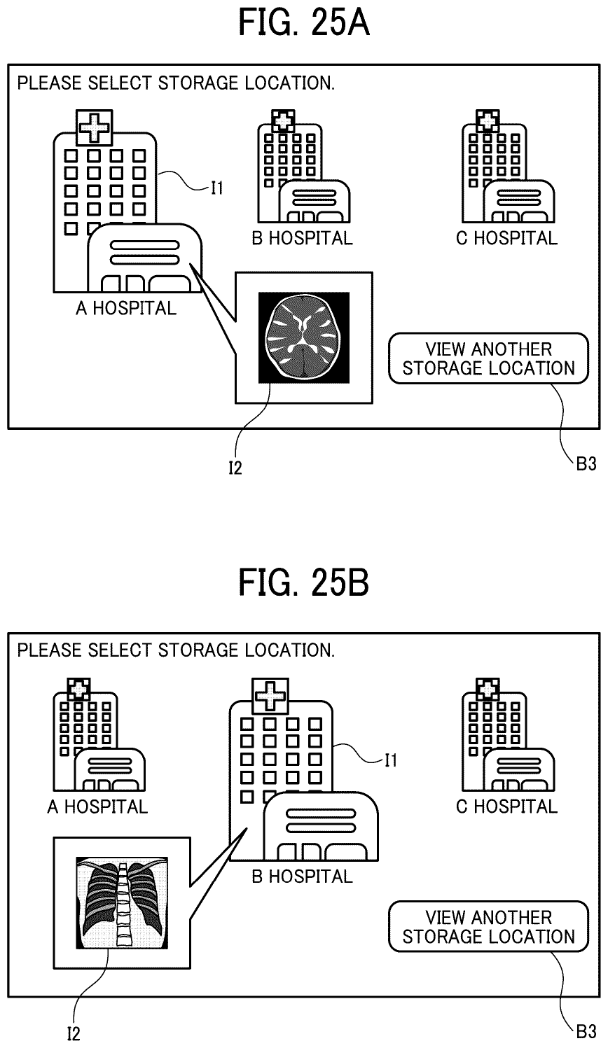

The information indicating the data storage server 5 serving as the storage location candidate may be, for example, an image in which the icon (the icon of the hospital A in FIG. 25A, which is the storage location candidate folder display information I1) of the hospital where the data storage server 5 serving as the storage location candidate is enlarged larger than the icons of the other hospitals. The feature information obtained by analyzing the stored data in the data storage server 5 serving as the storage location candidate may be, for example, a thumbnail image (e.g., a CT image in FIG. 25A, which is the feature information 12) of the other diagnostic data stored in the data storage server 5 serving as the storage location candidate in the hospital.

FIGS. 25A and 25B are diagrams each illustrating a screen displayed in the fifth embodiment. In FIG. 25A, a screen displayed when the data storage server 5a in the hospital A is identified as the storage location candidate is illustrated. As illustrated in FIG. 25A, the icon (storage location candidate folder display information I1) indicating the hospital A where the data storage server 5a serving as the storage location candidate is located is enlarged larger than the icons of the other hospitals and is displayed together with the thumbnail image (feature information I2) of the other diagnostic data (e.g., the CT image) stored in the data storage server 5a in the hospital A.

For example, when the user selects the “hospital A” where the data storage server 5a is located as the storage location for storing the diagnostic data, that is, when the operation input unit 407 of the personal computer terminal 4 receives an operation for storing the diagnostic data in the “hospital A” where the data storage server 5a is located, the communication unit 401 of the personal computer terminal 4 transmits a notification to the server apparatus 2 that the operation for storing the diagnostic data in the data storage server 5a in the hospital A has been received. In response to receiving the notification, the diagnostic data management unit 220 of the server apparatus 2 transmits the diagnostic data to the data storage server 5a in the hospital A via the communication unit 207, and causes the diagnostic data storage unit 501 to store the diagnostic data.

In addition, on the screen illustrated in FIG. 25A, a “view another storage location” button (i.e., the other candidates display button B3) is displayed. When the user determines that the hospital A where the data storage server 5a is located is not appropriate as the storage location for storing the diagnostic data, by the user pressing the “view another storage location” button (i.e., the other candidates display button B3), another hospital where another data storage server 5 is located, which has the next highest probability, is displayed as the storage location candidate.

For example, when the user presses the “view another storage location” button (i.e., the other candidates display button B3), that is, when the operation input unit 407 of the personal computer terminal 4 receives an operation for not storing the diagnostic data in the storage location candidate (i.e., the data storage server 5a in the hospital A in FIG. 25A), the communication unit 401 of the personal computer terminal 4 transmits a notification to the server apparatus 2 that an operation for not storing the diagnostic data in the storage location candidate has been received. When the communication unit 207 of the server apparatus 2 receives the notification, the diagnostic data distribution destination determination unit 221 performs a process for determining a classification having the next highest probability.

In FIG. 25B, a screen displayed when the data storage server 5b in the hospital B is identified as the storage location candidate is illustrated. For example, when the “view another storage location” button (i.e., the other candidates display button B3) is pressed on the screen illustrated in FIG. 25A, a screen as illustrated in FIG. 25B is displayed. As illustrated in FIG. 25B, the icon (storage location candidate folder display information I1) indicating the hospital B where the data storage server 5b serving as the storage location candidate is located is enlarged larger than the icons of the other hospitals and is displayed together with the thumbnail image (feature information I2) of the other diagnostic data stored in the data storage server 5b in the hospital B.

In the fifth embodiment described with reference to FIGS. 23 to 25B, the case of storing the diagnostic data is given by way of example. However, the data to be stored is not limited to the diagnostic data. Accordingly, for example, an image indicating a construction situation acquired at a construction site or an inspection image may be stored in one of the multiple data storage servers 5. Further, the data to be stored may be a wide-angle image such as a panoramic image or a spherical image, or a moving image.

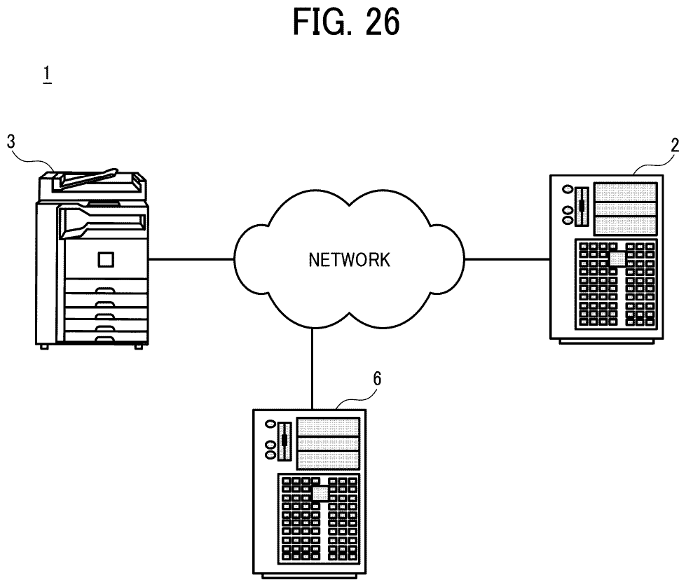

The fifth embodiment has been described above with reference to FIGS. 23 to 25B. The sixth embodiment is described below with reference to FIGS. 26 to 30B. In the embodiments described above, the thumbnail images generated from the stored data in the folder serving as the storage location candidate and the feature information such as the extracted keywords are displayed together with the information indicating the storage location candidate. However, the feature information is not limited to the keywords. As will be described in the sixth embodiment, for example, the feature information may be generated by so-called generative artificial intelligence (AI) using a large-scale language model.

FIG. 26 is a schematic diagram illustrating an overall hardware configuration of the system 1 according to the sixth embodiment. In FIG. 26, an environment in which the server apparatus 2, the MFP 3, and a generative AI server 6 are connected via a network such as the Internet or a LAN is illustrated. The number of MFPs 3 included in the system 1 is not limited to that illustrated in FIG. 26 and has no limitations. The method for connecting each apparatus to the network may be either wired or wireless. The server apparatus 2 and the MFP 3 according to the sixth embodiment are substantially the same as those illustrated in FIG. 1, and detailed descriptions thereof are omitted.

The generative AI server 6 is an information processing apparatus that provides a service (i.e., a generative AI service) for generating a response to information input to the information processing apparatus. Examples of the generative AI service include, but are not limited to, services such as COPILOT, CHAT GPT, and GEMINI. In the generative AI service, natural language processing is performed using the large-scale language model, the input information is analyzed to determine the context, and a response is output. The server apparatus 2 and the generative AI server 6 may be integrally configured as a single apparatus.

In the sixth embodiment, since the hardware configurations of the server apparatus 2 and the generative AI server 6 are substantially the same as that illustrated in FIG. 2A and the hardware configuration of the MFP 3 is substantially the same as that illustrated in FIG. 2B, detailed descriptions thereof are omitted.

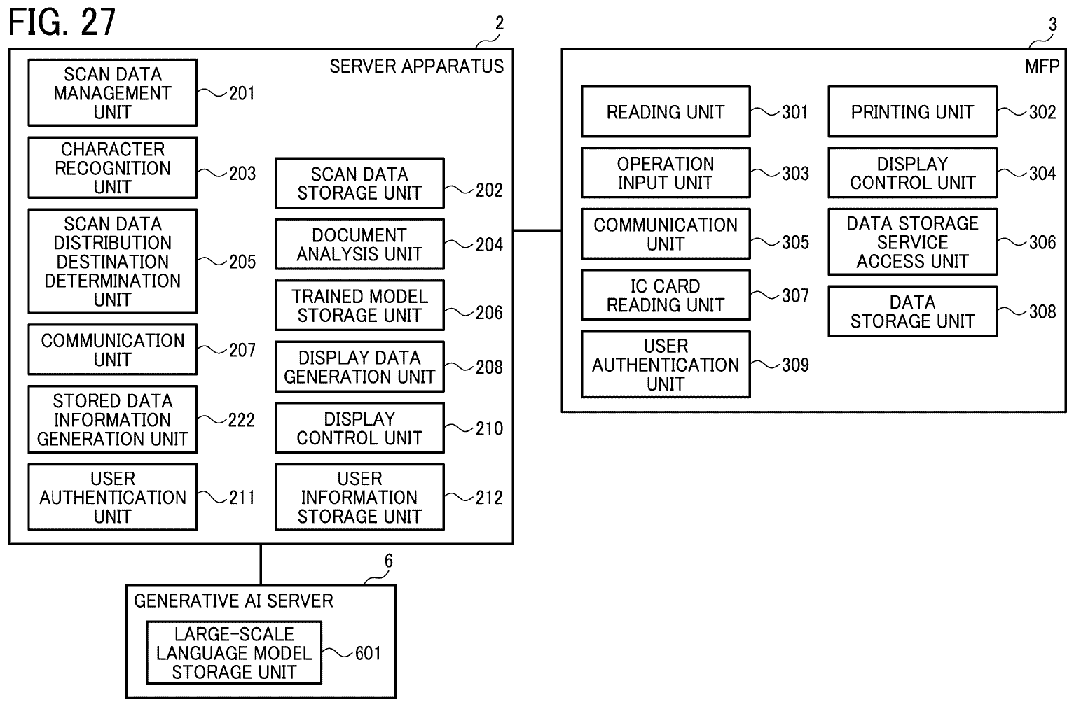

FIG. 27 is a block diagram illustrating a functional configuration of the system 1 according to the sixth embodiment.

The server apparatus 2 includes, as functional units, the scan data management unit 201, the scan data storage unit 202, the character recognition unit 203, the document analysis unit 204, the scan data distribution destination determination unit 205, the trained model storage unit 206, the communication unit 207, the display data generation unit 208, a stored data information generation unit 222, the display control unit 210, the user authentication unit 211, and the user information storage unit 212. The MFP 3 includes, as functional units, the reading unit 301, the printing unit 302, the operation input unit 303, the display control unit 304, the communication unit 305, the data storage service access unit 306, the IC card reading unit 307, the data storage unit 308, and the user authentication unit 309. The generative AI server 6 includes, as a functional unit, a large-scale language model storage unit 601. The functional units other than the stored data information generation unit 222 and the large-scale language model storage unit 601 according to the sixth embodiment illustrated in FIG. 27 are substantially the same as those according to the first embodiment illustrated in FIG. 3, and detailed descriptions thereof are omitted.

The stored data information generation unit 222 generates stored data information as feature information obtained by analyzing stored data in a folder serving as a storage location candidate. The stored data information generation unit 222 serves as a generation function in the present embodiment. The stored data information according to the present embodiment is, for example, breakdown information of the classification of the stored data included in the storage location candidate, which is obtained by analyzing the stored data having been stored in the storage location candidate. The stored data information generation unit 222 generates a breakdown of the classification, which is feature information obtained by analyzing the stored data in the folder serving as the storage location candidate using the stored data in the folder serving as the storage location candidate as an input to the large-scale language model of the generative AI server 6.

The large-scale language model storage unit 601 stores a large-scale language model associated with the generative AI service. The large-scale language model storage unit 601 serves as a storage function in the present embodiment. The large-scale language model is a computer language model that is generated by executing a training process using a huge amount of unlabeled text as training data and includes an artificial neural network having a large number of parameters. The large-scale language model is sufficiently trained by a method for learning a context, such as next-sentence prediction to understand a context by determining whether sentence 1 and sentence 2 are consecutive or a masked language model to understand a context by masking a word in a sentence and predicting the masked word from words that come before and after the masked word, to capture many sentence structures and meanings of human language. In the present embodiment, the stored data information is generated using the large-scale language model.

The above-described functional units correspond to functions implemented by the CPU 11 executing programs to function hardware components. All the functional units described in the present embodiment may be implemented by software. Alternatively, a part or all of the functional units may be implemented by pieces of hardware each of which provides the equivalent function.

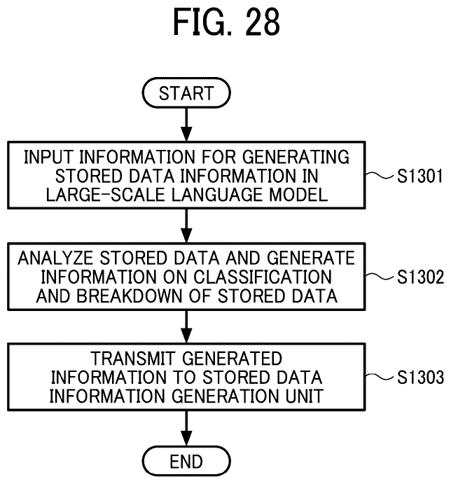

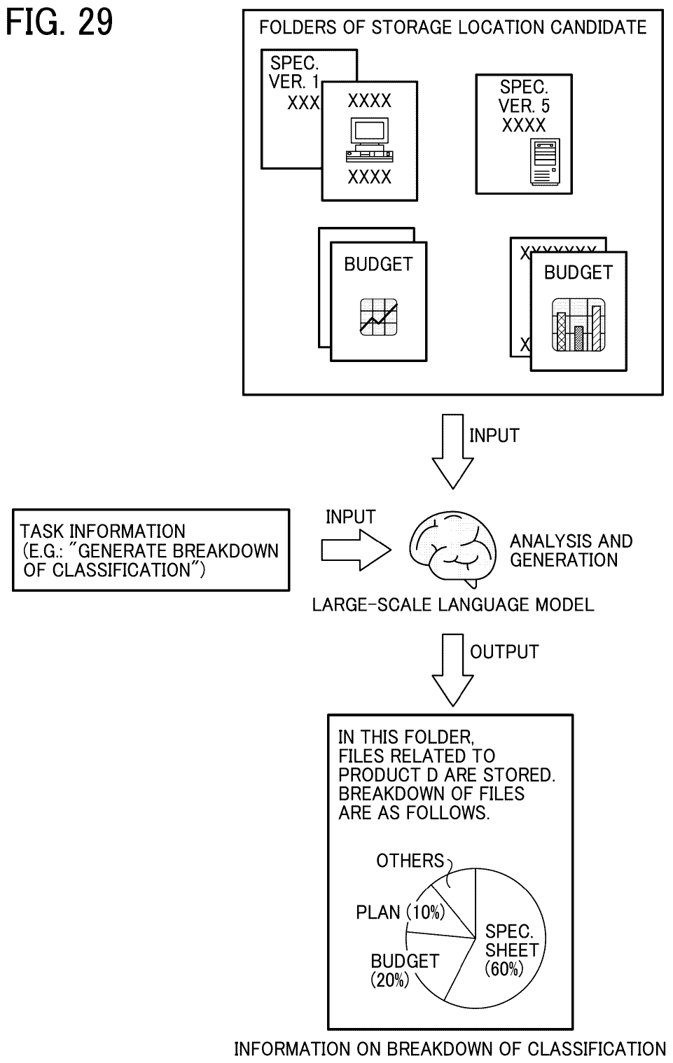

In the sixth embodiment, the functional units perform the same processes as those of the flowchart illustrated in FIG. 5 described in the first embodiment. However, in the sixth embodiment, the processes illustrated in FIG. 28 are performed instead of the processes for generating a thumbnail image in step S1006 of the flowchart illustrated in FIG. 5 (see FIGS. 9 and 11). FIG. 28 is a flowchart of the process for generating stored data information according to the sixth embodiment. In the following description of FIG. 28, FIG. 29 is referred to as appropriate. FIG. 29 is a conceptual diagram illustrating the process for generating stored data information according to the sixth embodiment.

The process for generating stored data information starts. In step S1301, the stored data information generation unit 222 inputs information for generating stored data information to the large-scale language model of the generative AI server 6. The information for generating stored data information may be, for example, stored data included in the folder serving as the storage location candidate, information on the storage location (e.g., a URL or path of the storage location) of the folder serving as the storage location candidate, or instruction information of a task (see FIG. 29). As an example of the instruction information of a task, a prompt using a natural sentence (an instruction sentence) such as “Please indicate the classification of stored data and the breakdown of the classification in graph” may be used. By inputting such instruction information of a task into the large-scale language model, stored data information indicating the breakdown of the classification of the stored data is output from the large-scale language model of the generative AI server 6.

In step S1302, the large-scale language model of the generative AI server 6 analyzes the stored data based on the input instruction information of a task, and generates information on the classification and breakdown of the classification of the stored data in the folder serving as the storage location candidate (see FIG. 29).

In step S1303, the generative AI server 6 transmits the generated information to the stored data information generation unit 222. After step S1303, the process ends. After the process ends once, the process proceeds to a process corresponding to the process of step S1007 in FIG. 5. However, in the sixth embodiment, instead of the process of S1007 (the transmission of the thumbnail image), the stored data information generated in the process of FIG. 28 is transmitted.

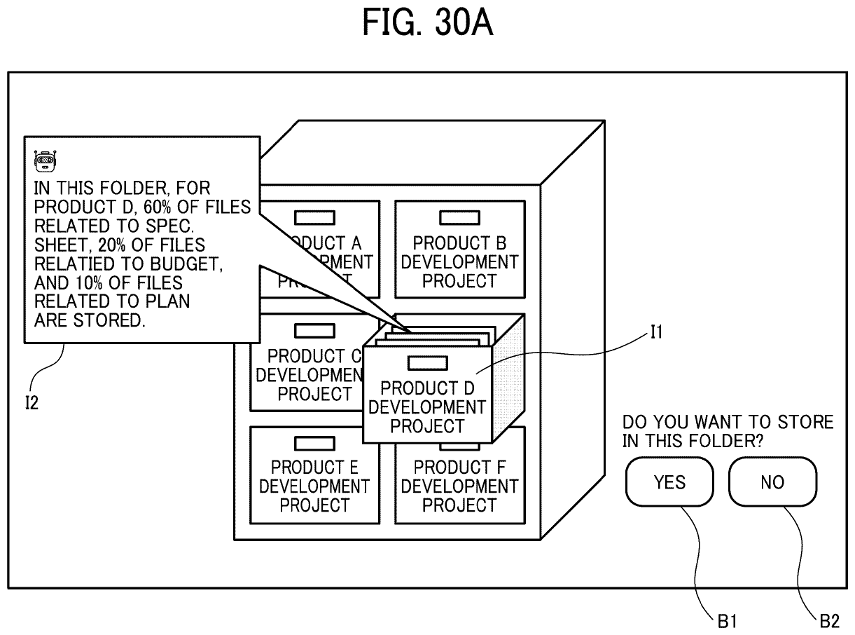

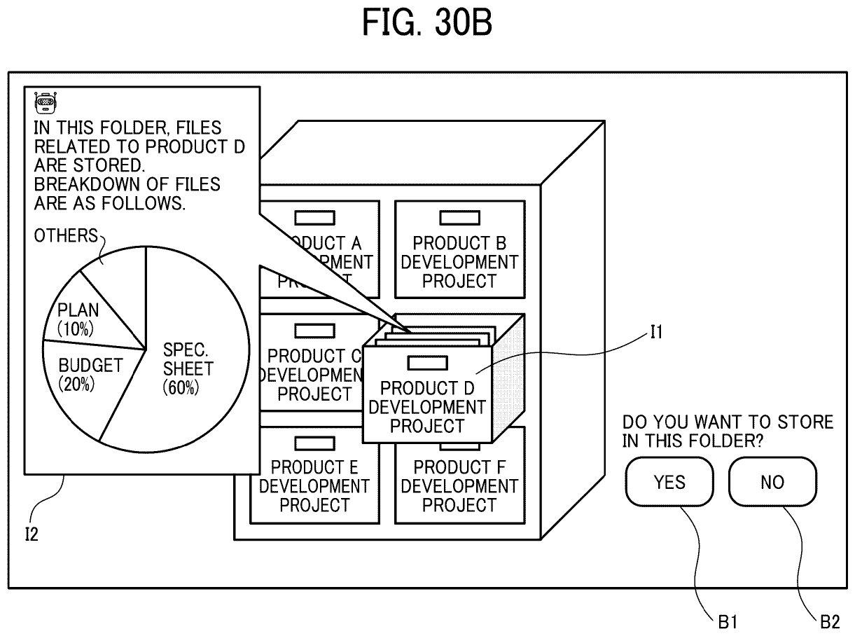

FIGS. 30A and 30B are diagrams each illustrating a screen displayed in the sixth embodiment. In the sixth embodiment, for example, stored data information is generated from data of a file most recently stored in a folder serving as the storage location candidate, or stored data information is generated from data of all files stored in a folder serving as the storage location candidate. In FIG. 30A, a screen when stored data information is generated from data of a file stored most recently in a folder serving as the storage location candidate is illustrated. In FIG. 30B, a screen when stored data information is generated from data of all files stored in a folder serving as the storage location candidate is illustrated.

In each of FIGS. 30A and 30B, a screen when the scan data is classified into a product D is illustrated. Accordingly, as illustrated in each of FIGS. 30A and 30B, an image (i.e., the storage location candidate folder display information I1) of a cabinet in which a “product D development project” drawer determined to be the classification (i.e., the folder serving as the storage location candidate) is opened is displayed on the MFP 3. The breakdown information of the classification of the stored data included in the storage location candidate, which is obtained by analyzing the stored data having been stored in the storage location candidate, is displayed in text or graph. For example, it is assumed that the breakdown information of the classification is displayed in text. As illustrated in FIG. 30A, a message (i.e., the feature information I2) is displayed as the feature information obtained by analyzing the stored data. The message indicates “In this folder, for the product D, 60% of files related to the specification sheet, 20% of files related to the budget, and 10% of files related to the plan are stored.”

On the other hand, it is assumed that the breakdown information of the classification is displayed in graph. As illustrated in FIG. 30B, a graph (i.e., the feature information I2) of the breakdown of the files (such as the composition ratio of the types of files) in the folder is displayed together with a message indicating “In this folder, files related to the product D are stored. The breakdown of the files are as follows.”

As described above, according to the sixth embodiment, by generating stored data information as the feature information related to the contents of the stored data in the candidate folder using the generative AI, the user is allowed to easily determine whether the candidate folder displayed on the screen is appropriate as a storage location for storing the file.

In the first to sixth embodiments described above, the data to be stored is scanned or created by an information processing apparatus such as the MFP 3 or the personal computer terminal 4. However, the data to be stored does not necessarily have to be scanned or created by the information processing apparatus. Accordingly, as will be described in the seventh and eighth embodiments below, for example, in a service provided on a cloud such as a file creation service, a data storage service, or a collaboration tool providing service, data created on the cloud or data uploaded on the cloud may be used as the data to be stored. The seventh embodiment is described below with reference to FIGS. 31 to 34B.

FIG. 31 is a schematic diagram illustrating an overall hardware configuration of the system 1 according to the seventh embodiment. In FIG. 31, an environment in which the server apparatus 2, the personal computer terminal 4, and the data storage server 5 are connected via a network such as the Internet or a LAN is illustrated. The server apparatus 2 of the present embodiment provides, on a cloud (online), services including a function of creating data to be stored. The server apparatus 2 of the present embodiment, like MICROSOFT 365 or GOOGLE WORKSPACE, provides, but not limited to, functions such as a document creation tool, a spreadsheet tool, and a presentation creation tool, and a data storage service on the cloud. In FIG. 31, the server apparatus 2 that provides the file creation service and the data storage server 5 are illustrated as individual apparatuses, but the configuration is not limited thereto. The server apparatus 2 and the data storage server 5 may be integrally configured as a single apparatus. Further, the terminal apparatus included in the system 1 is not limited to the personal computer terminal 4 as illustrated in FIG. 31, but may be an information processing apparatus such as a smartphone or a tablet terminal.

In the seventh embodiment, since the hardware configurations of the server apparatus 2 and the data storage server 5 are substantially the same as that illustrated in FIG. 2A and the hardware configuration of the personal computer terminal 4 is substantially the same as that illustrated in FIG. 18, detailed descriptions thereof are omitted.

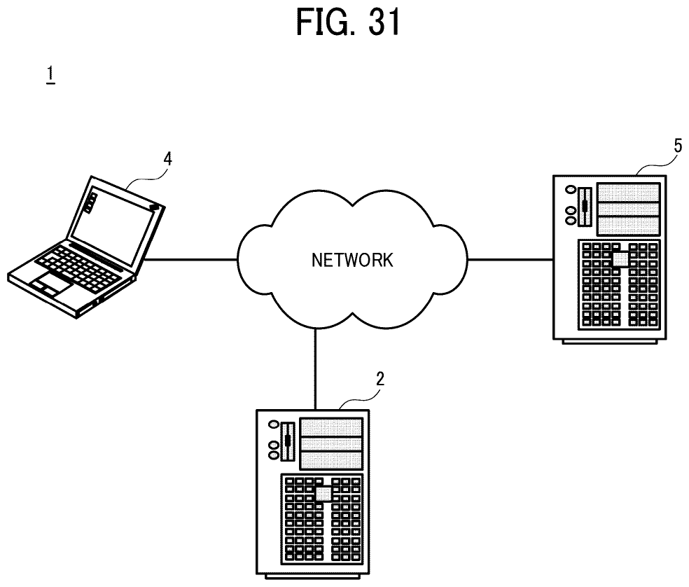

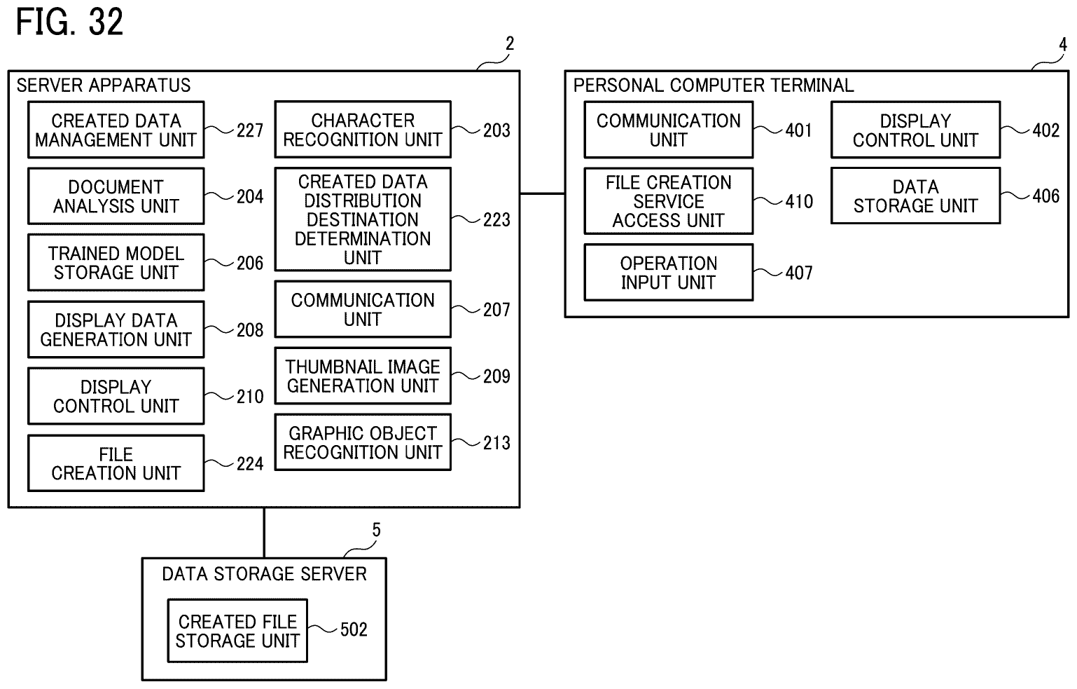

FIG. 32 is a block diagram illustrating a functional configuration of the system 1 according to the seventh embodiment. The server apparatus 2 includes, as functional units, a created data management unit 227, the character recognition unit 203, the document analysis unit 204, a created data distribution destination determination unit 223, the trained model storage unit 206, the communication unit 207, the display data generation unit 208, the thumbnail image generation unit 209, the display control unit 210, the graphic object recognition unit 213, and a file creation unit 224. The personal computer terminal 4 includes, as functional units, the communication unit 401, the display control unit 402, a file creation service access unit 410, the data storage unit 406, and the operation input unit 407. The data storage server 5 includes, as a functional unit, a created file storage unit 502.

Of the functional units in FIG. 32, the character recognition unit 203, the document analysis unit 204, the trained model storage unit 206, the communication unit 207, the display data generation unit 208, the thumbnail image generation unit 209, the display control unit 210, the graphic object recognition unit 213, the communication unit 401, the display control unit 402, the data storage unit 406, and the operation input unit 407 are described with reference to the block diagrams illustrating the functional units in the other embodiments, and detailed descriptions thereof are omitted. The display control unit 210 in the seventh embodiment may be configured to perform, for example, control for displaying information on the personal computer terminal 4 via a web browser. The created data management unit 227 and the created data distribution destination determination unit 223 correspond to, for example, the scan data management unit 201 and the scan data distribution destination determination unit 205 illustrated in FIG. 3, respectively, and detailed descriptions thereof are omitted. Also, the created file storage unit 502 corresponds to the diagnostic data storage unit 501 in FIG. 24, and a detailed description thereof is omitted.

The file creation unit 224 creates data (a file) on the cloud. The file creation unit 224 serves as a data creation function in the present embodiment. The file creation unit 224 of the present embodiment creates, for example, various files on the cloud via a browser. The file creation unit 224 creates, for example, a document file, a spreadsheet file, and a presentation file, and stores the files in the created file storage unit 502 serving as a data storage service.

The file creation service access unit 410 accesses the file creation service provided by the server apparatus 2. The file creation service access unit 410 serves as an access function in the present embodiment. The file creation service access unit 410 of the present embodiment requests, through the network, the file creation unit 224 of the server apparatus 2 to create various files and change the contents of a file. Also, the file creation service access unit 410 acquires information related to the file creation service from various functional units of the server apparatus 2 such as the display data generation unit 208 and the file creation unit 224, and causes the information to be displayed.

The above-described functional units correspond to functions implemented by the CPU 11 or the CPU 41 executing programs to function hardware components. All the functional units described in the present embodiment may be implemented by software. Alternatively, a part or all of the functional units may be implemented by pieces of hardware each of which provides the equivalent function. In a modification of the seventh embodiment, for example, a server apparatus that analyzes a document and a server apparatus that creates a file may be configured as individual information processing apparatuses.

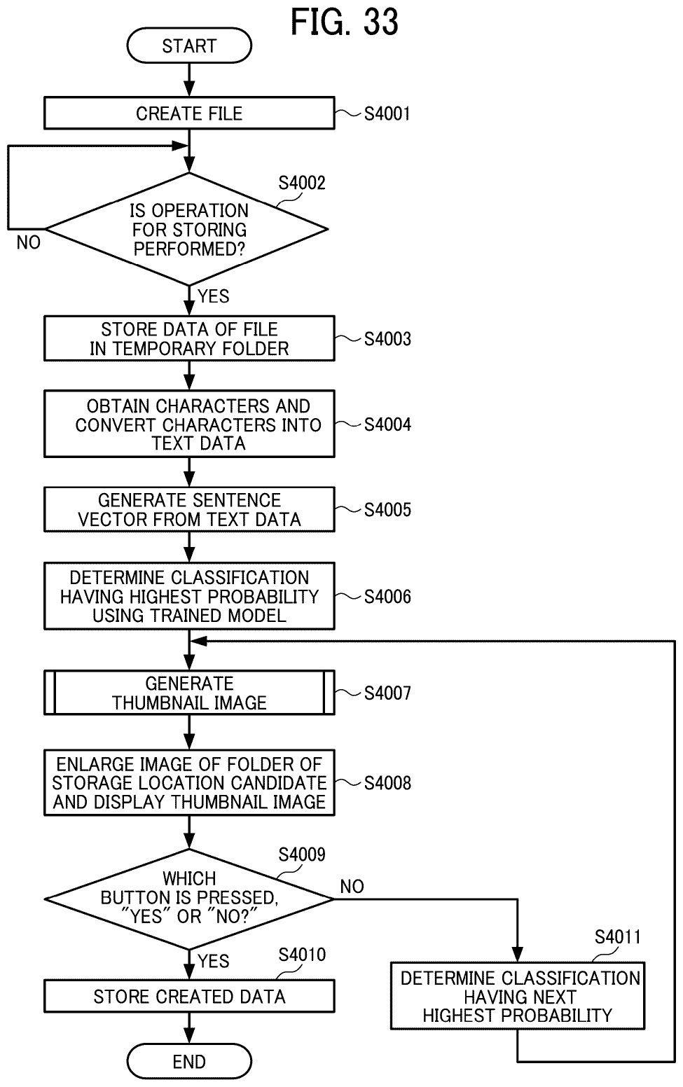

Subsequently, the processes executed by the functional units are described below with reference to FIG. 33. FIG. 33 is a flowchart of the process executed by the server apparatus 2 according to the seventh embodiment. The server apparatus 2 starts the process.

In step S4001, the file creation unit 224 creates a file. Examples of the file created in step S4001 include, but not limited to, a document file, a spreadsheet file, and a presentation file. The user is allowed to modify, on the cloud via the file creation service access unit 410, the contents of the created file.

In step S4002, the process branches depending on whether an operation for storing the file created in step S4001 has been performed. In the case where the operation for storing the file is not performed (NO in step S4002), the process of step S4002 is repeated to wait for the performing of the operation for storing the file. On the other hand, in the case where an operation for storing the file is performed (YES in step S4002), the process proceeds to step S4003. The operation for storing the file in step S4002 may not be performed by the user, and may be, for example, a process in which the file creation unit 224 automatically stores a file.

The processes of steps S4003 to S4007 in FIG. 33 are substantially the same as the processes of steps S1002 to S1006 in FIG. 5, and detailed descriptions thereof are omitted.

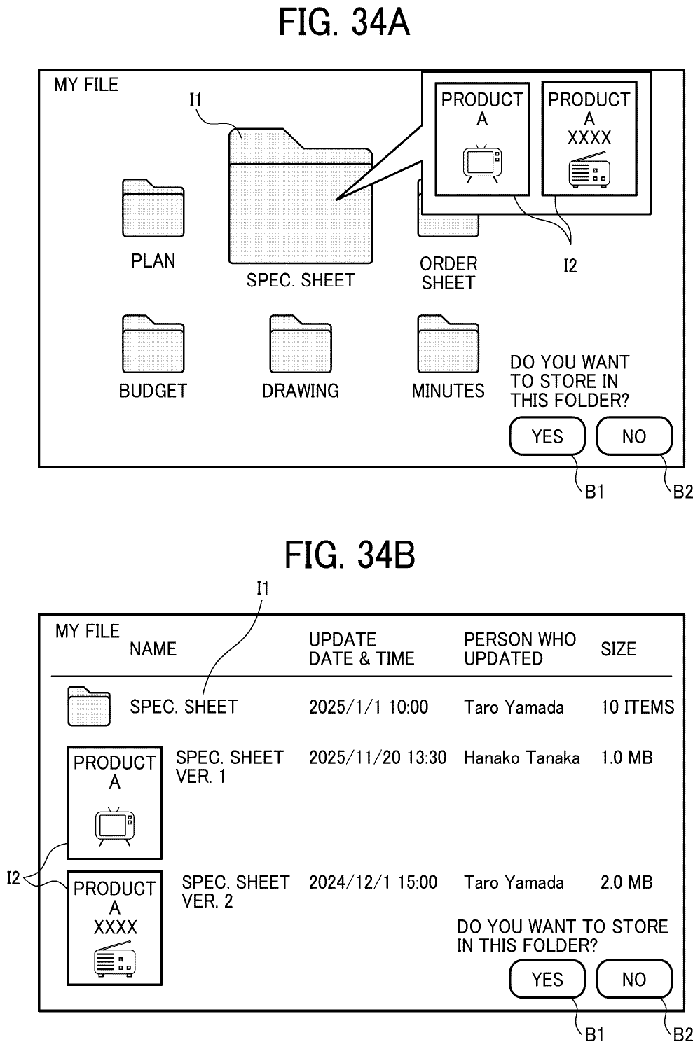

In step S4008, the display control unit 210 controls, via the communication unit 207, the personal computer terminal 4 to display an image obtained by enlarging an icon of a folder as information indicating a folder serving as a storage location candidate and a thumbnail image as feature information obtained by analyzing stored data in the folder serving as the storage location candidate. With reference to FIGS. 34A and 34B, screens displayed in the seventh embodiment are described below. FIGS. 34A and 34B are diagrams each illustrating a screen displayed in the seventh embodiment.

In FIG. 34A, a screen displayed when a “spec. sheet” folder is identified as the storage location candidate of the created file is illustrated. In this case, as illustrated in FIG. 34A, an icon of the “spec. sheet” folder is enlarged and is displayed as the storage location candidate folder display information I1 together with the name of the folder. Also, as illustrated in FIG. 34A, thumbnail images (i.e., feature information I2) of pages and images related to the “spec. sheet” folder of the stored data in the “spec. sheet” folder are displayed as feature information.

The data storage service provided in the seventh embodiment may have a structure that has multiple storage locations such as “my file” and a “shared file,” in one of which the folder serving as the storage location candidate is included. For example, in FIG. 34A, the “spec. sheet” folder included in a folder named “my file” is identified as the storage location candidate.

The processes of steps S4009 to S4011 in FIG. 33 are substantially the same as the processes of steps S1008, S1009, and S1011 in FIG. 5, respectively, and detailed descriptions thereof are omitted.

Alternatively, the screen displayed in the seventh embodiment may be, for example, a screen as illustrated in FIG. 34B. In FIG. 34B, similarly to FIG. 34A, a screen displayed when the “spec. sheet” folder is identified as the storage location candidate of the created file is illustrated. In FIG. 34B, on the screen, the folder name of the “spec. sheet” folder identified as the storage location candidate is displayed as the storage location candidate folder display information I1, and the other folders are not displayed. Also, as illustrated in FIG. 34B, thumbnail images (i.e., feature information I2) of pages and images related to the “spec. sheet” folder of the stored data in the “spec. sheet” folder are displayed as feature information. On the screen illustrated in FIG. 34B, detailed information on the folder and files is displayed. For example, in addition to the folder name and the file names, the update date and time of the folder and the files, the persons who have updated the folder and the files, the number of files included in the folder, and the data sizes of the files may be displayed.

According to the seventh embodiment described with reference to FIGS. 31 to 34B, even for a file created on the cloud, the user can easily determine that the storage location candidate is appropriate as a storage location for storing the created file among multiple storage locations.

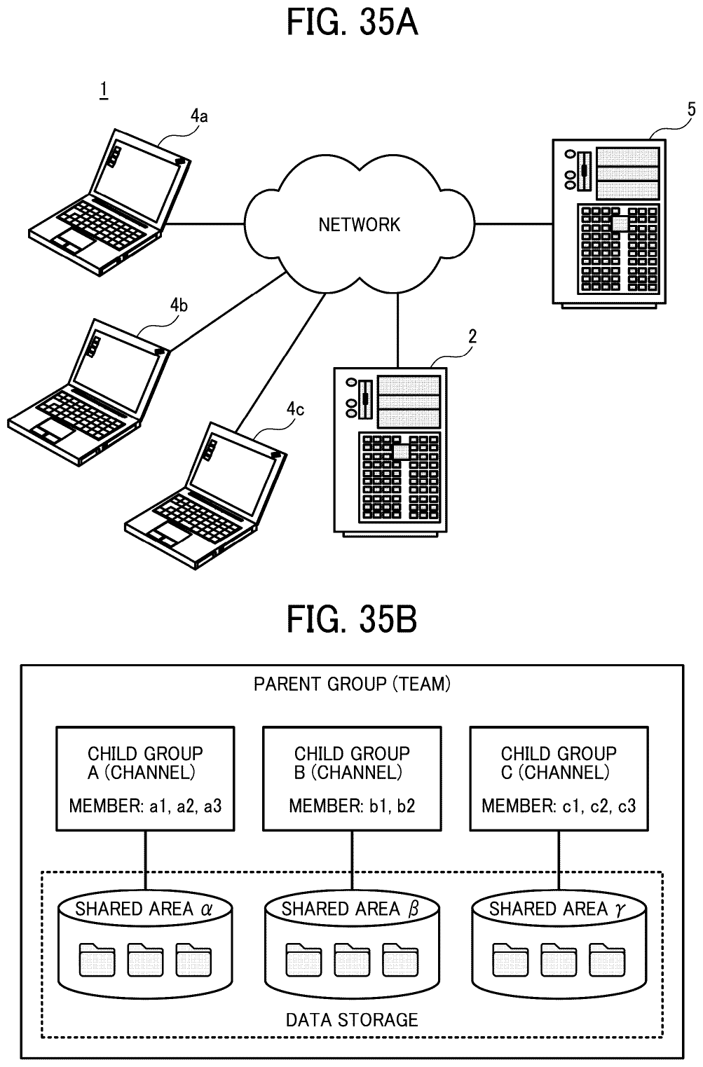

The eighth embodiment is described below with reference to FIGS. 35A to 39B. In the eighth embodiment, a configuration is described in which the user can easily determine that a storage location candidate is appropriate as a storage location for storing data among multiple storage locations in a so-called collaboration tool used for sharing information and performing communication in a specific community on the cloud.

FIG. 35A is a schematic diagram illustrating an overall hardware configuration of the system 1 according to the eighth embodiment. FIG. 35B is a diagram illustrating a hierarchical relationship of a collaboration tool according to the eighth embodiment. In FIG. 35A, the overall hardware configuration of the system 1 according to the eighth embodiment and an environment in which the server apparatus 2, the multiple personal computer terminals 4, and the data storage server 5 are connected via a network such as the Internet or a LAN are illustrated. The number of personal computer terminals 4 included in the system 1 is not limited to that illustrated in FIG. 35 and has no limitations. The method for connecting each apparatus to the network may be either wired or wireless.

The server apparatus 2 is an information processing apparatus that provides the collaboration tool service according to the present embodiment. The collaboration tool according to the present embodiment is described below. The collaboration tool (also referred to as a collaboration service or a team communication tool) is a tool that centrally manages, for example, file sharing, chat, and web conferencing for a specific group. Examples of the collaboration tool include, but are not limited to, MICROSOFT TEAMS. The collaboration tool has a structure having a parent group (sometimes referred to as a team) formed of members who participate in a community and a child group (sometimes referred to as a channel) formed of specific members within the team (parent group). In the team, multiple channels (child groups) may be included. For example, in a company (team), channels are created for individual projects or departments, and file sharing, chat, web conferencing can be performed among the members in each channel.

In FIG. 35B, the hierarchical relationship of the collaboration tool according to the eighth embodiment is illustrated. As illustrated in FIG. 35B, in the collaboration tool, a parent group (team) includes one or more child groups (channels). In FIG. 35B, three child groups A, B, and C are included in the parent group. In the child group A, members a1, a2, and a3 participate. In the child group B, members b1 and b2 participate. In the child group C, members c1, c2, and c3 participate. Shared areas a, B, and y of a data storage are allocated to and associated with the child groups A, B, and C, respectively. Accordingly, for example, various data stored in the shared area a can be shared among the members a1, a2, and a3. Each shared area can include a folder for storing data to be shared. The data to be stored does not necessarily have to be stored in the folder, and may be stored, for example, in the shared area (i.e., in the same layer as the folder).

The personal computer terminals 4 illustrated in FIG. 35A are information processing apparatuses owned by the members of each team. The user uses the collaboration tool according to the embodiments through the personal computer terminal 4.

In FIG. 35A, the server apparatus 2 that provides the collaboration tool service and the data storage server 5 are illustrated as individual apparatuses, but the configuration is not limited thereto. The server apparatus 2 and the data storage server 5 may be integrally configured as a single apparatus.

In the eighth embodiment, since the hardware configurations of the server apparatus 2 and the data storage server 5 are substantially the same as that illustrated in FIG. 2A and the hardware configuration of the personal computer terminal 4 is substantially the same as that illustrated in FIG. 18, detailed descriptions thereof are omitted.

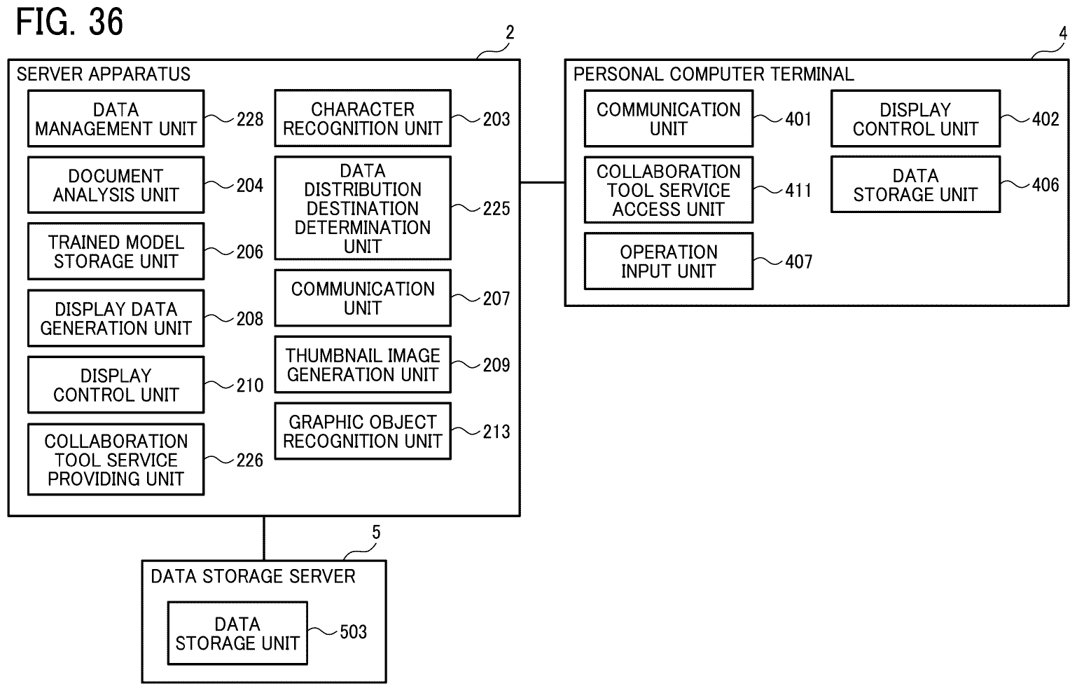

FIG. 36 is a block diagram illustrating a functional configuration of the system 1 according to the eighth embodiment. The server apparatus 2 includes, as functional units, a data management unit 228, the character recognition unit 203, the document analysis unit 204, a data distribution destination determination unit 225, the trained model storage unit 206, the communication unit 207, the display data generation unit 208, the thumbnail image generation unit 209, the display control unit 210, the graphic object recognition unit 213, and a collaboration tool service providing unit 226. The personal computer terminal 4 includes, as functional units, the communication unit 401, the display control unit 402, a collaboration tool service access unit 411, the data storage unit 406, and the operation input unit 407. The data storage server 5 includes, as a functional unit, a data storage unit 503.

Of the functional units in FIG. 36, the character recognition unit 203, the document analysis unit 204, the trained model storage unit 206, the communication unit 207, the display data generation unit 208, the thumbnail image generation unit 209, the display control unit 210, the graphic object recognition unit 213, the communication unit 401, the display control unit 402, the data storage unit 406, and the operation input unit 407 are described with reference to the block diagrams illustrating the functional units in the other embodiments, and detailed descriptions thereof are omitted. The display control unit 210 in the eighth embodiment, similarly to the display control unit 210 in the seventh embodiment, may be configured to perform, for example, control for displaying information on the personal computer terminal 4 via a web browser. The data management unit 228 and the data distribution destination determination unit 225 correspond to, for example, the scan data management unit 201 and the scan data distribution destination determination unit 205 illustrated in FIG. 3, respectively, and detailed descriptions thereof are omitted. Also, the data storage unit 503 corresponds to the diagnostic data storage unit 501 in FIG. 24, and a detailed description thereof is omitted. The data storage unit 503 according to the eighth embodiment corresponds to the data storage illustrated in FIG. 35B, and includes a shared area for each channel.

The collaboration tool service providing unit 226 provides a collaboration tool service according to the embodiments. The collaboration tool service providing unit 226 serves as a providing function in the present embodiment. The collaboration tool service providing unit 226 of the present embodiment provides, for example, in response to operations performed by the user through the personal computer terminal 4, various services such as management and sharing of a file uploaded by the user, and chat and web conferencing among the users.

The collaboration tool service access unit 411 accesses the collaboration tool service provided by the server apparatus 2. The collaboration tool service access unit 411 serves as an access function in the present embodiment. The collaboration tool service access unit 411 of the present embodiment performs sharing of a file, chat, and web conferencing with the other members in the team or channel.

The above-described functional units correspond to functions implemented by the CPU 11 or the CPU 41 executing programs to function hardware components. All the functional units described in the present embodiment may be implemented by software. Alternatively, a part or all of the functional units may be implemented by pieces of hardware each of which provides the equivalent function. In a modification of the eighth embodiment, for example, a server apparatus that analyzes a document and a server apparatus that provides a collaboration tool service may be configured as individual information processing apparatuses.

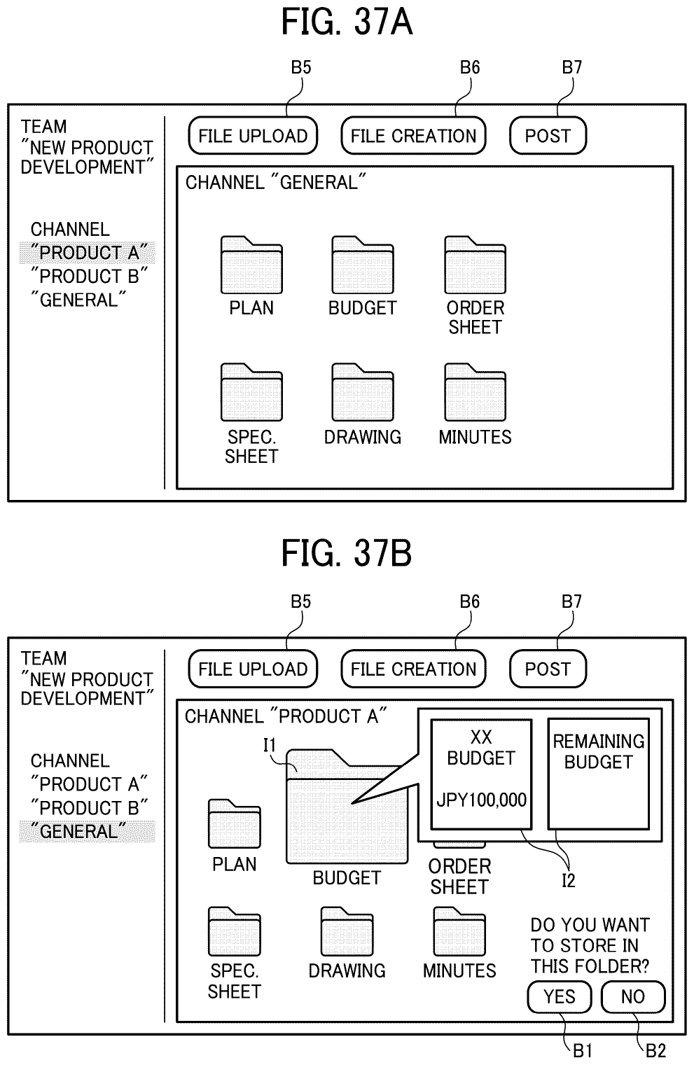

A screen displayed in the collaboration tool of the present embodiment is described below with reference to FIGS. 37A and 37B. FIGS. 37A and 37B are diagrams each illustrating a screen displayed in the eighth embodiment. In FIG. 37A, a screen in the collaboration tool according to the embodiments is illustrated.

As illustrated in FIG. 37A, in the collaboration tool of the present embodiment, channels of a “product A,” a “product B,” and “general” are included in a team of “new product development.” As illustrated in FIG. 37A, the “product A” channel includes folders of a “plan,” a “budget,” a “order sheet,” a “spec. sheet,” a “drawing,” and “minutes” related to the product A, and data in the folders is shared among the members of the channel. In other words, the data in the folders illustrated in FIG. 37A is shared among the members of the “product A” channel.

In addition, as illustrated in FIG. 37A, for example, a “file upload” button B5, a “file creation” button B6, and a “post” button B7 are displayed on the screen. Through the screen in the collaboration tool, the members of the channel can upload a file, create a file, post a chat, and share various information with the other members. For example, when a member of the channel presses the “file upload” button B5, a file to be shared with the other members is uploaded. As another example, when a member of the channel presses the “file creation” button B6, the member is allowed to create a file to be shared with the other members. As still another example, when a member of the channel presses the “post” button B7, the member is allowed to chat with the other members.

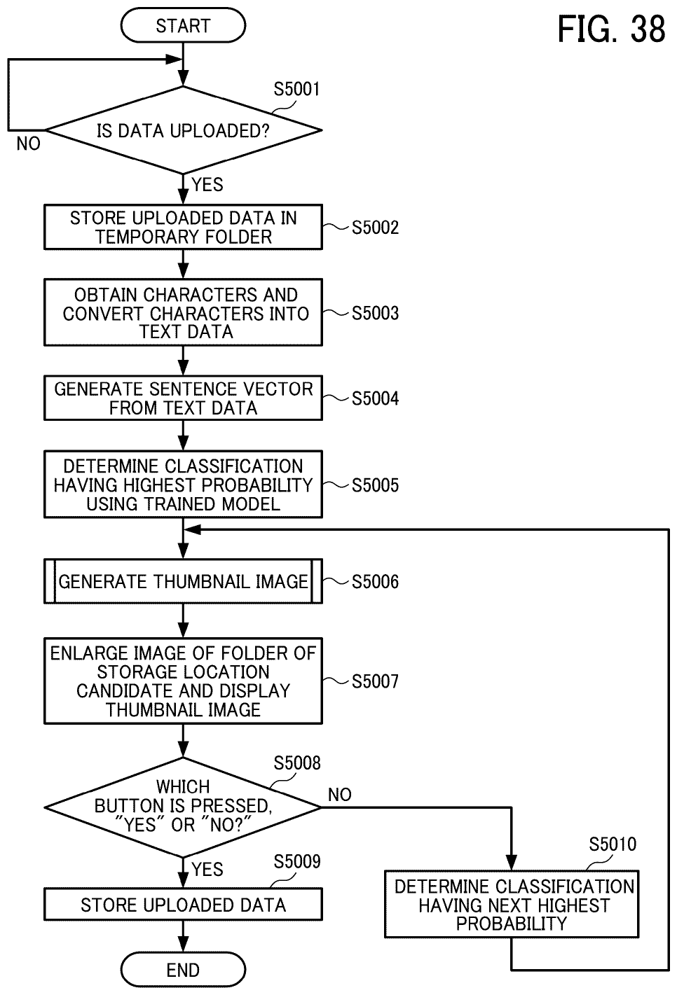

The process for storing an uploaded file is described below with reference to FIG. 38. FIG. 38 is a flowchart of the process executed by the server apparatus 2 according to the eighth embodiment. The server apparatus 2 starts the process. The process starts, for example, when the “file upload” button B5 on the screen illustrated in FIG. 37A is pressed and a file to be uploaded is selected.

In step S5001, the process branches depending on whether a file to be shared has been uploaded via the collaboration tool. In other words, in step S5001, the process branches depending on whether an operation for uploading a file has been performed on the screen illustrated in FIG. 37A. In the process of step S5001 in FIG. 38, a case in which a file has been uploaded is described. The file to be uploaded via the collaboration tool may be a file created on the cloud (as in the seventh embodiment).

In the case where a file has not been uploaded in step S5001 (NO in step S5001), the process of step S5001 is repeated to wait for the uploading of a file. On the other hand, in the case where a file has been uploaded in step S5001 (YES in step S5001), the process proceeds to step S5002.

The processes of steps S5002 to S5011 in FIG. 38 are substantially the same as the processes of steps S4003 to S4012 in FIG. 33, and detailed descriptions thereof are omitted. However, the determination of the classification (in step S5005) according to the eighth embodiment is different from that, for example, in FIG. 33, and is to determine, based on the contents of the uploaded file, a channel and a folder in the channel, in which the uploaded file is to be stored. Accordingly, for example, when the uploaded file includes the contents related to the “budget” of the “product A” (and even when the file is uploaded on the screen in which the “general” channel is selected), the file is determined to be appropriate to be stored in the “budget” folder in the “product A” channel.

With reference to FIG. 37B, a screen displayed in the process in FIG. 38 according to the eighth embodiment is described below. For example, in the eighth embodiment, when a file including the contents related to the “budget” of the “product A” is uploaded, the file is determined to be appropriate to be stored in the “budget” folder in the “product A” channel. Accordingly, for example, even when the file is uploaded on a screen in which the “general” channel is selected as illustrated in FIG. 37A, an image indicating folders in the product A channel is displayed as illustrated in FIG. 37B. In FIG. 37B, the name of the “product A” channel is displayed as information for identifying the channel, and the “budget” folder determined as the storage location candidate of the uploaded file is displayed in a manner different from the other folders. For example, the “budget” folder (i.e., the storage location candidate folder display information I1) is displayed in an enlarged size. Also, as illustrated in FIG. 37B, thumbnail images (i.e., the feature information I2) of the stored data in the “budget” folder in the product A channel are displayed. The user who has uploaded the file can view the screen illustrated in FIG. 37B to determine whether the selected folder is appropriate as a storage location for storing the file, and can perform an operation for selecting whether to store the file in the selected folder, that is, an operation of pressing the “Yes” button B1 or the “No” button B2.

With reference to FIG. 38, the process in the case where the file is uploaded in response to the pressing of the “file upload” button B5 on the screen illustrated in FIG. 37A is described. However, the way of acquiring a file is not particularly limited. Accordingly, for example, a file may be created and stored in response to the pressing of the “file creation” button B6 on the screen illustrated in FIG. 37A, or a file may be acquired and stored in response to the pressing of the “post” button B7 on the screen illustrated in FIG. 37A.

A case where a file is created and stored in response to the pressing of the “file creation” button B6 on the screen illustrated in FIG. 37A is described below. For example, when the “file creation” button B6 is pressed on the screen illustrated in FIG. 37A, a file creation screen is displayed. Subsequently, when operations for creating a file and storing the created file are performed (see the processes in steps S4001 and S4002 in FIG. 33), the storage location candidate folder display information I1 and the feature information I2 as illustrated in FIG. 34A or 34B are displayed.

Subsequently, a case where a file is acquired and stored in response to the pressing of the “post” button B7 on the screen illustrated in FIG. 37A is described below. For example, when the “post” button B7 is pressed on the screen illustrated FIG. 37A, a chat screen for chatting with the other members in the channel is displayed. Subsequently, when an operation for attaching a file to be posted in a chat field is performed, the storage location candidate folder display information I1 and the feature information I2 as illustrated in FIG. 37B are displayed.

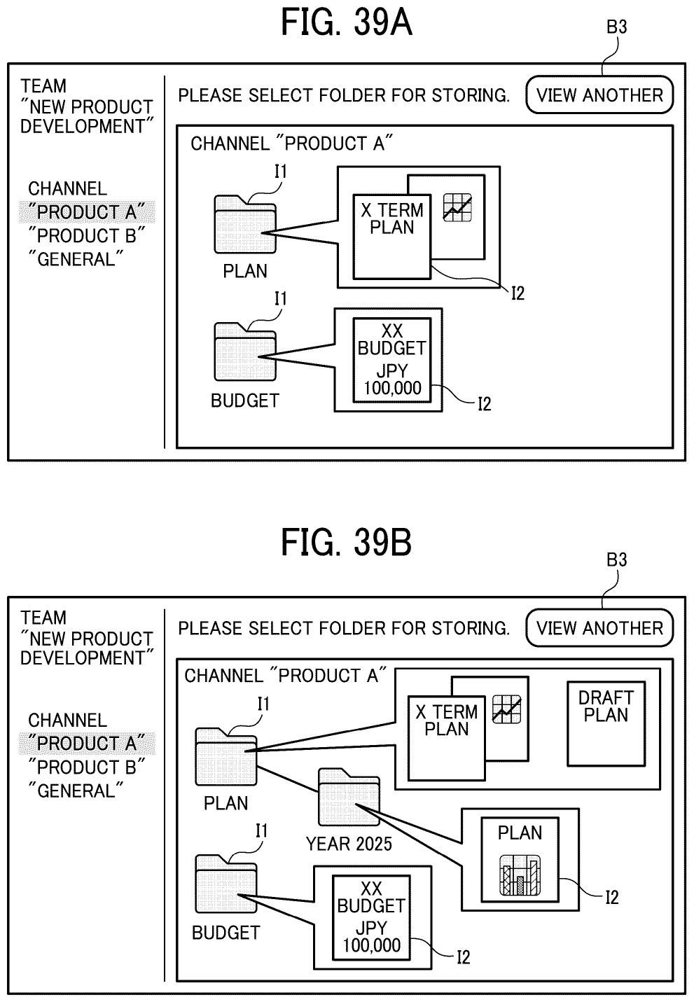

The structure of the screen displayed in the eighth embodiment is not limited to the structure illustrated in FIG. 37A or 37B, and may be, for example, a structure as illustrated in FIG. 39A or 39B. FIGS. 39A and 39B are diagrams each illustrating a screen displayed in a modification of the eighth embodiment. In FIG. 39A, a screen displayed in a first modification of the eighth embodiment is illustrated. In FIG. 39B, a screen displayed in a second modification of the eighth embodiment is illustrated.

In the eighth embodiment, only the folder determined as the storage location candidate may be displayed, and the other folders may be hidden. For example, as illustrated in FIG. 39A, both the “plan” folder and the “budget” folder that are determined as the storage location candidate may be displayed as the storage location candidate folder display information I1. When multiple pages related to the folder are included in the stored data in the folder serving as the storage location candidate, multiple thumbnail images of the pages may be displayed as the feature information I2 of the “plan” folder in FIG. 39A. As illustrated in FIG. 39A, on the screen displayed in the eighth embodiment, a “view another” button (serving as the other candidates display button B3) used for displaying a storage location candidate other than the folder determined as the storage location candidate may be displayed.

In the eighth embodiment, when a folder in a channel further includes a sub-folder (when a folder has a hierarchical structure), for example, the sub-folder may also be displayed as illustrated in FIG. 39B. As illustrated in FIG. 39B, the “plan” folder includes a “2025” folder. For example, when the contents of the uploaded file is related to the “plan” or the “2025” of the “product A,” the “2025” folder may be displayed as the storage location candidate, as illustrated in FIG. 39B. As illustrated in FIG. 39B, on the screen displayed in the eighth embodiment, the “view another” button (serving as the other candidates display button B3) used for displaying a storage location candidate other than the folder determined as the storage location candidate may be displayed.

According to the eighth embodiment described with reference to FIGS. 35A to 39B, even for a file uploaded through the collaboration tool, the user can easily determine that the storage location candidate is appropriate as a storage location for storing the uploaded file among multiple storage locations. In addition, according to the eighth embodiment, even in a structure that has multiple channels in which folders are included, such as in a collaboration tool, the channel and the folder in the channel, which is the storage location candidate of the file to be stored, are displayed. Thus, the user can easily determine that the storage location candidate is appropriate as a storage location for storing the file to be stored.

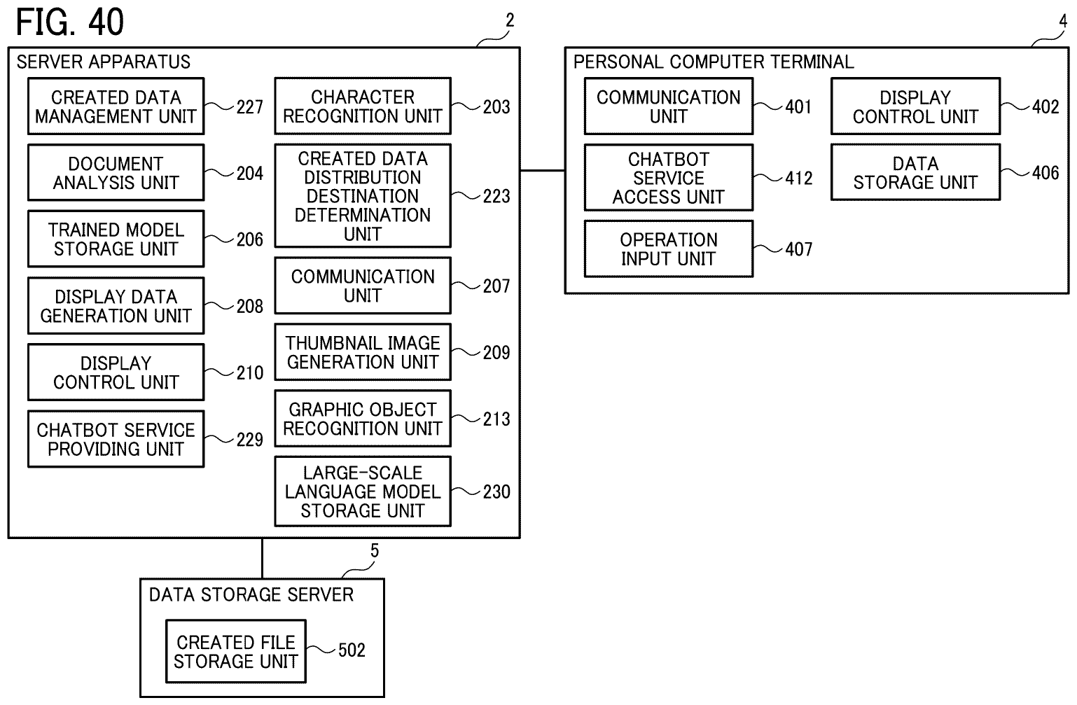

The ninth embodiment is described below with reference to FIGS. 40 to 42. In the ninth embodiment, a configuration is described in which a file is stored via a generative AI (a so-called chatbot) that performs pseudo dialogue. The schematic hardware configuration of the entire system 1 according to the ninth embodiment is substantially the same as that illustrated in FIG. 31, and a detailed description thereof is omitted. In the ninth embodiment, since the hardware configurations of the server apparatus 2 and the data storage server 5 are substantially the same as that illustrated in FIG. 2A and the hardware configuration of the personal computer terminal 4 is substantially the same as that illustrated in FIG. 18, detailed descriptions thereof are omitted.

FIG. 40 is a block diagram illustrating a functional configuration of the system 1 according to the ninth embodiment. The server apparatus 2 includes, as functional units, the created data management unit 227, the character recognition unit 203, the document analysis unit 204, the created data distribution destination determination unit 223, the trained model storage unit 206, the communication unit 207, the display data generation unit 208, the thumbnail image generation unit 209, the display control unit 210, the graphic object recognition unit 213, a chatbot service providing unit 229, and a large-scale language model storage unit 230. The personal computer terminal 4 includes, as functional units, the communication unit 401, the display control unit 402, a chatbot service access unit 412, the data storage unit 406, and the operation input unit 407. The data storage server 5 includes, as a functional unit, the created file storage unit 502.

Of the functional units in FIG. 40, the created data management unit 227, the character recognition unit 203, the document analysis unit 204, the created data distribution destination determination unit 223, the trained model storage unit 206, the communication unit 207, the display data generation unit 208, the thumbnail image generation unit 209, the display control unit 210, the graphic object recognition unit 213, the large-scale language model storage unit 230, the communication unit 401, the display control unit 402, the data storage unit 406, the operation input unit 407, and the created file storage unit 502 are described with reference to the block diagrams illustrating the functional units in the other embodiments, and detailed descriptions thereof are omitted.

The chatbot service providing unit 229 provides a chatbot service according to the embodiments. The chatbot service providing unit 229 serves as a providing function in the present embodiment. The chatbot service providing unit 229 of the present embodiment provides a service that allows the user to make text-based pseudo-conversation (i.e., chat). The chatbot service providing unit 229 analyzes, for example, a prompt received from the personal computer terminal 4 and generates a response to the prompt.

The chatbot service access unit 412 accesses the chatbot service provided by the server apparatus 2. The chatbot service access unit 412 serves as an access function in the present embodiment. The chatbot service access unit 412 of the present embodiment transmits a natural sentence (i.e., a prompt) input from the personal computer terminal 4 to the chatbot service providing unit 229 of the server apparatus 2 via the network and receives a response generated by the chatbot service providing unit 229.

The above-described functional units correspond to functions implemented by the CPU 11 or the CPU 41 executing programs to function hardware components. All the functional units described in the present embodiment may be implemented by software. Alternatively, a part or all of the functional units may be implemented by pieces of hardware each of which provides the equivalent function. In a modification of the ninth embodiment, the large-scale language model storage unit 230 may be included in an information processing apparatus different from the data storage server 5, such as the generative AI server 6.

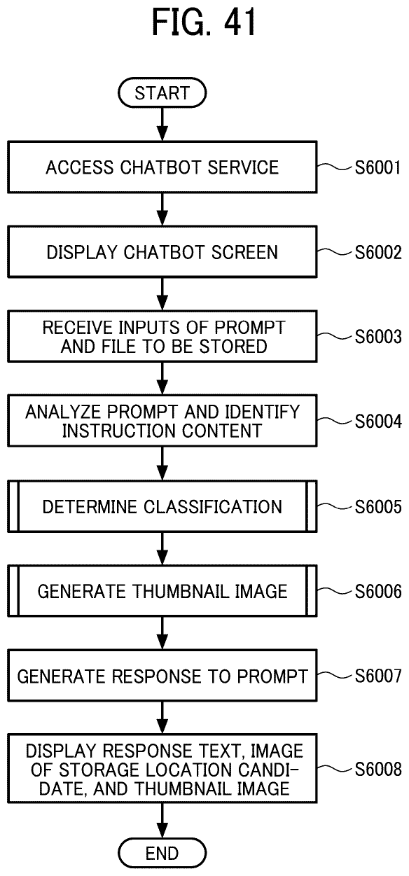

Subsequently, the processes executed by the functional units are described below with reference to FIG. 41. FIG. 41 is a flowchart of the process executed by the server apparatus 2 and the personal computer terminal 4 according to the ninth embodiment. The server apparatus 2 and the personal computer terminal 4 start the process.

In step S6001, the chatbot service access unit 412 accesses the chatbot service providing unit 229 of the server apparatus 2 to start the chatbot service. When the chatbot service is started, the display control unit 402 performs control to display a chatbot screen in step S6002. The user views the displayed chatbot screen and operates a UI on the screen.

In step S6003, the chatbot service access unit 412 receives inputs of a prompt and a file to be stored. The prompt and the file to be stored input in step S6003 are transmitted to the server apparatus 2.

In step S6004, the chatbot service providing unit 229 analyzes the content of the prompt to identify an instruction content. In the process of step S6004, the prompt is input to the large-scale language model stored in the large-scale language model storage unit 230 to be analyzed, and the instruction content indicated by the prompt (i.e., the content desired to be carried out by the user) is identified. For example, when a prompt indicating “Tell me the storage location for this file” is input together with the file to be stored, an instruction to “store the file to be stored” is identified.

In step S6005, a classification determination process is performed. The classification determination process corresponds to the processes of steps S1003 to S1005 in FIG. 5, and detailed descriptions thereof are omitted.

In step S6006, the thumbnail image generation unit 209 generates a thumbnail image as feature information obtained by analyzing the stored data. The process of step S6006 corresponds to the process of step S1006 in FIG. 5. Specifically, the thumbnail image generation unit 209 performs the same processes as those in FIGS. 9 and 11 to generate a thumbnail image. The generated thumbnail image is transmitted to the personal computer terminal 4.

In step S6007, the large-scale language model generates a response to the prompt. The response may be generated, for example, in the form of a sentence. When the prompt indicating “Tell me the storage location for this file” is input, information indicating a storage location candidate is generated as the response. The generated response is transmitted to the personal computer terminal 4.

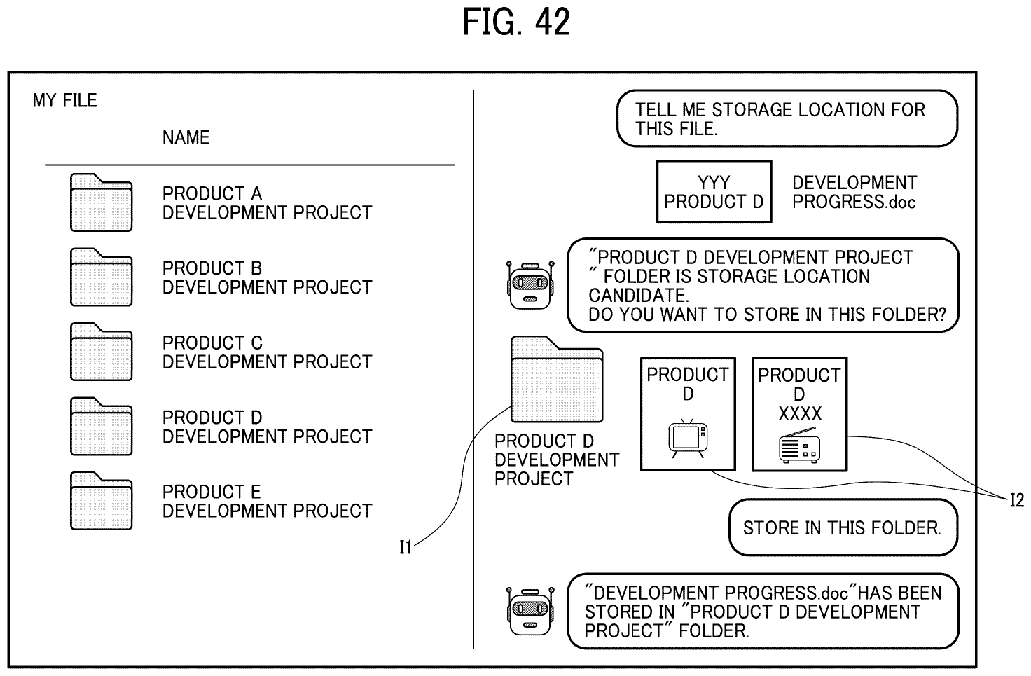

In step S6008, the display control unit 402 performs control to display the response text, an image of the storage location candidate, and a thumbnail image received from the server apparatus 2 on the chatbot screen. Then, the process ends. With reference to FIG. 42, a screen displayed in the process of step S6008 is described below.

FIG. 42 is a diagram illustrating a screen displayed in the ninth embodiment. In the ninth embodiment, for example, as illustrated in FIG. 42, an area used for chatting with the chatbot, which is an area used for exchanging text-based dialogues with the large-scale language model, may be displayed on a part of the screen. In the case of the screen illustrated in FIG. 42, the user is attempting to store a file called “development progress.doc.” At that time, a natural sentence (an instruction sentence) indicating “Tell me the storage location for this file” may be input. In response to receiving the prompt, a storage location candidate of the “development progress.doc” file is determined and the result of the determination is presented to the user. For example, it is assumed that the “development progress.doc” file is related to the product D. As illustrated in FIG. 42, the “product D development project” folder is determined as a storage location candidate, and an icon of the “product D development project” folder serving as the storage location candidate folder display information I1 is displayed together with a message indicating that the “product D development project” folder is the storage location candidate. In addition, on the screen illustrated in FIG. 42, the feature information I2 (e.g., a thumbnail image or stored data information) of the stored data in the “product D development project” folder may also be displayed.

The user is allowed to view the screen illustrated in FIG. 42 and determine whether the storage location candidate is appropriate as a storage location for storing the “development progress.doc” file. In this case, the “Yes” button B1 and the “No” button B2 may not be displayed on the screen illustrated in FIG. 42. Instead, for example, the operation for storing the file may be performed through chatting with the chatbot. For example, when the user determines that the storage location candidate is appropriate as a storage location for storing the “development progress.doc” file, the user inputs a prompt indicating “Store in this folder.” In response to receiving the input of the prompt, a process in accordance with the content of the prompt, that is, a process for storing the “development progress.doc” file in the “product D development project” folder is performed. Then, as illustrated in FIG. 42, a message indicating that the “development progress.doc” has been stored in the “product D development project” folder is displayed.

According to the ninth embodiment described with reference to FIGS. 40 to 42, even for data for which an operation for storing is performed via a chatbot service, the user can easily determine that the storage location candidate is appropriate as a storage location for storing the data among multiple storage locations.

The personal computer terminal 4 used in the above-described embodiments is given by way of example as an information processing apparatus. However, the information processing apparatus is not limited thereto. Accordingly, for example, instead of the personal computer terminal 4, an information processing apparatus such as a smartphone or a tablet terminal may be used.

According to the first to ninth embodiments described above, the user can easily determine that the storage location candidate is appropriate as a storage location for storing the data among multiple storage locations. In particular, by displaying the storage location candidate that is a candidate of the storage location in a manner that allows the storage location candidate to be distinguished from the other storage locations, the user can easily recognize the storage location. The manner is for example, displaying the storage location candidate as an image of an opened drawer or displaying an image obtained by enlarging an icon indicating the storage location. Further, by displaying the feature information (e.g., a thumbnail image, stored data information, and a list of specific keywords) obtained by analyzing the stored data, the user can easily determine whether the storage location candidate is appropriate as a storage location for storing data.

The configurations in the first to ninth embodiments described above can be combined in any combination as long as no contradictions occur. For example, in the configuration in which the MFP 3 analyzes scan data as in the second embodiment, a configuration in which a graphic object is recognized as in the third embodiment may be employed. Also, for example, in the configuration in which conference data is stored as in the fourth embodiment, a configuration in which multiple storage location candidates are displayed may be employed as described with reference to FIG. 8 of the first embodiment. Further, for example, in the case where multiple physical storage areas are used as in the fifth embodiment, a configuration in which the terminal apparatus performs the process for distributing data may be employed as in the second embodiment. Furthermore, for example, in the case where multiple physical storage areas are used as in the fifth embodiment, a configuration in which the stored data information generated by the generative AI is displayed may be employed as in the sixth embodiment. Furthermore, for example, in the file creation service and the data storage service as in the seventh embodiment and the collaboration tool service as in the eighth embodiment, a configuration in which the stored data information generated by the generative AI is displayed may be employed as in the sixth embodiment.

According to the embodiments of the present disclosure described above, an information processing apparatus, a system, a non-transitory recording medium, and a method that allow the user to easily determine that the storage location candidate is appropriate as a storage location for storing the data among multiple storage locations are provided. Furthermore, according to the embodiments described above, the data is stored in an appropriate storage location while the workload for the user is reduced. In other words, in a configuration in which only the information on the storage location candidate is displayed as in the technology in the art, the user has to browse the stored data to confirm the contents. However, according to the configurations of the embodiments described above, since the feature information obtained by analyzing the stored data is also displayed, the workload for the user is reduced.

The functions of the embodiments of the present disclosure described above can be implemented by a device-executable program written in, for example, C, C++, C#, or JAVA. The program according to an embodiment of the present disclosure can be stored in a device-readable recording medium to be distributed. Examples of the recording medium include a hard disk drive, a compact disk-read-only memory (CD-ROM), a magneto-optical disk (MO), a digital versatile disk (DVD), a flexible disk, an electrically erasable programmable read-only memory (EEPROM), and an erasable programmable read-only memory (EPROM). The program can be transmitted through a network in a format executable by another device.

Each of the functions of the embodiments described above may be implemented by one or more processing circuits or circuitry. The “processing circuit or circuitry” herein includes a programmed processor to execute each function by software, such as a processor implemented by an electronic circuit, and devices, such as an application-specific integrated circuit (ASIC), a digital signal processor (DSP), a field-programmable gate array (FPGA), and circuit modules known in the art arranged to perform the recited functions.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present invention.

Aspects of the present disclosure are, for example, as follows.

According to Aspect 1, an information apparatus includes a determination unit that determines, based on the contents of data received from a terminal apparatus, a storage location candidate of the data among multiple storage locations, a display control unit that causes the terminal apparatus to display, on a display, information indicating the storage location candidate and feature information obtained by analyzing stored data having been stored in the storage location candidate, and a management unit that causes the data to be stored in the storage location candidate, in response to an operation performed on the terminal apparatus for instructing to store the data in the storage location candidate.

According to Aspect 2, in the information processing apparatus of Aspect 1, in response to an operation performed on the terminal apparatus for instructing not to store the data in the storage location candidate, the determination unit determines another storage location candidate different from the storage location candidate, and the display control unit causes the terminal apparatus to display, on the display, information indicating the other storage location candidate and feature information obtained by analyzing stored data in the other storage location candidate.

According to Aspect 3, in the information processing apparatus of Aspect 1, the determination unit determines multiple storage location candidates that includes the storage location candidate, and the management unit causes the data to be stored in one of the multiple storage location candidates, in response to an operation performed on the terminal apparatus for instructing to store the data in the one of the multiple storage location candidates.

According to Aspect 4, in the information processing apparatus of Aspect 3, the determination unit determines, in response to an operation performed on the terminal apparatus for not selecting any one of the multiple storage location candidates, multiple other storage location candidates different from the multiple storage location candidates, and the display control unit causes the terminal apparatus to display, on the display, information indicating the multiple other storage location candidates and feature information obtained by analyzing stored data in the multiple other storage location candidates.

According to Aspect 5, the information processing apparatus of Aspect 1 further includes an analysis unit that analyzes text data included in the data received from the terminal apparatus, and the determination unit determines the storage location candidate based on the result obtained by the analysis unit.

According to Aspect 6, the information processing apparatus of Aspect 1 further includes a generation unit that generates a thumbnail image based on the stored data, and the feature information is the thumbnail image.

According to Aspect 7, in the information processing apparatus of Aspect 6, the thumbnail image includes a page identified to have a high degree of similarity to the data to be stored, the page being obtained from the stored data having a high degree of similarity to the data to be stored.

According to Aspect 8, in the information processing apparatus of Aspect 5, the analysis unit outputs a probability indicating a degree of probability that the data corresponds to the contents of each of the multiple storage locations based on the text data, and the determination unit determines the storage location candidate based on the degree of the probability.

According to Aspect 9, the information processing apparatus of Aspect 1 further includes a recognition unit that recognizes a graphic object included in the data received from the terminal apparatus, and the determination unit determines the storage location candidate based on the graphic object.

According to Aspect 10, the information processing apparatus of Aspect 1 further includes an analysis unit that analyzes audio data received from the terminal apparatus, and the determination unit determines the storage location candidate based on the result obtained by the analysis unit.

According to Aspect 11, the information processing apparatus of Aspect 1 further includes an extraction unit that extracts one or more specific keywords associated with the stored data, and the feature information is a list of the one or more specific keywords.

According to Aspect 12, in the information processing apparatus of Aspect 11, the one or more specific keywords in the list are extracted from data most recently stored in the storage location candidate.

According to Aspect 13, in the information processing apparatus of Aspect 10, the analysis unit outputs a probability indicating a degree of probability that the data corresponds to the contents of each of the multiple storage locations based on the audio data, and the determination unit determines the storage location candidate based on the degree of the probability.

According to Aspect 14, in the information processing apparatus of Aspect 6, the thumbnail image includes at least one of text data and image data identified to have high frequencies of appearance among the text data and the image data in the stored data.

According to Aspect 15, the information processing apparatus of Aspect 1 further includes a generation unit that generates stored data information indicating a breakdown of a classification of the stored data obtained by analyzing the stored data, and the feature information is the stored data information.

According to Aspect 16, in the information processing apparatus of Aspect 1, the display control unit causes the terminal apparatus to display, on the display, an area used for exchanging text-based dialogues with a large-scale language model, the determination unit determines the storage location candidate of the data based on the data to be stored input in the area, and the display control unit performs control to display a response sentence generated by the large-scale language model to an instruction sentence input in the area, information indicating the storage location candidate, and the feature information in the area on the display.

According to Aspect 17, a system includes a terminal apparatus that acquires data and an information processing apparatus that stores the data in one of multiple storage locations. The terminal apparatus includes a determination unit that determines, based on the contents of the data, a storage location candidate of the data among the multiple storage locations and a communication unit that transmits the result of the determination of the storage location candidate to the information processing apparatus. The information processing apparatus includes a communication unit that transmits information indicating the storage location candidate and feature information obtained by analyzing stored data having been stored in the storage location candidate to the terminal apparatus and a management unit that cause the data to be stored in the storage location candidates, in response to an operation performed on the terminal apparatus for instructing to store the data in the storage location candidate.

According to Aspect 18, in the system of Aspect 17, the terminal apparatus scans a document and further includes an analysis unit that analyzes text data included in the data obtained by scanning the document. The determination unit determines the storage location candidate based on the result obtained by the analysis unit.

According to Aspect 19, in the system of Aspect 17, in the case where an operation for not storing the data in the storage location candidate is performed on the terminal apparatus, the determination unit determines another storage location candidate different from the storage location candidate, and the communication unit transmits the result of the determination of the other storage location candidate to the information processing apparatus.

According to Aspect 20, a non-transitory recording medium stores a plurality of program codes which, when executed by one or more processors, causes the one or more processors to perform a method including determining, based on the contents of data received from a terminal apparatus, a storage location candidate of the data among multiple storage locations, causing the terminal apparatus to display, on a display, information indicating the storage location candidate and feature information obtained by analyzing stored data having been stored in the storage location candidate, and causing the data to be stored in the storage location candidate, in response to an operation performed on the terminal apparatus for instructing to store the data in the storage location candidate.

According to Aspect 21, a method includes determining, based on the contents of data received from a terminal apparatus, a storage location candidate of the data among multiple storage locations, causing the terminal apparatus to display, on a display, information indicating the storage location candidate and feature information obtained by analyzing stored data having been stored in the storage location candidate, and causing the data to be stored in the storage location candidate, in response to an operation performed on the terminal apparatus for instructing to store the data in the storage location candidate.

According to Aspect 22, a system provides a service on a cloud. The system includes a determination unit that determines, based on the contents of data to be stored in the service, a storage location candidate of the data among multiple storage locations, a display control unit that causes a terminal apparatus to which the service is provided to display, on a display, information indicating the storage location candidate and feature information obtained by analyzing stored data having been stored in the storage location candidate, and a management unit that causes the data to be stored in the storage location candidate, in response to an operation performed on the terminal apparatus for instructing to store the data in the storage location candidate.

According to Aspect 23, in the system of Aspect 22, the service manages each of multiple groups and one or more storage locations of the multiple storage locations in association with each other.

According to Aspect 24, in the system of Aspect 23, the information indicating the storage location candidate includes information for identifying, from among the multiple groups, a particular group associated with the storage location candidate.

According to Aspect 25, in the system of Aspect 22, the service includes a function for creating the data to be stored on the cloud.

According to Aspect 26, an information processing apparatus provides a service on a cloud. The information processing apparatus includes a determination unit that determines, based on the contents of data to be stored in the service, a storage location candidate of the data among multiple storage locations, a display control unit that causes a terminal apparatus to which the service is provided to display, on a display, information indicating the storage location candidate and feature information obtained by analyzing stored data having been stored in the storage location candidate, and a management unit that causes the data to be stored in the storage location candidate, in response to an operation performed on the terminal apparatus for instructing to store the data in the storage location candidate.

According to Aspect 27, a method includes determining, based on the contents of data to be stored in a service provided on a cloud, a storage location candidate of the data among multiple storage locations, causing a terminal apparatus to which the service is provided to display, on a display, information indicating the storage location candidate and feature information obtained by analyzing stored data having been stored in the storage location candidate, and causing the data to be stored in the storage location candidate, in response to an operation performed on the terminal apparatus for instructing to store the data in the storage location candidate.

According to Aspect 28, a non-transitory recording medium stores a plurality of program codes which, when executed by one or more, causes the one or more processors to perform a method including determining, based on the contents of data to be stored in a service provided on a cloud, a storage location candidate of the data among multiple storage locations, causing a terminal apparatus to which the service is provided to display, on a display, information indicating the storage location candidate and feature information obtained by analyzing stored data having been stored in the storage location candidate, and causing the data to be stored in the storage location candidate, in response to an operation performed on the terminal apparatus for instructing to store the data in the storage location candidate.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

In another aspect, an information processing apparatus includes circuitry to determine, in response to an operation performed on a terminal apparatus for not selecting any one of a plurality of storage location candidates, a plurality of other storage location candidates different from the plurality of storage location candidates and cause the terminal apparatus to display, on a display, information indicating the plurality of other storage location candidates and feature information obtained by analyzing stored data having been stored in the plurality of other storage location candidates.

In another aspect, in an information processing, one or more specific keywords in a list are extracted from data most recently stored in a storage location candidate.

In another aspect, an information processing apparatus includes circuitry to output a probability indicating a degree of probability that data corresponds to contents of each of a plurality of storage locations based on audio data and determine a storage location candidate based on the degree of the probability.

In another aspect, a system includes a terminal apparatus that scans a document and includes circuitry to analyze text data included in data obtained by scanning the document and determine a storage location candidate based on a result obtained by analyzing the text data.

In another aspect, a system includes circuitry to, in a case that an operation for instructing not to store data in a storage location candidate is performed on a terminal apparatus, determine another storage location candidate different from the storage location candidate and transmit a result of a determination of the other storage location candidate to an information processing apparatus.

In another aspect, an information processing apparatus for providing a service on a cloud includes circuitry to determine, based on contents of data to be stored in the service, a storage location candidate of the data among a plurality of storage locations, cause a terminal apparatus to which the service is provided to display, on a display, information indicating the storage location candidate and feature information obtained by analyzing stored data having been stored in the storage location candidate, and cause the data to be stored in the storage location candidate, in response to an operation performed on the terminal apparatus for instructing to store the data in the storage location candidate.

In another aspect, a method includes determining, based on contents of data to be stored in a service provided on a cloud, a storage location candidate of the data among a plurality of storage locations, causing a terminal apparatus to which the service is provided to display, on a display, information indicating the storage location candidate and feature information obtained by analyzing stored data having been stored in the storage location candidate, and causing the data to be stored in the storage location candidate, in response to an operation performed on the terminal apparatus for instructing to store the data in the storage location candidate.

In another aspect, a non-transitory recording medium stores a plurality of program codes which, when executed by one or more processors, causes the one or more processors to perform a method including determining, based on contents of data to be stored in a service on a cloud, a storage location candidate of the data among a plurality of storage locations, causing a terminal apparatus to which the service is provided to display, on a display, information indicating the storage location candidate and feature information obtained by analyzing stored data having been stored in the storage location candidate, and causing the data to be stored in the storage location candidate, in response to an operation performed on the terminal apparatus for instructing to store the data in the storage location candidate.

1. An information processing apparatus comprising circuitry configured to:
determine, based on contents of data received from a terminal apparatus, a storage location candidate of the data among a plurality of storage locations;
cause the terminal apparatus to display, on a display, information indicating the storage location candidate and feature information obtained by analyzing stored data having been stored in the storage location candidate; and
cause the data to be stored in the storage location candidate, in response to an operation performed on the terminal apparatus for instructing to store the data in the storage location candidate.

2. The information processing apparatus according to claim 1, wherein
the circuitry is configured to:
in response to an operation performed on the terminal apparatus for instructing not to store the data in the storage location candidate, determine another storage location candidate different from the storage location candidate; and
cause the terminal apparatus to display, on the display, information indicating the another storage location candidate and feature information obtained by analyzing stored data having been stored in the another storage location candidate.

3. The information processing apparatus according to claim 1, wherein
the circuitry is configured to:
determine a plurality of storage location candidates, the plurality of storage location including the storage location candidate; and
cause the data to be stored in one of the plurality of storage location candidates, in response to an operation performed on the terminal apparatus for instructing to store the data in the one of the plurality of storage location candidates.

4. The information processing apparatus according to claim 1, wherein
the circuitry is further configured to:
analyze text data included in the data received from the terminal apparatus; and
determine the storage location candidate based on a result obtained by analyzing the text data.

5. The information processing apparatus according to claim 1, wherein
the circuitry is further configured to generate a thumbnail image based on the stored data, the thumbnail image serving as the feature information.

6. The information processing apparatus according to claim 5, wherein
the thumbnail image includes a page identified based on a degree of similarity between the data to be stored and the stored data in the storage location candidate.

7. The information processing apparatus according to claim 4, wherein
the circuitry is further configured to:
output a probability indicating a degree of probability that the data corresponds to the contents of each of the plurality of storage locations based on the text data; and
determine the storage location candidate based on the degree of the probability.

8. The information processing apparatus according to claim 1, wherein
the circuitry is further configured to:
recognize a graphic object included in the data received from the terminal apparatus; and
determine the storage location candidate based on the graphic object.

9. The information processing apparatus according to claim 1, wherein
the circuitry is further configured to:
analyze audio data received from the terminal apparatus; and
determine the storage location candidate based on a result obtained by analyzing the audio data.

10. The information processing apparatus according to claim 1, wherein
the circuitry is further configured to extract one or more specific keywords associated with the stored data, a list of the one or more specific keywords serving as the feature information.

11. The information processing apparatus according to claim 5, wherein
the thumbnail image includes at least one of text data or image data identified based on a frequency of appearance among the text data and the image data in the stored data.

12. The information processing apparatus according to claim 1, wherein
the circuitry is further configured to generate stored data information indicating a breakdown of a classification of the stored data obtained by analyzing the stored data, the stored data information serving as the feature information.

13. The information processing apparatus according to claim 1, wherein
the circuitry is configured to:
cause the terminal apparatus to display, on the display, an area used for exchanging text-based dialogues with a large-scale language model;
determine the storage location candidate of the data based on the data to be stored input in the area; and
cause the display to display in the area a response sentence generated by the large-scale language model to an instruction sentence input in the area, information indicating the storage location candidate, and the feature information.

14. A system comprising:
a terminal apparatus; and
an information processing apparatus, wherein
the terminal apparatus includes circuitry configured to:
acquire data;
determine, based on contents of the data, a storage location candidate of the data among a plurality of storage locations; and
transmit a result of a determination of the storage location candidate to the information processing apparatus, and
the information processing apparatus includes other circuitry configured to:
transmit information indicating the storage location candidate and feature information obtained by analyzing stored data having been stored in the storage location candidate to the terminal apparatus; and
store the data in the storage location candidate in response to an operation performed on the terminal apparatus for instructing to store the data in the storage location candidate.

15. A non-transitory recording medium storing a plurality of program codes which, when executed by one or more processors, causes the one or more processors to perform a method, the method comprising:
determining, based on contents of data received from a terminal apparatus, a storage location candidate of the data among a plurality of storage locations;
causing the terminal apparatus to display, on a display, information indicating the storage location candidate and feature information obtained by analyzing stored data having been stored in the storage location candidate; and
causing the data to be stored in the storage location candidate, in response to an operation performed on the terminal apparatus for instructing to store the data in the storage location candidate.

16. A method comprising:
determining, based on contents of data received from a terminal apparatus, a storage location candidate of the data among a plurality of storage locations;
causing the terminal apparatus to display, on a display, information indicating the storage location candidate and feature information obtained by analyzing stored data having been stored in the storage location candidate; and
causing the data to be stored in the storage location candidate, in response to an operation performed on the terminal apparatus for instructing to store the data in the storage location candidate.

17. A system for providing a service on a cloud, the system comprising circuitry configured to:
determine, based on contents of data to be stored in the service, a storage location candidate of the data among a plurality of storage locations;
cause a terminal apparatus to which the service is provided to display, on a display, information indicating the storage location candidate and feature information obtained by analyzing stored data having been stored in the storage location candidate; and
cause the data to be stored in the storage location candidate, in response to an operation performed on the terminal apparatus for instructing to store the data in the storage location candidate.

18. The system according to claim 17, wherein
the service manages each of a plurality of groups and one or more storage locations of the plurality of storage locations in association with each other.

19. The system according to claim 18, wherein
the information indicating the storage location candidate includes information for identifying, from among the plurality of groups, a particular group associated with the storage location candidate.

20. The system according to claim 17, wherein
the service includes a function for creating the data to be stored on the cloud.
